(19) United States
(12) Patent Application Publication
(10) Pub. No.: US 2022/0179250 A1
(43) Pub. Date: Jun. 9, 2022

(54) PHOTO-ALIGNMENT POLYMER, BINDER COMPOSITION, BINDER LAYER, OPTICAL LAMINATE, OPTICAL LAMINATE MANUFACTURING METHOD, AND IMAGE DISPLAY DEVICE

(71) Applicant: FUJIFILM Corporation, Tokyo (JP)

(72) Inventors: Takashi IIZUMI, Kanagawa (JP); Soichiro WATANABE, Kanagawa (JP); Yutaka NOZOE, Kanagawa (JP); Kunihiro ATSUMI, Kanagawa (JP)

(73) Assignee: FUJIFILM Corporation, Tokyo (JP)

(21) Appl. No.: 17/677,955

(22) Filed: Feb. 22, 2022

Related U.S. Application Data
(63) Continuation of application No. PCT/JP2020/032063, filed on Aug. 25, 2020.

(30) Foreign Application Priority Data
Aug. 29, 2019 (JP) 2019-156583

(51) Int. Cl. G02F 1/1334; G02F 1/1337; C08L 1/10

(52) U.S. Cl. CPC G02F 1/1334; C08L 1/10; G02F 1/133769

(57) ABSTRACT

The present invention provides a photo-alignment polymer having excellent liquid crystal aligning properties, a binder composition, a binder layer, an optical laminate, an optical laminate manufacturing method, and an image display device. A photo-alignment polymer according to the embodiment of the present invention has a repeating unit having a photo-alignment group and a repeating unit having a group represented by Formula (1).

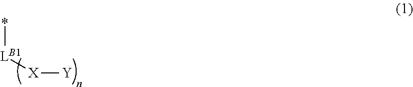

### CROSS-REFERENCE TO RELATED APPLICATIONS

This application is a Continuation of PCT International Application No. PCT/JP2020/032063 filed on Aug. 25, 2020, which claims priority under 35 U.S.C. § 119(a) to Japanese Patent Application No. 2019-156583 filed on Aug. 29, 2019. The above application is hereby expressly incorporated by reference, in its entirety, into the present application.

### BACKGROUND OF THE INVENTION

### 1. Field of the Invention

The present invention relates to a photo-alignment polymer, a binder composition, a binder layer, an optical laminate, an optical laminate manufacturing method, and an image display device.

### 2. Description of the Related Art

Optical films such as optical compensation sheets or retardation films are used in various image display devices from the viewpoint of solving image staining or enlarging a view angle.

A stretched birefringence film has been used as an optical film, but in recent years, it has been proposed to use an optically anisotropic layer formed of a liquid crystal compound in place of the stretched birefringence film.

In the formation of such an optically anisotropic layer, a photo-alignment film obtained by performing a photo-alignment treatment may be used in order to align the liquid crystal compound.

For example, examples of WO2018/216812A discloses a method of forming an optically anisotropic layer using a photo-alignment polymer represented by the following formula. The photo-alignment polymer contains a cleavage group which is decomposed by the action of an acid to produce a polar group.

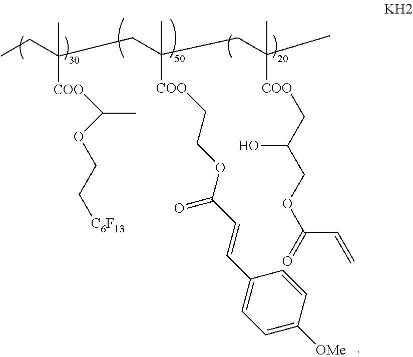

### SUMMARY OF THE INVENTION

Recently, in an optically anisotropic layer formed of a liquid crystal compound, it has been required to further improve aligning properties (liquid crystal aligning properties) of the liquid crystal compound.

The inventors have conducted studies on the photo-alignment polymer containing a cleavage group which is decomposed by the action of an acid to produce a polar group, described in detail in WO2018/216812A, and found that although the liquid crystal aligning properties in an optically anisotropic layer formed on a layer formed of the photo-alignment polymer meet a level required in the past, a further improvement is required to meet a higher required level.

Therefore, an object of the present invention is to provide a photo-alignment polymer having excellent liquid crystal aligning properties.

Another object of the present invention is to provide a binder composition, a binder layer, an optical laminate, an optical laminate manufacturing method, and an image display device.

The inventors have conducted intensive studies to achieve the objects, and as a result, found that the objects can be achieved by the following configurations.

(1) A photo-alignment polymer comprising: a repeating unit having a photo-alignment group; and

a repeating unit having a group represented by Formula (1).

(2) The photo-alignment polymer according to (1), in which the repeating unit having a group represented by Formula (1) is a repeating unit represented by Formula (B).

(3) The photo-alignment polymer according to (1) or (2), in which X represents a group represented by any one of Formula (B1), . . . , or Formula (B3).

(4) The photo-alignment polymer according to any one of (1) to (3), in which the group represented by Formula (1) represents a group represented by any one of Formula (B4), . . . , or Formula (B8).

(5) The photo-alignment polymer according to any one of (1) to (4), in which the repeating unit having a photo-alignment group is a repeating unit represented by Formula (A).

(6) The photo-alignment polymer according to any one of (1) to (5), further comprising a repeating unit having a crosslinkable group.

(7) The photo-alignment polymer according to (6), in which the repeating unit having a crosslinkable group is a repeating unit represented by Formula (C).

(8) The photo-alignment polymer according to (6) or (7), in which the crosslinkable group represents a group represented by any one of Formula (C1), . . . , or Formula (C4).

(9) The photo-alignment polymer according to any one of (6) to (8), in which a content a of the repeating unit having a photo-alignment group, a content b of the repeating unit having a group represented by Formula (1), and a content c of the repeating unit having a crosslinkable group satisfy Expression (D1) in terms of mass ratio.

(10) The photo-alignment polymer according to any one of (1) to (9), in which a weight-average molecular weight is 10,000 to 500,000.

(11) A binder composition comprising: the photo-alignment polymer according to any one of (1) to (10); a binder; and a photo-acid generator.

(12) A binder layer which is formed of the binder composition according to (11), and has a surface having alignment controllability.

(13) An optical laminate comprising: the binder layer according to (12); and

an optically anisotropic layer which is disposed on the binder layer.

(14) An optical laminate manufacturing method comprising: a step of generating an acid from the photo-acid generator in a coating film formed of the composition according to (11), and then performing a photo-alignment treatment to form a binder layer; and

a step of performing coating on the binder layer with a polymerizable liquid crystal composition containing a polymerizable liquid crystal compound to form an optically anisotropic layer.

(15) An image display device comprising: the binder layer according to (12); or the optical laminate according to (13).

According to the present invention, it is possible to provide a photo-alignment polymer having excellent liquid crystal aligning properties.

In addition, according to the present invention, it is possible to provide a binder composition, a binder layer, an optical laminate, an optical laminate manufacturing method, and an image display device.

### DESCRIPTION OF THE PREFERRED EMBODIMENTS

Hereinafter, the present invention will be described in detail.

The following description of constituent requirements is based on typical embodiments of the present invention, but the present invention is not limited thereto.

In this specification, a numerical range expressed using “to” means a range including numerical values before and after “to” as a lower limit and an upper limit.

In addition, the bonding direction of a divalent group (for example, —O—CO—) described in this specification is not particularly limited, and for example, in a case where L² in a “L¹-L²-L³” bond is —O—CO—, and a bonding position on the L′ side is represented by *1 and a bonding position on the L³ side is represented by *2, L² may be *1-O—CO—*2 or *1-CO—O—*2.

Hereinafter, first, a photo-alignment polymer according to the embodiment of the present invention will be described in detail, and then a binder composition, a binder layer, an optical laminate, an optical laminate manufacturing method, and an image display device will be described in detail.

One of features of the photo-alignment polymer according to the embodiment of the present invention is that it has a repeating unit having a group represented by Formula (1).

The inventors have conducted studies on the photo-alignment polymer described in WO2018/216812A, and found that since the cleavage group which is contained in the photo-alignment polymer and is decomposed by the action of an acid to produce a polar group has low acid resistance, the cleavage of the cleavage group in the photo-alignment polymer proceeds in some cases before the formation of a predetermined layer, and as a result, the liquid crystal aligning properties are lowered.

More specifically, in a case where the cleavage of the cleavage group proceeds, a group containing a fluorine atom or a silicon atom in the photo-alignment polymer is eliminated. In a case where a group containing a fluorine atom or a silicon atom introduced to unevenly distribute the photo-alignment polymer on the air interface side is eliminated, a polymer chain portion having a photo-alignment group is not unevenly distributed on the surface of the layer, and a part thereof moves to the inside of the layer. As a result, the alignment controllability of the formed layer is lowered, and the liquid crystal aligning properties are lowered.

With respect to this, in the present invention, the acid resistance of the cleavage group is improved by bonding an aliphatic hydrocarbon group having 1 or more carbon atoms to the cleavage group which is decomposed by the action of an acid to produce a polar group, and the above problem is solved.

<Photo-Alignment Polymer>

A photo-alignment polymer according to the embodiment of the present invention has a repeating unit having a photo-alignment group and a repeating unit having a group represented by Formula (1).

Hereinafter, first, the repeating unit having a group represented by Formula (1) will be described in detail.

(Repeating Unit Having Group Represented by Formula (1))

The photo-alignment polymer according to the embodiment of the present invention has a repeating unit having a group represented by Formula (1). The group represented by Formula (1) includes a predetermined cleavage group as described above, and is cleaved by the action of an acid so that a group containing a fluorine atom or a silicon atom is eliminated and a polar group is produced. In Formula (1), * represents a bonding position.

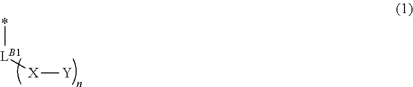

In Formula (1), L^{B1} represents an n+1-valent aliphatic hydrocarbon group having 1 or more carbon atoms.

The number of carbon atoms in the aliphatic hydrocarbon group is 1 or more, and from the viewpoint of more excellent liquid crystal aligning properties of the photo-alignment polymer (hereinafter, also simply referred to as “from the viewpoint of more excellent effects of the present invention”), the number of carbon atoms is preferably 1 to 10, more preferably 1 to 5, and even more preferably 1 to 3.

The aliphatic hydrocarbon group is n+1-valent. For example, in a case where n is 1, the aliphatic hydrocarbon group is a divalent aliphatic hydrocarbon group (so-called alkylene group), in a case where n is 2, the aliphatic hydrocarbon group is a trivalent aliphatic hydrocarbon group, and in a case where n is 3, the aliphatic hydrocarbon group is a tetravalent aliphatic hydrocarbon group.

The aliphatic hydrocarbon group may be linear or branched. In addition, the aliphatic hydrocarbon group may have a cyclic structure. Among these, a linear aliphatic hydrocarbon group is preferable from the viewpoint of more excellent effects of the present invention.

X represents a cleavage group which is decomposed by the action of an acid to produce a polar group.

Examples of the polar group include a carboxy group, a hydroxyl group, and a sulfonic acid group.

As the cleavage group, known cleavage groups can be used. Among these, a group represented by any one of Formula (B1), . . . , or Formula (B3) is preferable, and a group represented by Formula (B1) is more preferable from the viewpoint of more excellent effects of the present invention.

* in Formulae (B1) to (B3) represents a bonding position.

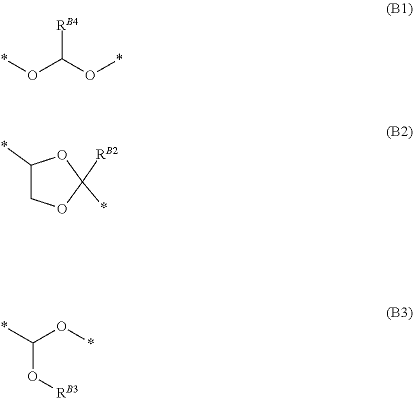

R^{B4} in Formula (B1) represents an alkyl group or an aryl group.

The number of carbon atoms of the alkyl group is not particularly limited, and is preferably 1 to 10, and more preferably 1 to 6.

The alkyl group may be linear, branched, or cyclic.

Examples of the alkyl group include a methyl group, an ethyl group, a propyl group, and a cyclohexyl group.

Examples of the aryl group include a phenyl group and a naphthyl group.

R^{B2} in Formula (B2) represents a hydrogen atom or a substituent.

The type of the substituent represented by R^{B2} is not particularly limited, and known substituents are considered. Examples of the substituent include an alkyl group, an alkenyl group, an alkynyl group, an aryl group, an amino group, an alkoxy group, an aryloxy group, an aromatic heterocyclicoxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, an aromatic heterocyclicthio group, a sulfonyl group, a sulfinyl group, an ureido group, a phosphoric acid amide group, a hydroxy group, a mercapto group, a halogen atom, a cyano group, a sulfo group, a carboxy group, a nitro group, a hydroxamic acid group, a sulfino group, a hydrazino group, an imino group, a heterocyclic group (for example, heteroaryl group), a silyl group, and a group formed by combining the above groups. The substituent may be further substituted with a substituent.

The substituent represented by R^{B2} is preferably an alkyl group.

The alkyl group may be linear or branched. In addition, the alkyl group may have a cyclic structure.

The alkyl group is preferably an alkyl group having 1 to 18 carbon atoms, more preferably an alkyl group having 1 to 8 carbon atoms (for example, a methyl group, an ethyl group, a propyl group, an isopropyl group, an n-butyl group, an isobutyl group, a sec-butyl group, a t-butyl group, and a cyclohexyl group), and even more preferably an alkyl group having 1 to 4 carbon atoms.

R^{B3} in Formula (B3) represents a substituent.

The type of the substituent represented by R^{B3} is not particularly limited, and known substituents are considered. Examples thereof include the examples of the substituent represented by R^{B2}.

The substituent represented by R^{B3} is preferably an alkyl group.

In addition, the substituent represented by R^{B3} is also preferably a group containing a fluorine atom or a silicon atom represented by Y to be described later.

Y represents a group containing a fluorine atom or a silicon atom.

The total number of fluorine atoms and silicon atoms contained in the group containing a fluorine atom or a silicon atom is not particularly limited, and is preferably 1 to 30, more preferably 5 to 25, and even more preferably 10 to 20 from the viewpoint of more excellent effects of the present invention.

The group containing a fluorine atom or a silicon atom is preferably a so-called organic group (carbon atom-containing group). The number of carbon atoms contained in the group containing a fluorine atom or a silicon atom is not particularly limited, and is preferably 1 to 30, more preferably 2 to 20, and even more preferably 3 to 10 from the viewpoint of more excellent effects of the present invention.

Examples of the group containing a fluorine atom or a silicon atom include a group containing a fluorine atom-containing alkyl group to be described later and a group containing a polydialkylsiloxane chain.

The group containing a fluorine atom or a silicon atom is preferably a group represented by Formula (2) from the viewpoint of more excellent effects of the present invention.

*-L^{B3}-Cf Formula (2)

L^{B3} represents a single bond or a divalent linking group.

Examples of the divalent linking group represented by L^{B3} include a divalent hydrocarbon group which may have a substituent, a divalent heterocyclic group, —O—, —S—, —N(Q)-, —CO—, and a group formed by combining the above groups. Q represents a hydrogen atom or a substituent.

Examples of the divalent hydrocarbon group include divalent aliphatic hydrocarbon groups such as an alkylene group having 1 to 10 (preferably 1 to 5) carbon atoms, an alkenylene group having 1 to 10 carbon atoms, and an alkynylene group having 1 to 10 carbon atoms; and divalent aromatic hydrocarbon groups such as an arylene group.

Examples of the divalent heterocyclic group include divalent aromatic heterocyclic groups. Specific examples thereof include a pyridylene group (pyridine-diyl group), a pyridazine-diyl group, an imidazole-diyl group, thienylene (thiophene-diyl group), and a quinolylene group (quinoline-diyl group).

In addition, examples of the group formed by combining the above groups include a group formed by combining at least two selected from the group consisting of a divalent hydrocarbon group, a divalent heterocyclic group, —O—, —S—, —N(Q)-, and —CO— described above. Examples thereof include —O-divalent hydrocarbon group-, —(O-divalent hydrocarbon group)ₚ-O— (p represents an integer of 1 or more), and -divalent hydrocarbon group-O—CO—.

Among these, as the divalent linking group represented by L^{B3}, an alkylene group which may have a substituent and is linear with 1 to 10 carbon atoms, branched with 3 to 10 carbon atoms, or cyclic with 3 to 10 carbon atoms, an arylene group which may have a substituent and has 6 to 12 carbon atoms, —O—, —CO—, —N(Q)-, or a group formed by combining the above groups is preferable, an alkylene group which may have a substituent and is linear with 1 to 10 carbon atoms, branched with 3 to 10 carbon atoms, or cyclic with 3 to 10 carbon atoms or a linear alkylene group which may have a substituent and has 1 to 10 carbon atoms in which at least one —CH₂— is substituted with —O— is more preferable, an alkylene group which is linear with 1 to 5 carbon atoms or branched with 3 to 5 carbon atoms or a linear alkylene group having 1 to 10 carbon atoms in which one —CH₂— is substituted with —O— is even more preferable, and a linear alkylene group having 1 to 3 carbon atoms is particularly preferable.

Examples of the linear alkylene group include a methylene group, an ethylene group, a propylene group, a butylene group, a pentylene group, a hexylene group, and a decylene group.

In addition, examples of the branched alkylene group include a dimethylmethylene group, a methylethylene group, a 2,2-dimethylpropylene group, and a 2-ethyl-2-methylpropylene group.

In addition, examples of the cyclic alkylene group include a cyclopropylene group, a cyclobutylene group, a cyclopentylene group, and a cyclohexylene group.

Here, examples of the optional substituent of the divalent hydrocarbon group (alkylene group, arylene group) and the substituent represented by Q include a halogen atom, an alkyl group, an alkoxy group, an aryl group, an aryloxy group, a cyano group, a carboxy group, an alkoxycarbonyl group, and a hydroxyl group.

Cf represents a fluorine atom-containing organic group. The fluorine atom-containing organic group represents an organic group containing a fluorine atom.

Examples of the fluorine atom-containing organic group include a fluorine atom-containing alkyl group which may contain —O— and a fluorine atom-containing alkenyl group which may contain —O—. A fluorine atom-containing alkyl group or a fluorine atom-containing alkenyl group are preferable, and a fluorine atom-containing alkyl group is more preferable.

The fluorine atom-containing alkyl group represents an alkyl group containing a fluorine atom, and a perfluoroalkyl group is preferable. The fluorine atom-containing alkenyl group represents an alkenyl group containing a fluorine atom, and a perfluoroalkenyl group is preferable.

The number of carbon atoms of the fluorine atom-containing alkyl group is not particularly limited, and is preferably 1 to 30, more preferably 2 to 20, and even more preferably 3 to 10 from the viewpoint of more excellent effects of the present invention.

The number of fluorine atoms contained in the fluorine atom-containing alkyl group is not particularly limited, and is preferably 1 to 30, more preferably 5 to 25, and even more preferably 10 to 20 from the viewpoint of more excellent effects of the present invention.

The number of carbon atoms of the fluorine atom-containing alkenyl group is not particularly limited, and is preferably 1 to 30, more preferably 2 to 20, and even more preferably 3 to 10 from the viewpoint of more excellent effects of the present invention.

The number of fluorine atoms contained in the fluorine atom-containing alkenyl group is not particularly limited, and is preferably 1 to 30, more preferably 5 to 25, and even more preferably 10 to 20 from the viewpoint of more excellent effects of the present invention.

The number of double bonds contained in the fluorine atom-containing alkenyl group is not particularly limited, and is preferably 1 to 3, and more preferably 1.

Examples of the fluorine atom-containing alkyl group which may contain —O— include a group represented by —(XO)ₘ—R^{f}. X represents a perfluoroalkylene group having 1 to 4 carbon atoms, and R^{f} represents a perfluoroalkyl group having 1 to 4 carbon atoms. m represents an integer of 1 or more, and is preferably 2 to 10.

n represents an integer of 1 or more. In the above range, the integer is preferably 1 to 10, more preferably 1 to 5, and even more preferably 1 to 3 from the viewpoint of more excellent effects of the present invention.

The group represented by Formula (1) is preferably a group represented by any one of Formula (B4), . . . , or Formula (B8) from the viewpoint of more excellent effects of the present invention.

* in Formulae (B4) to (B8) represents a bonding position.

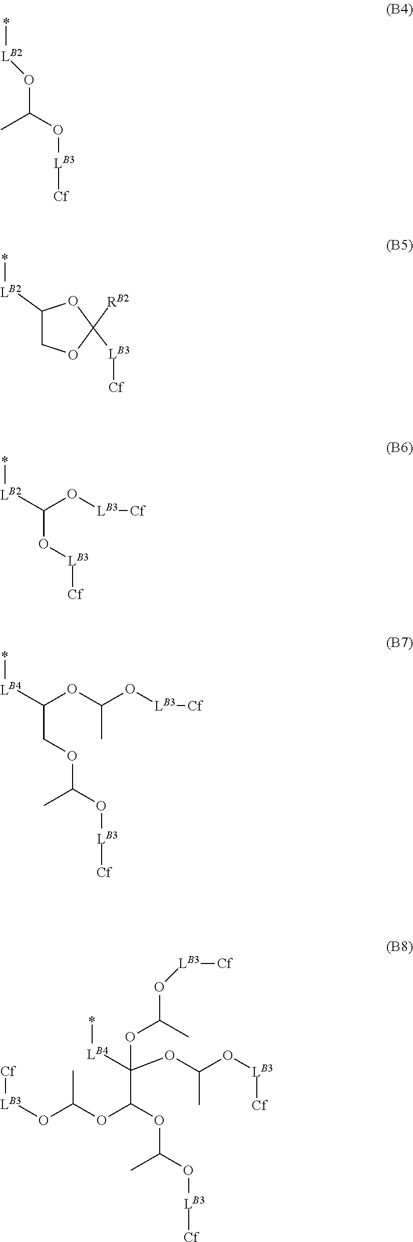

In Formula (B4), L^{B2} represents a divalent aliphatic hydrocarbon group having 1 or more carbon atoms. L^{B3} represents a single bond or a divalent linking group. Cf represents a fluorine atom-containing alkyl group.

Definitions of L^{B3} and Cf are as described above.

The number of carbon atoms contained in the divalent aliphatic saturated hydrocarbon of L^{B2} is 1 or more, and is preferably 1 to 10, more preferably 1 to 5, and even more preferably 1 to 3 from the viewpoint of more excellent effects of the present invention.

The divalent aliphatic hydrocarbon group having 1 or more carbon atoms may be linear or branched. In addition, the divalent aliphatic hydrocarbon group having 1 or more carbon atoms may have a cyclic structure.

Specific examples of the divalent aliphatic hydrocarbon group include a linear alkylene group, a branched alkylene group, and a cyclic alkylene group.

Examples of the linear alkylene group include a methylene group, an ethylene group, a propylene group, a butylene group, a pentylene group, a hexylene group, and a decylene group.

In addition, examples of the branched alkylene group include a dimethylmethylene group, a methylethylene group, a 2,2-dimethylpropylene group, and a 2-ethyl-2-methylpropylene group.

In addition, examples of the cyclic alkylene group include a cyclopropylene group, a cyclobutylene group, a cyclopentylene group, a cyclohexylene group, a cyclooctylene group, a cyclodecylene group, an adamantane-diyl group, a norbornane-diyl group, and an exo-tetrahydrodicyclopentadiene-diyl group.

In Formula (B5), L^{B2} represents a divalent aliphatic hydrocarbon group having 1 or more carbon atoms. R^{B2} represents a hydrogen atom or a substituent. L^{B3} represents a single bond or a divalent linking group. Cf represents a fluorine atom-containing alkyl group.

Definitions of L^{B2}, R^{B2}, L^{B3}, and Cf are as described above.

In Formula (B6), L^{B2} represents a divalent aliphatic hydrocarbon group having 1 or more carbon atoms. L^{B3} each independently represent a single bond or a divalent linking group. Cf each independently represent a fluorine atom-containing alkyl group.

Definitions of L^{B2}, L^{B3}, and Cf are as described above.

In Formula (B7), L^{B4} represents a single bond or a divalent aliphatic hydrocarbon group having 1 or more carbon atoms. L^{B3} each independently represent a single bond or a divalent linking group. Cf each independently represent a fluorine atom-containing alkyl group.

Definitions of L^{B3} and Cf are as described above.

L^{B4} represents a single bond or a divalent aliphatic hydrocarbon group having 1 or more carbon atoms. A definition of the divalent aliphatic hydrocarbon group having 1 or more carbon atoms represented by L^{B4} is the same as that of the divalent aliphatic hydrocarbon group having 1 or more carbon atoms represented by L^{B2}.

In Formula (B8), L^{B4} represents a single bond or a divalent aliphatic hydrocarbon group having 1 or more carbon atoms. L^{B3} each independently represent a single bond or a divalent linking group. Cf each independently represent a fluorine atom-containing alkyl group.

Definitions of L^{B3}, L^{B4}, and Cf are as described above.

The structure of a main chain of the repeating unit having a group represented by Formula (1) is not particularly limited, and known structures are considered. For example, a skeleton selected from the group consisting of a (meth)acrylic skeleton, a styrene-based skeleton, a siloxane-based skeleton, a cycloolefin-based skeleton, a methylpentene-based skeleton, an amide-based skeleton, and an aromatic ester-based skeleton is preferable.

Among these, a skeleton selected from the group consisting of a (meth)acrylic skeleton, a siloxane-based skeleton, and a cycloolefin-based skeleton is more preferable, and a (meth)acrylic skeleton is even more preferable.

(Meth)acrylic is a general term for acrylic and methacrylic.

The repeating unit having a group represented by Formula (1) is preferably a repeating unit represented by Formula (B) from the viewpoint of more excellent effects of the present invention.

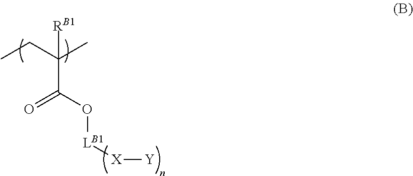

In Formula (B), R^{B1} represents a hydrogen atom or a substituent.

The type of the substituent represented by R^{B1} is not particularly limited, and known substituents are considered. Examples thereof include the examples of the substituent represented by R^{B2}. Among these, an alkyl group having 1 to 3 carbon atoms is preferable.

Definitions of L^{B1}, X, Y, and n in Formula (B) are the same as those of L^{B1}, X, Y, and n in Formula (1), respectively.

The repeating unit having a group represented by Formula (1) is preferably a repeating unit represented by Formula (E). A definition of R^{B1} in Formula (E) is the same as that of L^{B1} in Formula (1). Z in Formula (E) represents a group represented by any one of Formula (B4), . . . , or Formula (B8).

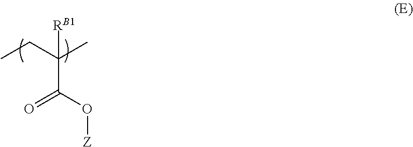

Specific examples of the repeating unit having a group represented by Formula (1) are as follow.

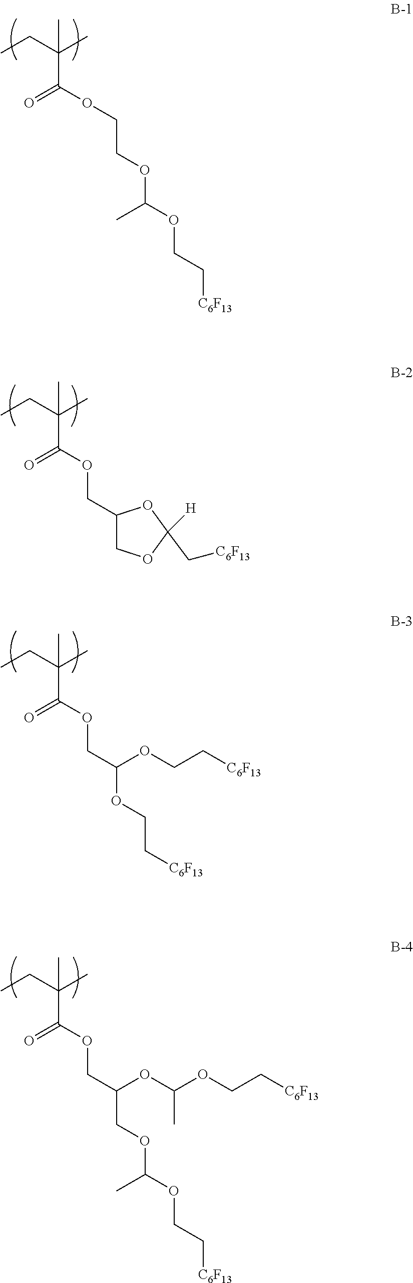

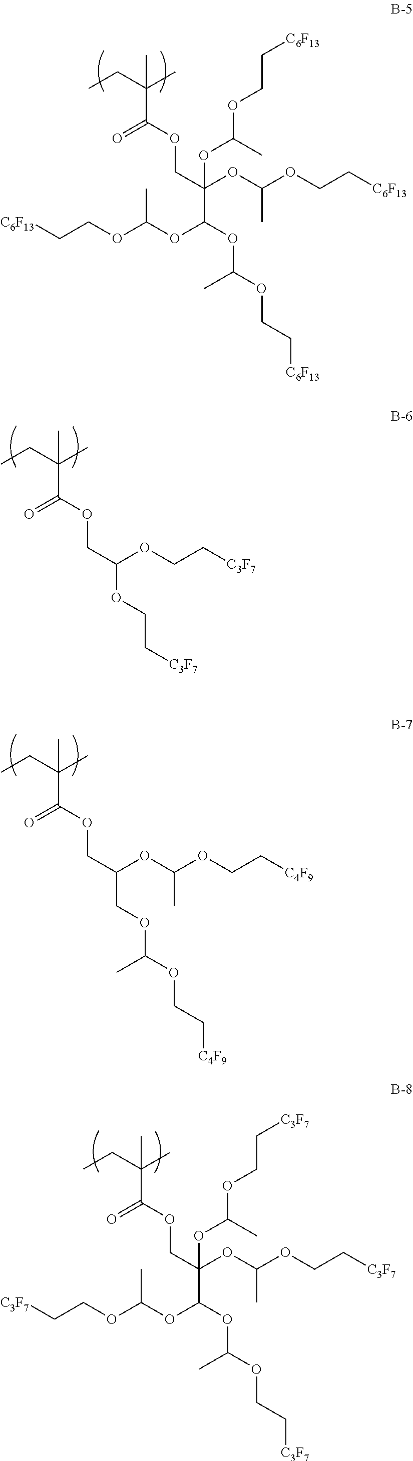

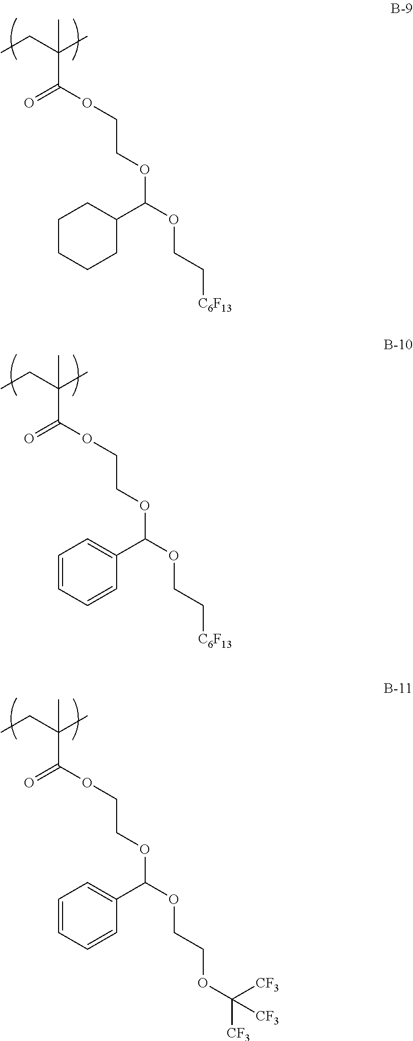

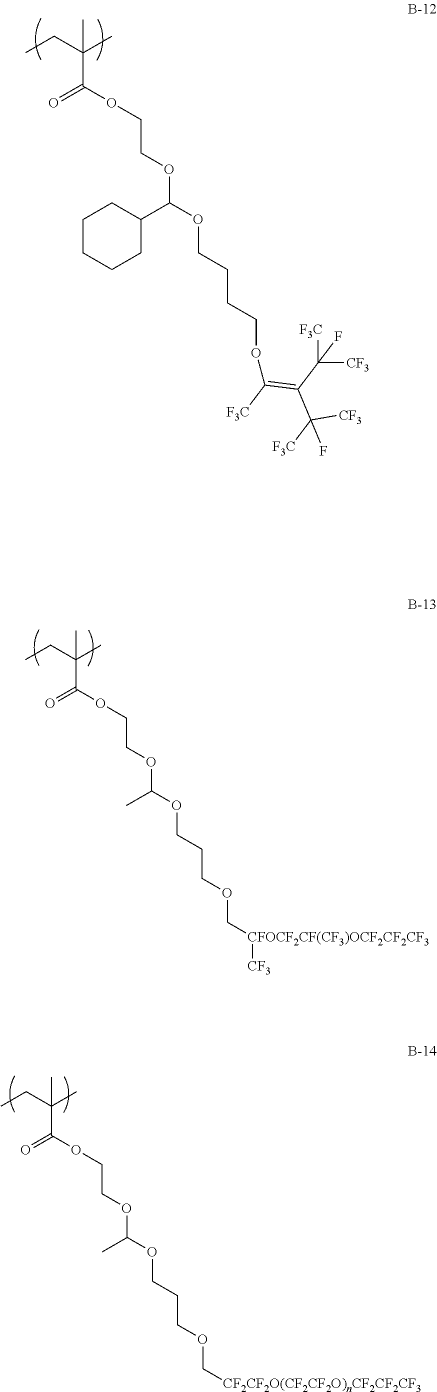

The content of the repeating unit having a group represented by Formula (1) in the photo-alignment polymer is not particularly limited, and is preferably 3 mass % or more, more preferably 5 mass % or more, even more preferably 10 mass % or more, particularly preferably 20 mass % or more, preferably 95 mass % or less, more preferably 80 mass % or less, even more preferably 60 mass % or less, particularly preferably 50 mass % or less, and most preferably 30 mass % or less with respect to all the repeating units of the photo-alignment polymer from the viewpoint of more excellent effects of the present invention.

(Repeating Unit Having Photo-Alignment Group)

The photo-alignment polymer has a repeating unit having a photo-alignment group.

The photo-alignment group refers to a group having a photo-alignment function in which rearrangement or an anisotropic chemical reaction is induced by irradiation with light having anisotropy (for example, plane-polarized light), and from the viewpoint of excellent alignment uniformity and improved thermal stability and chemical stability, a photo-alignment group in which at least one of dimerization or isomerization is caused by the action of light is preferable.

Suitable examples of the photo-alignment group which is dimerized by the action of light include groups having a skeleton of at least one type of derivative selected from the group consisting of cinnamic acid derivatives (M. Schadt et al., J. Appl. Phys., vol. 31, No. 7, page 2155 (1992)), coumarin derivatives (M. Schadt et al., Nature., vol. 381, page 212 (1996)), chalcone derivatives (Toshihiro Ogawa et al., Preprints of Symposium on Liquid Crystals (Ekisho Toronkai Koen Yokoshu in Japanese), 2AB03 (1997)), maleimide derivatives, and benzophenone derivatives (Y. K. Jang et al., SID Int. Symposium Digest, P-53 (1997)).

Suitable examples of the photo-alignment group which is isomerized by the action of light include groups having a skeleton of at least one type of compound selected from the group consisting of azobenzene compounds (K. Ichimura et al., Mol. Cryst. Liq. Cryst., 298, 221 (1997)), stilbene compounds. (J. G. Victor and J. M. Torkelson, Macromolecules, 20, 2241 (1987)), spiropyran compounds (K. Ichimura et al., Chemistry Letters, page 1063 (1992); K. Ichimura et al., Thin Solid Films, vol. 235, page 101 (1993)), cinnamic acid compounds (K. Ichimura et al., Macromolecules, 30, 903 (1997)), and hydrazono-β-ketoester compounds (S. Yamamura et al., Liquid Crystals, vol. 13, No. 2, page 189 (1993)).

As the photo-alignment group, a group having a skeleton of at least one type of derivative selected from the group consisting of cinnamic acid derivatives, coumarin derivatives, chalcone derivatives, maleimide derivatives, azobenzene compounds, stilbene compounds, and spiropyran compounds is preferable, and a group having a skeleton of a cinnamic acid derivative or a coumarin derivative is more preferable.

The structure of a main chain of the repeating unit having a photo-alignment group is not particularly limited, and known structures are considered. For example, a skeleton selected from the group consisting of a (meth)acrylic skeleton, a styrene-based skeleton, a siloxane-based skeleton, a cycloolefin-based skeleton, a methylpentene-based skeleton, an amide-based skeleton, and an aromatic ester-based skeleton is preferable.

Among these, a skeleton selected from the group consisting of a (meth)acrylic skeleton, a siloxane-based skeleton, and a cycloolefin-based skeleton is more preferable, and a (meth)acrylic skeleton is even more preferable.

The repeating unit having a photo-alignment group is preferably a repeating unit represented by Formula (A) from the viewpoint of more excellent effects of the present invention.

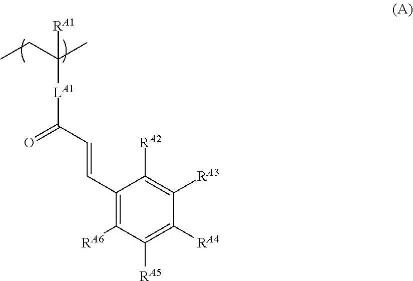

In Formula (A), R^{A1} represents a hydrogen atom or a methyl group.

L^{A1} represents a single bond or a divalent linking group.

A definition of the divalent linking group represented by L^{A1} is the same as that of the divalent linking group represented by L^{B3} described above. Among these, from the viewpoint of more excellent effects of the present invention, a divalent linking group formed by combining at least two selected from the group consisting of an alkylene group which may have a substituent and is linear with 1 to 10 carbon atoms, branched with 3 to 10 carbon atoms, or cyclic with 3 to 10 carbon atoms, an arylene group which may have a substituent and has 6 to 12 carbon atoms, —O—, —CO—, and —N(Q)- is preferable as the divalent linking group represented by L^{A1}. Q represents a hydrogen atom or a substituent.

Examples of the optional substituent of the alkylene group and the arylene group and the substituent represented by Q include a halogen atom, an alkyl group, an alkoxy group, an aryl group, an aryloxy group, a cyano group, a carboxy group, an alkoxycarbonyl group, and a hydroxyl group.

As the divalent linking group represented by L^{A1}, a combination of an alkylene group which may have a substituent and is linear with 1 to 10 carbon atoms, branched with 3 to 10 carbon atoms, or cyclic with 3 to 10 carbon atoms and an arylene group which may have a substituent and has 6 to 12 carbon atoms can be selected as described above.

Examples of the alkylene group which may have a substituent and is linear with 1 to 10 carbon atoms, branched with 3 to 10 carbon atoms, or cyclic with 3 to 10 carbon atoms include the linear, branched, or cyclic alkylene group described for the divalent aliphatic hydrocarbon group.

Examples of the arylene group having 6 to 12 carbon atoms include a phenylene group, a xylylene group, a biphenylene group, a naphthylene group, and a 2,2′-methylenebisphenyl group, and a phenylene group is preferable.

Among these, from the viewpoint of more excellent effects of the present invention, a divalent linking group containing at least one of a linear alkylene group which may have a substituent and has 1 to 10 carbon atoms, a cyclic alkylene group which may have a substituent and has 3 to 10 carbon atoms, or an arylene group which may have a substituent and has 6 to 12 carbon atoms is preferable, a divalent linking group containing at least a linear alkylene group which may have a substituent and has 1 to 10 carbon atoms or a cyclic alkylene group which may have a substituent and has 3 to 10 carbon atoms is more preferable, and a divalent linking group containing an unsubstituted linear alkylene group having 2 to 6 carbon atoms or unsubstituted trans-1,4-cyclohexylene is even more preferable as L^{A1} of Formula (A).

In a case where a divalent linking group containing at least a linear alkylene group which may have a substituent and has 1 to 10 carbon atoms and a divalent linking group containing at least a cyclic alkylene group which may have a substituent and has 3 to 10 carbon atoms are compared, more excellent effects are obtained with a divalent linking group containing at least a cyclic alkylene group which may have a substituent and has 3 to 10 carbon atoms.

In addition, —CO—O— (a linear alkylene group which may have a substituent and has 1 to 10 (preferably 1 to 5) carbon atoms)-, —CO—O— (a cyclic alkylene group which may have a substituent and has 3 to 10 (preferably 6) carbon atoms)-, —CO—NH— (a linear alkylene group which may have a substituent and has 1 to 10 (preferably 1 to 5) carbon atoms)-, or —CO—NH— (a cyclic alkylene group which may have a substituent and has 3 to 10 (preferably 6) carbon atoms)- is also preferable as L^{A1} of Formula (A).

R^{A2}, R^{A3}, R^{A4}, R^{A5}, and R^{A6} each independently represent a hydrogen atom or a substituent. The type of the substituent is not particularly limited, and known substituents are considered. Examples thereof include the examples of the substituent represented by R^{B2}.

Two adjacent groups of R^{A2}, R^{A3}, R^{A4}, R^{A5}, and R^{A6} may be bonded to form a ring.

R^{A2}, R^{A3}, R^{A4}, R^{A5}, and R^{A6} are each independently preferably a halogen atom, a linear, branched, or cyclic alkyl group having 1 to 20 carbon atoms, a linear halogenated alkyl group having 1 to 20 carbon atoms, an alkoxy group having 1 to 20 carbon atoms, an aryl group having 6 to 20 carbon atoms, an aryloxy group having 6 to 20 carbon atoms, a cyano group, an amino group, or a group represented by Formula (3) from the viewpoint of more excellent effects of the present invention.

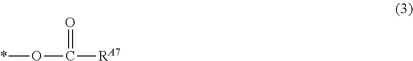

Here, in Formula (3), * represents a bonding position.

R^{A7} represents a linear or cyclic alkyl group having 1 to 20 carbon atoms.

Examples of the halogen atom include a fluorine atom, a chlorine atom, a bromine atom, and an iodine atom, and a fluorine atom or a chlorine atom is preferable.

Among the linear, branched, or cyclic alkyl groups having 1 to 20 carbon atoms, the linear alkyl group is preferably an alkyl group having 1 to 6 carbon atoms, and examples thereof include a methyl group, an ethyl group, and an n-propyl group.

The branched alkyl group is preferably an alkyl group having 3 to 6 carbon atoms, and examples thereof include an isopropyl group and a tert-butyl group.

The cyclic alkyl group is preferably an alkyl group having 3 to 6 carbon atoms, and examples thereof include a cyclopropyl group, a cyclopentyl group, and a cyclohexyl group.

The linear halogenated alkyl group having 1 to 20 carbon atoms is preferably a fluoroalkyl group having 1 to 4 carbon atoms. Examples thereof include a trifluoromethyl group, a perfluoroethyl group, a perfluoropropyl group, and a perfluorobutyl group, and a trifluoromethyl group is preferable.

The alkoxy group having 1 to 20 carbon atoms is preferably an alkoxy group having 1 to 18 carbon atoms, more preferably an alkoxy group having 3 to 18 carbon atoms, and even more preferably an alkoxy group having 6 to 18 carbon atoms. Examples thereof include a methoxy group, an ethoxy group, an n-butoxy group, a methoxyethoxy group, an n-hexyloxy group, an n-octyloxy group, an n-decyloxy group, an n-dodecyloxy group, and an n-tetradecyloxy group.

The aryl group having 6 to 20 carbon atoms is preferably an aryl group having 6 to 12 carbon atoms, and examples thereof include a phenyl group, an α-methylphenyl group, and a naphthyl group.

The aryloxy group having 6 to 20 carbon atoms is preferably an aryloxy group having 6 to 12 carbon atoms, and examples thereof include a phenyloxy group and a 2-naphthyloxy group.

Examples of the amino group include: primary amino groups (—NH₂); secondary amino groups such as a methylamino group; and tertiary amino groups such as a dimethylamino group, a diethylamino group, a dibenzylamino group, and a group having a nitrogen atom of a nitrogen-containing heterocyclic compound (for example, pyrrolidine, piperidine, and piperazine) as a bonding site.

From the viewpoint of the fact that the photo-alignment group is easy to interact with the liquid crystal compound, and the liquid crystal aligning properties are thus improved, at least R^{A4} among R^{A4}, R^{A5}, among R^{A2}, and R^{A6} in Formula (A) preferably represents the above-described substituent (preferably an alkoxy group having 1 to 20 carbon atoms). Moreover, since the linearity of a photo-alignment polymer to be obtained is improved, the interaction with the liquid crystal compound is made easier, and the liquid crystal aligning properties are thus improved, it is more preferable that R^{A2}, R^{A3}, R^{A5}, and R^{A6} all represent a hydrogen atom.

From the viewpoint of an improvement in reaction efficiency of the photo-alignment group, R^{A4} of Formula (A) is preferably an electron-donating substituent.

Here, the electron-donating substituent (electron-donating group) refers to a substituent having a Hammett value (Hammett substituent constant σp) of 0 or less, and an alkyl group, a halogenated alkyl group, an alkoxy group, and the like are exemplified among the above-described substituents.

Among these, an alkoxy group is preferable, an alkoxy group having 4 to 18 carbon atoms is more preferable, an alkoxy group having 6 to 18 carbon atoms is even more preferable, and an alkoxy group having 8 to 18 carbon atoms is particularly preferable from the viewpoint of more excellent liquid crystal aligning properties.

Specific examples of the repeating unit having a photo-alignment group are as follows.

In the following formulae, Me represents a methyl group, and Et represents an ethyl group. In the following specific examples, the “1,4-cyclohexyl group” contained in the divalent linking group of A-31 and the like may be either a cis-form or a trans-form, and is preferably a trans-form.

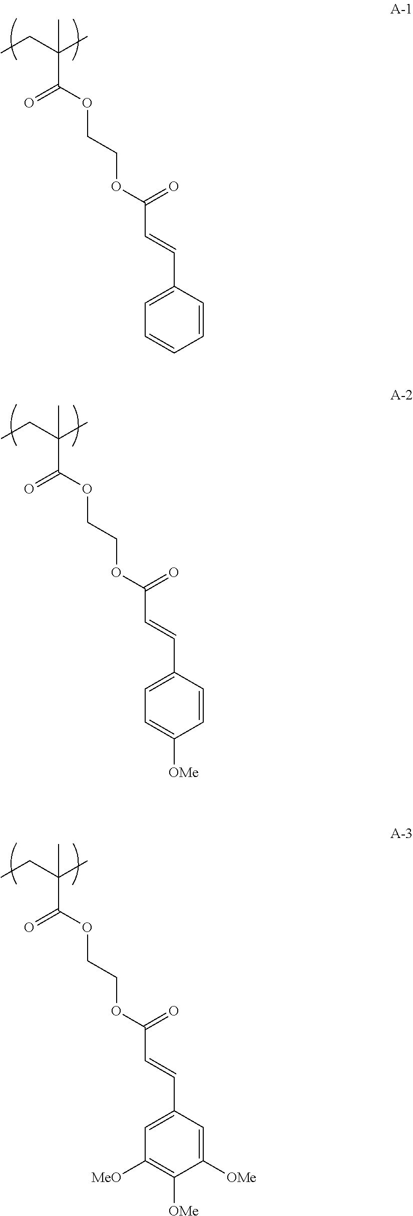

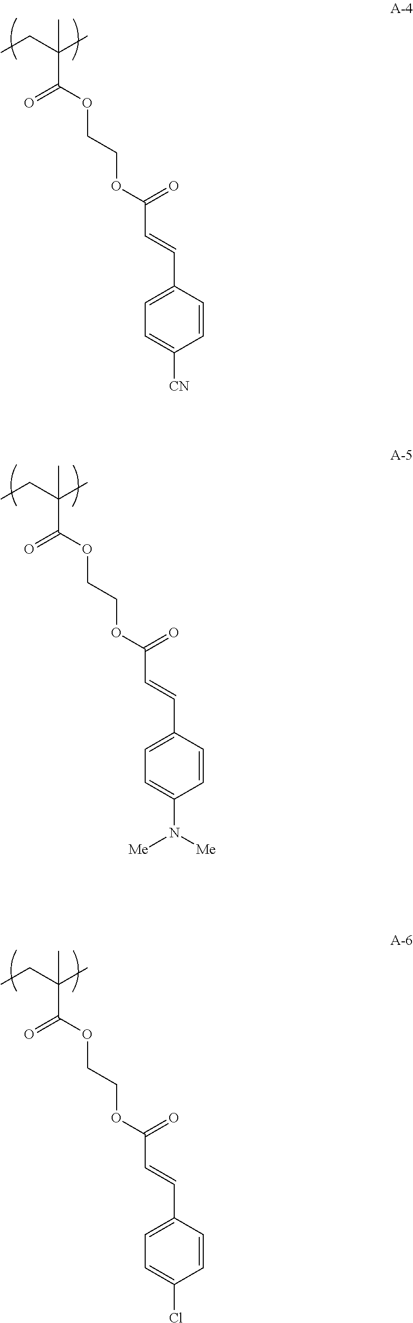

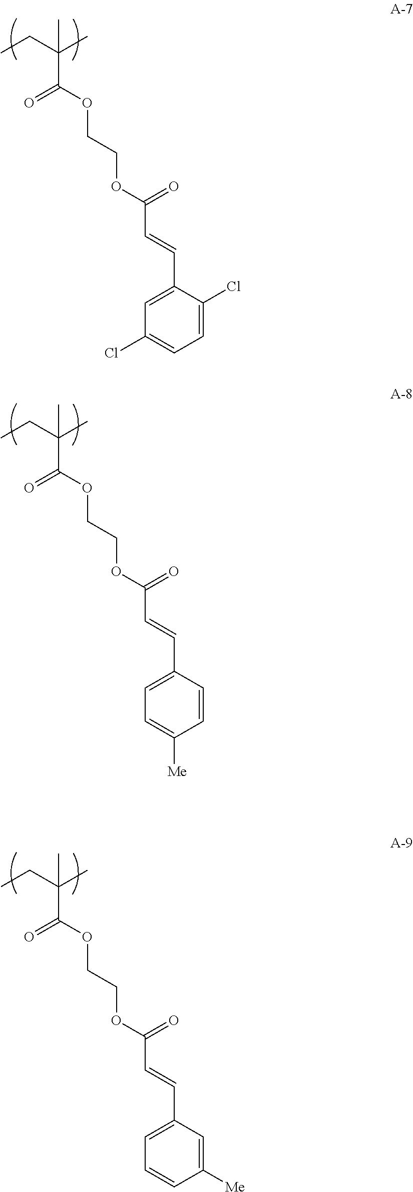

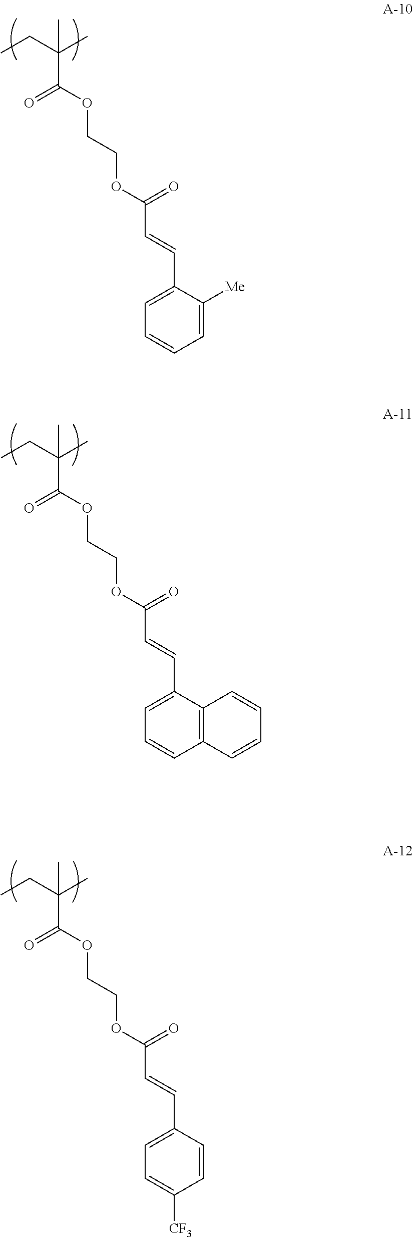

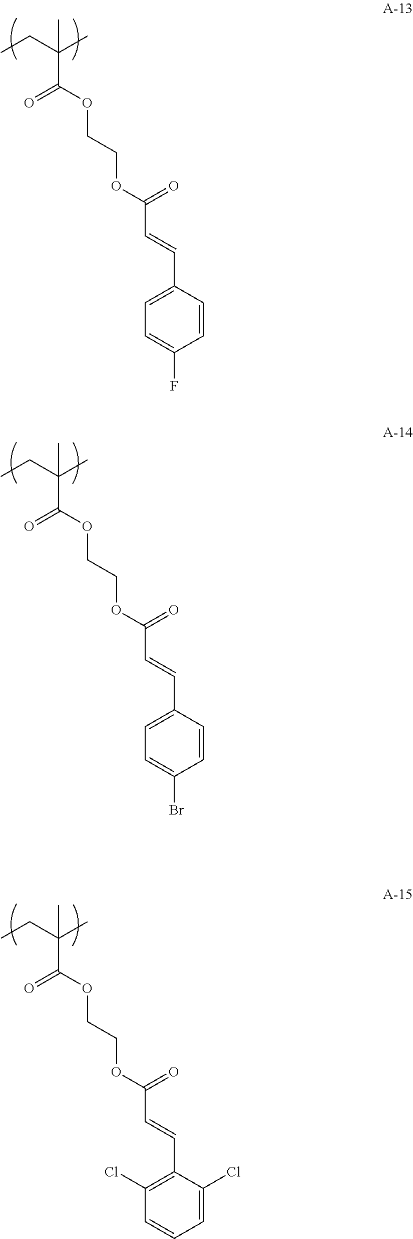

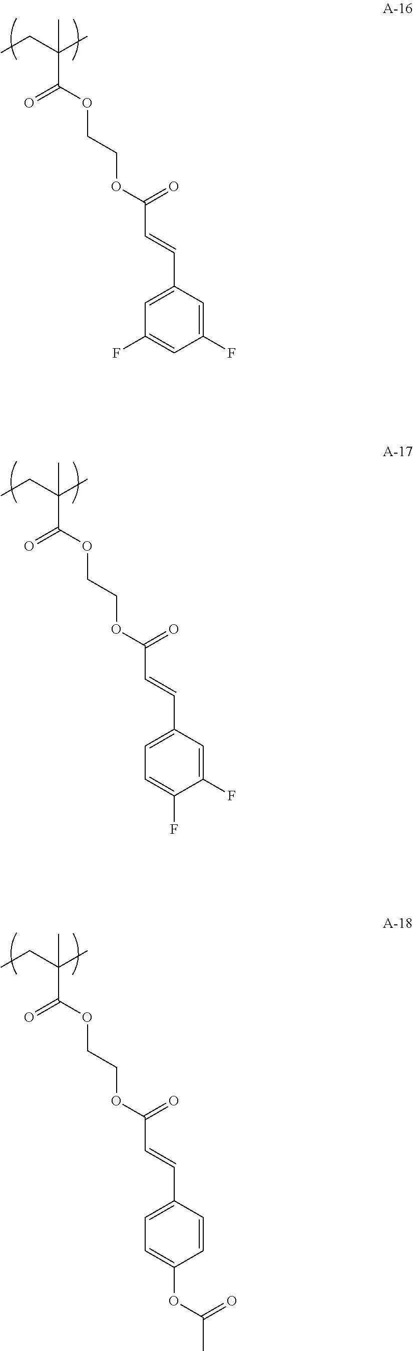

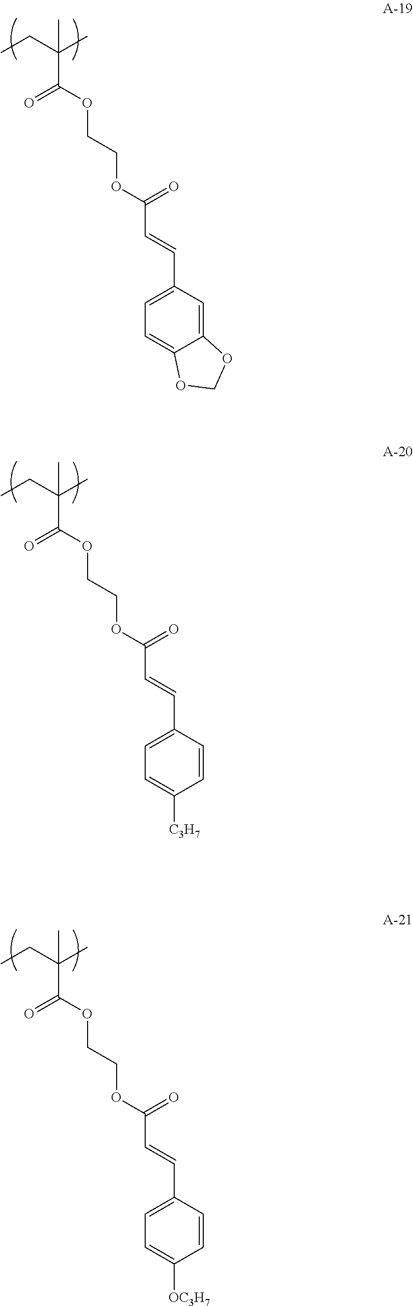

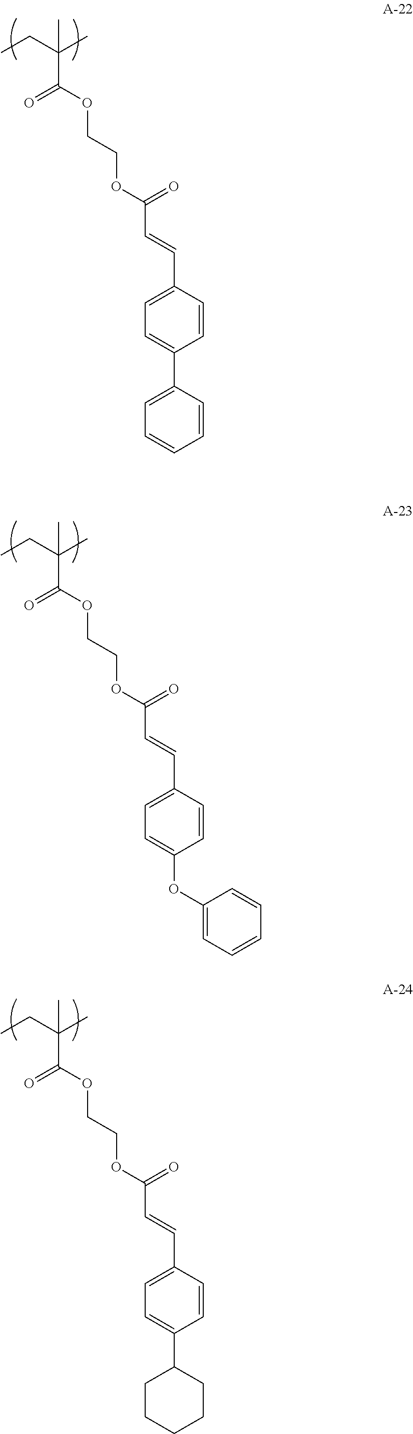

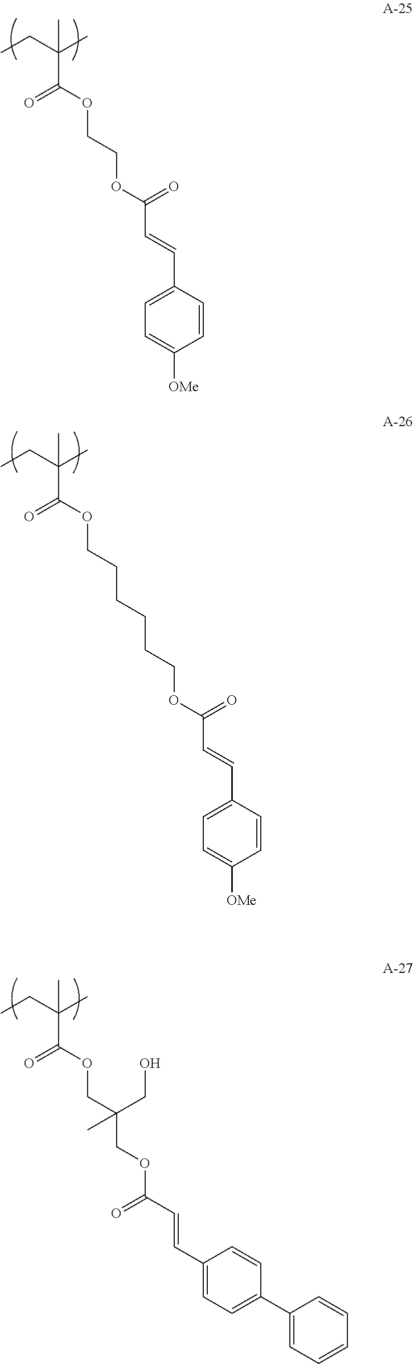

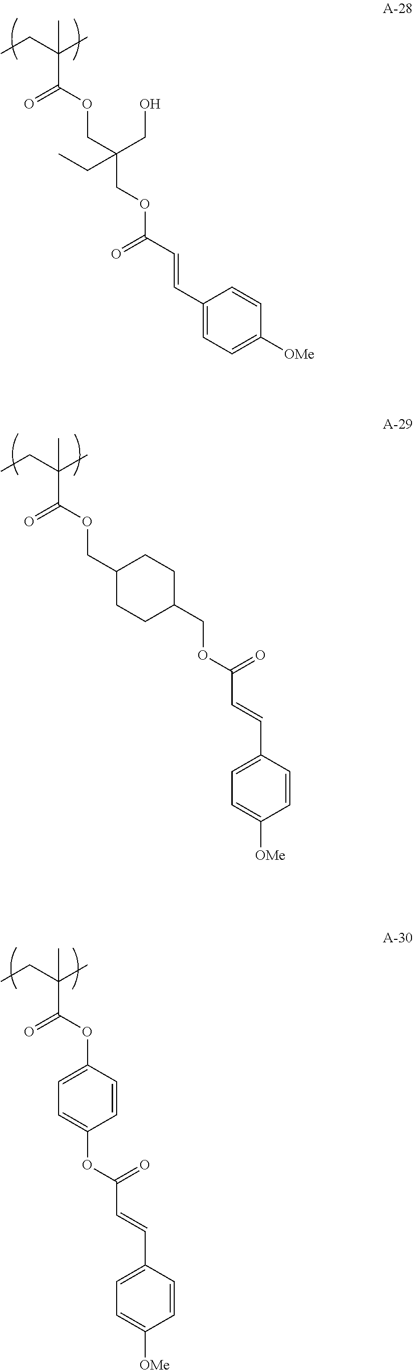

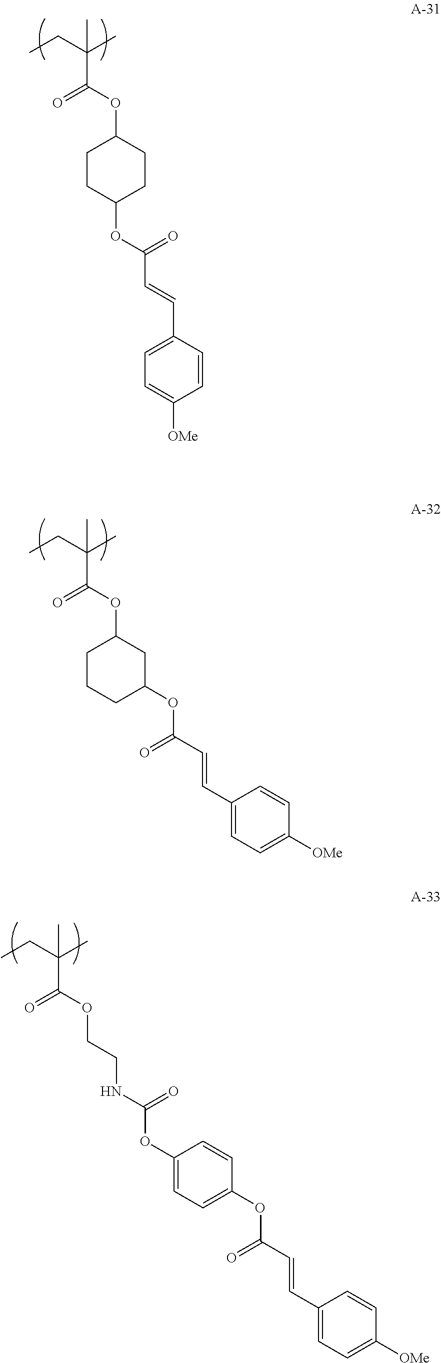

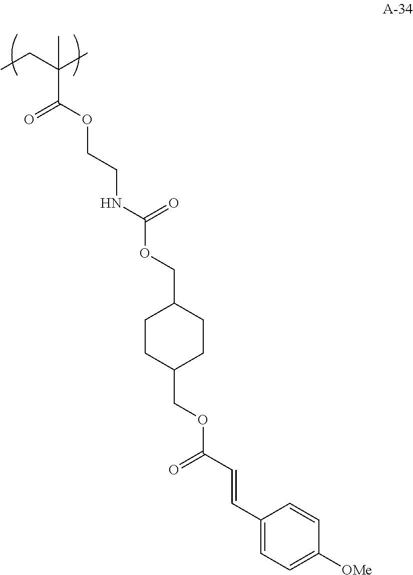

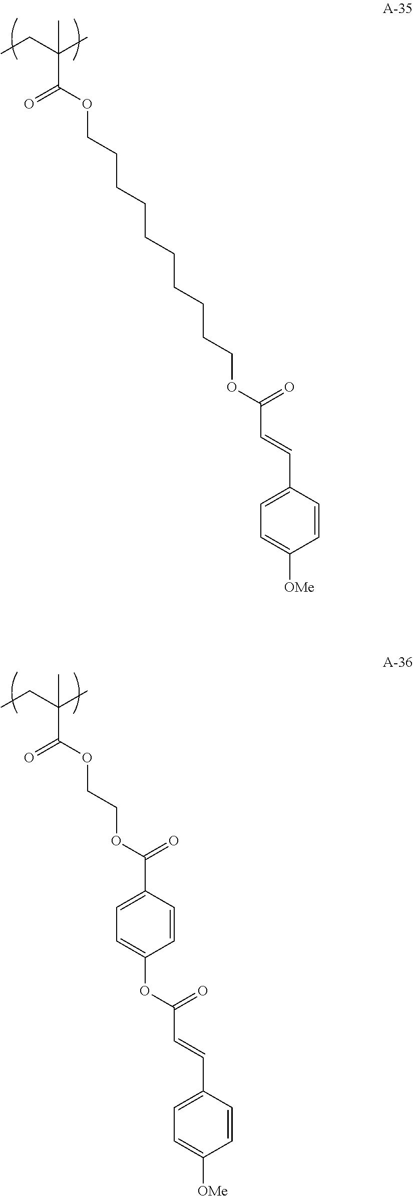

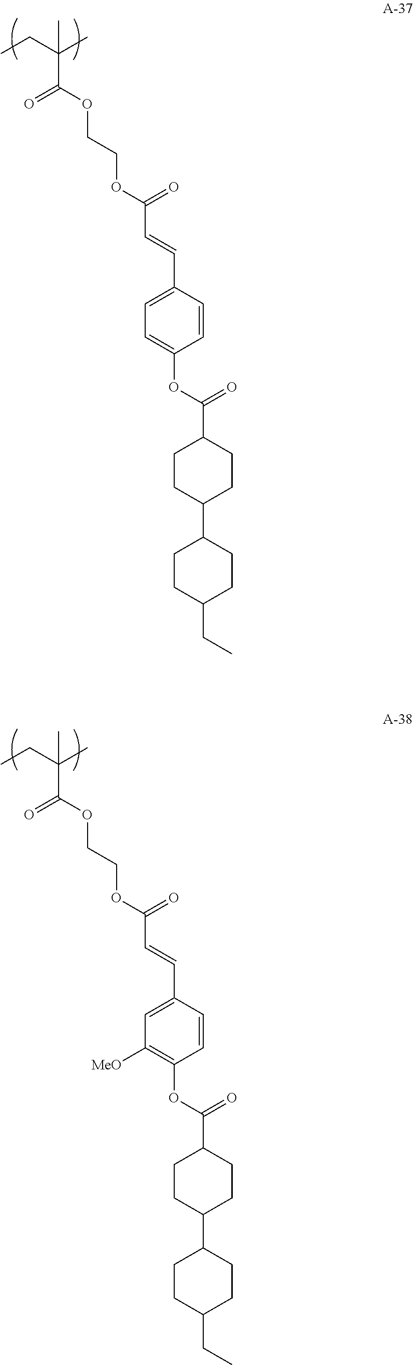

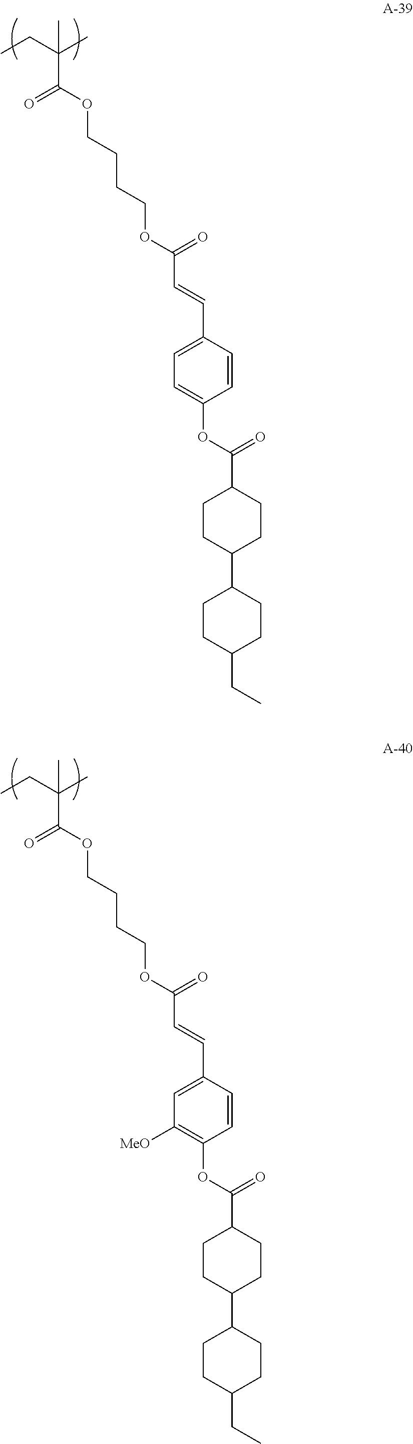

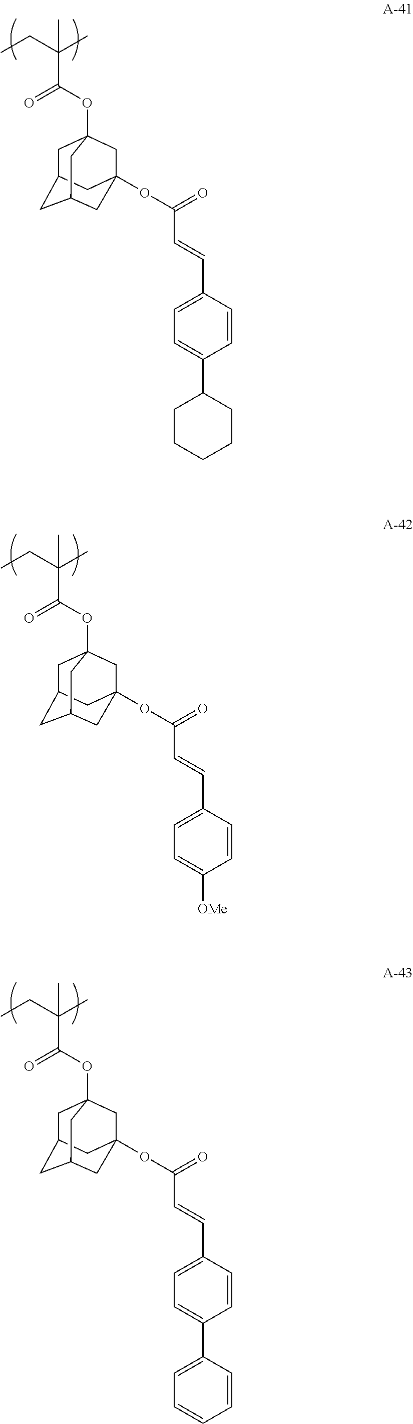

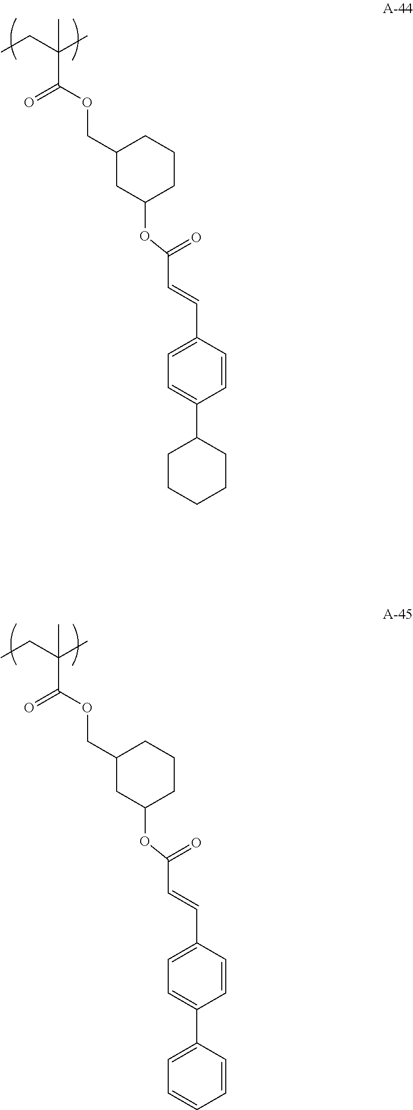

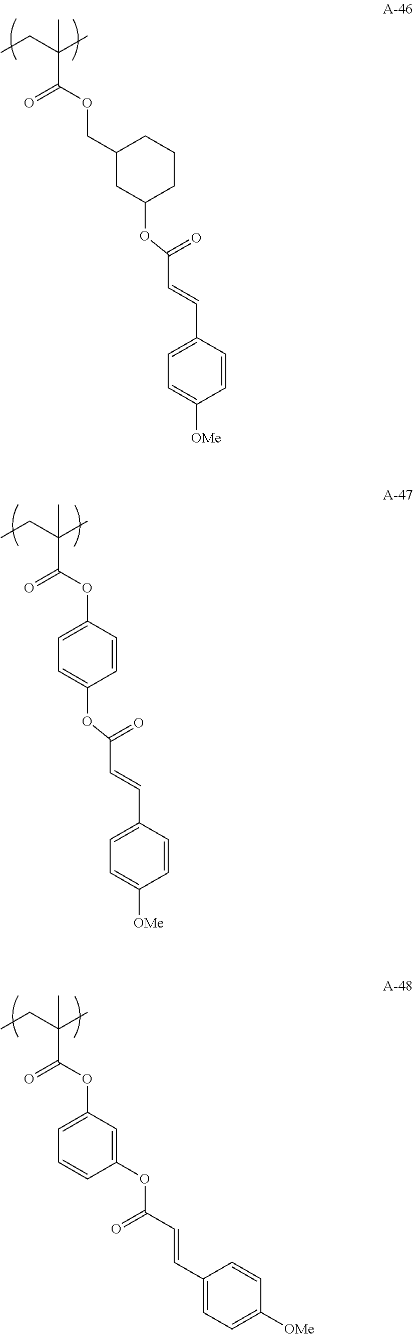

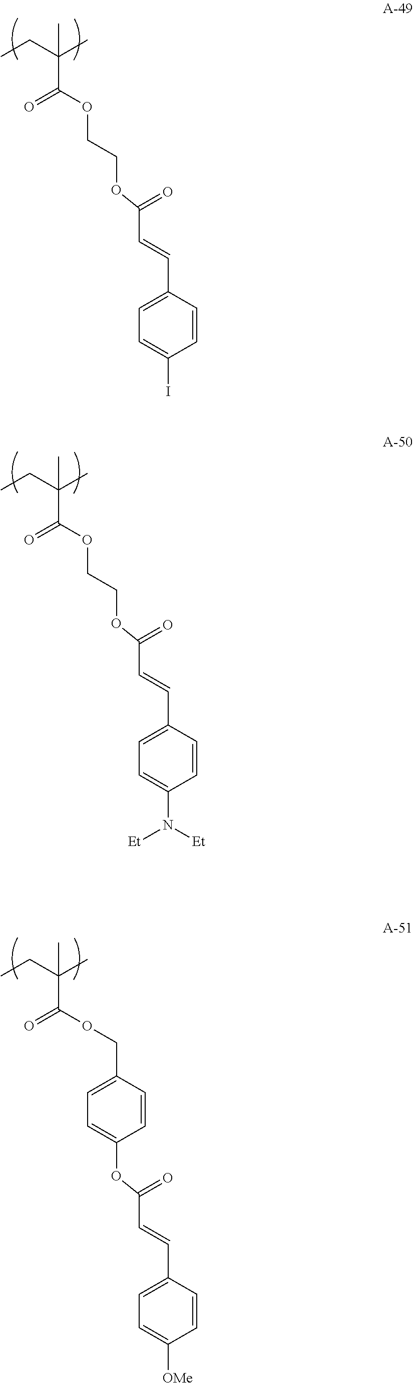

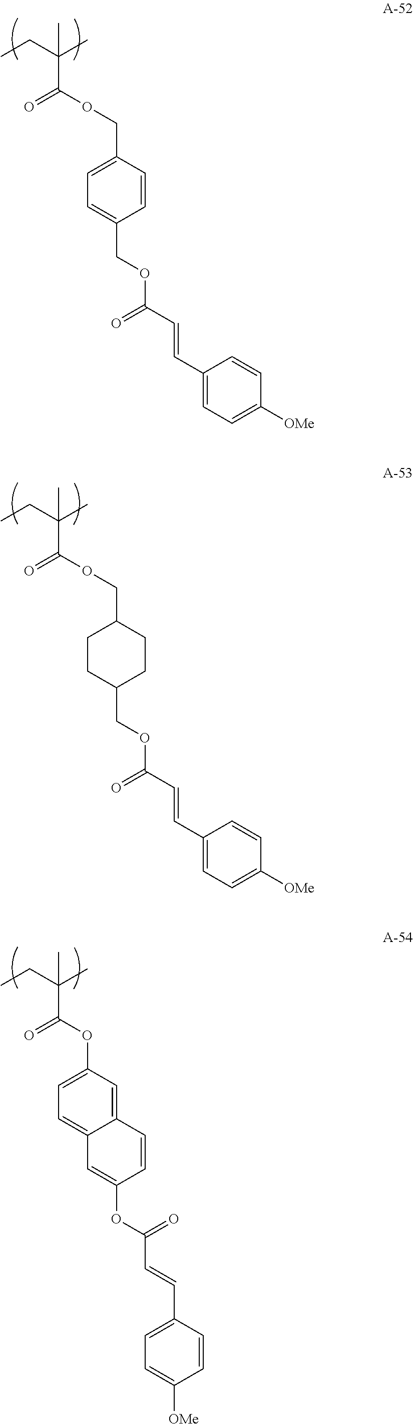

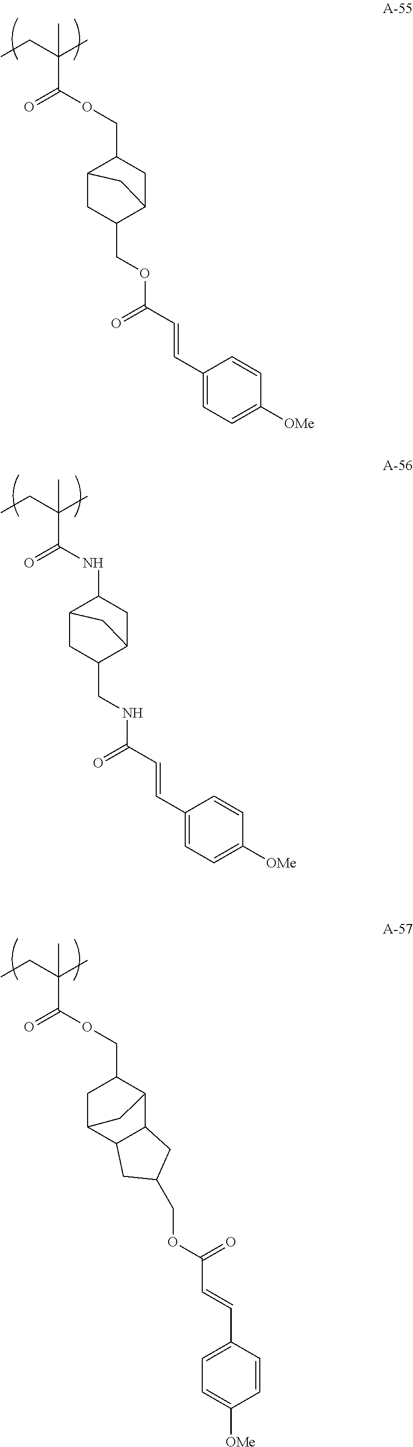

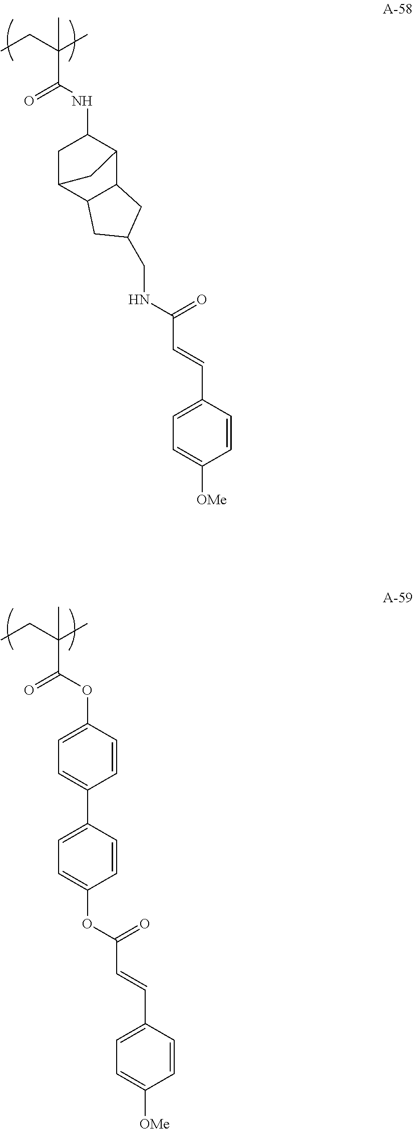

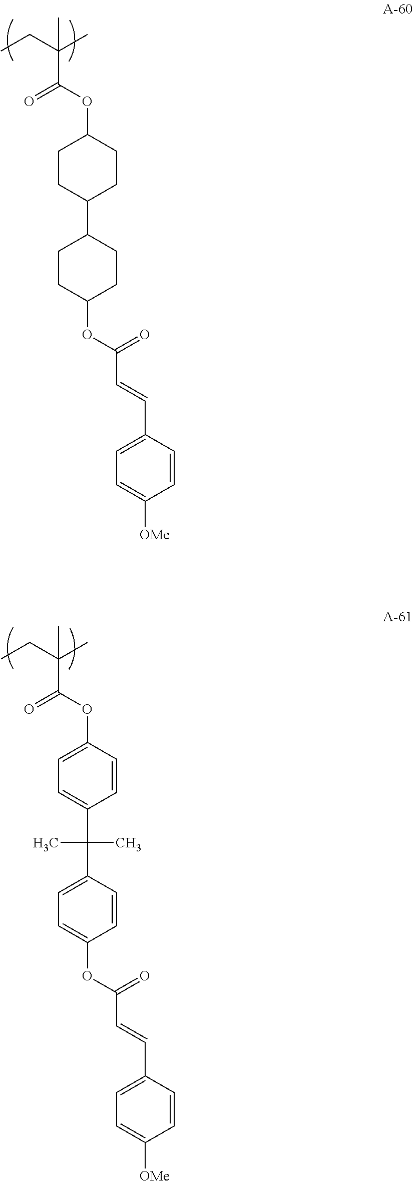

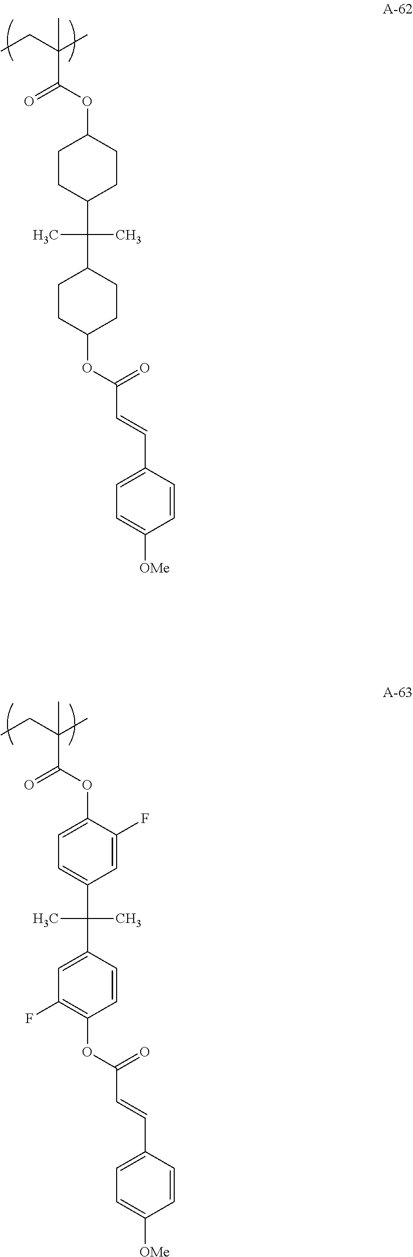

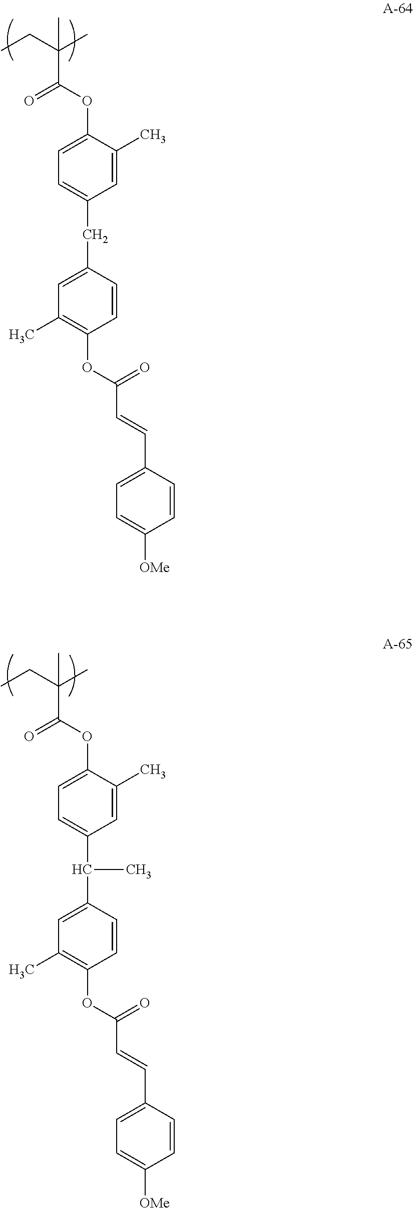

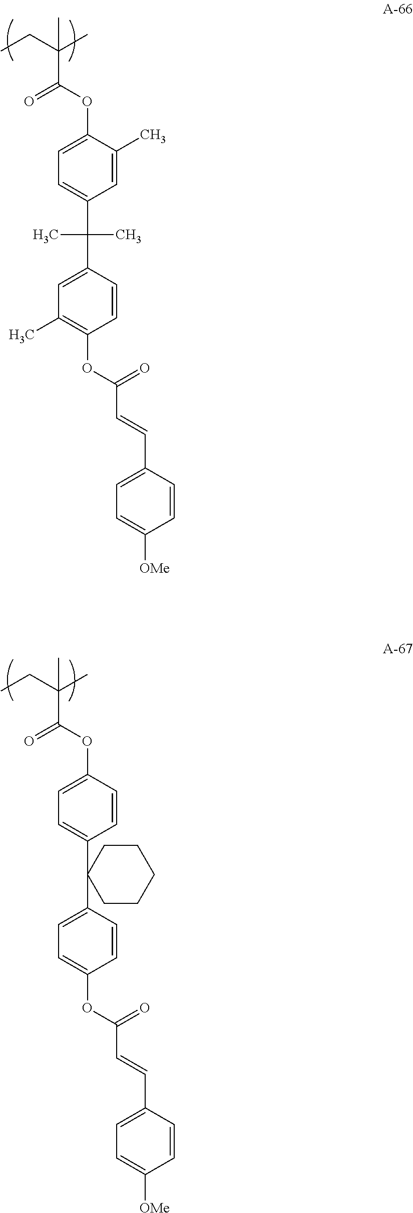

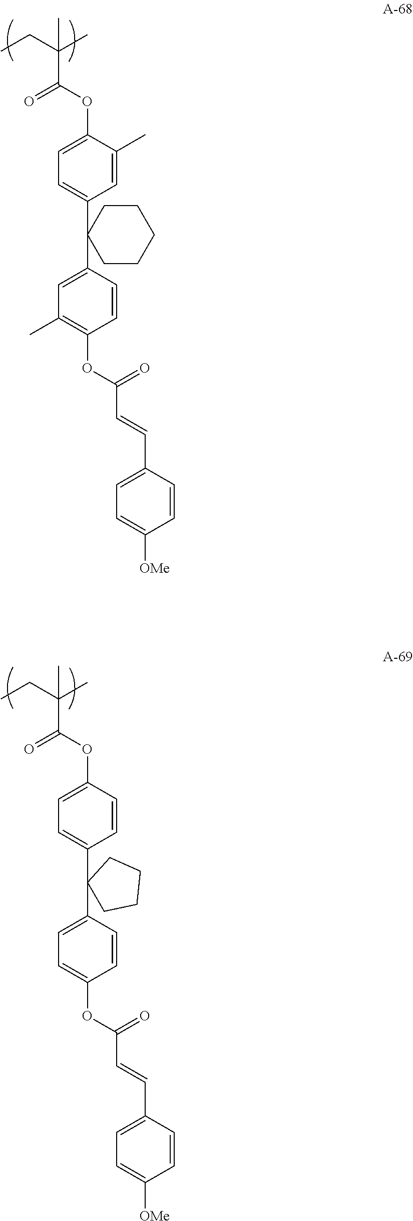

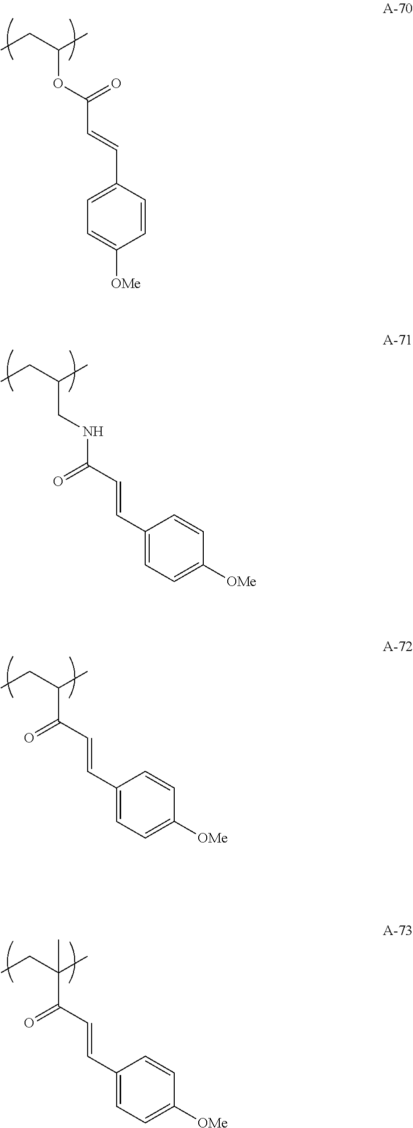

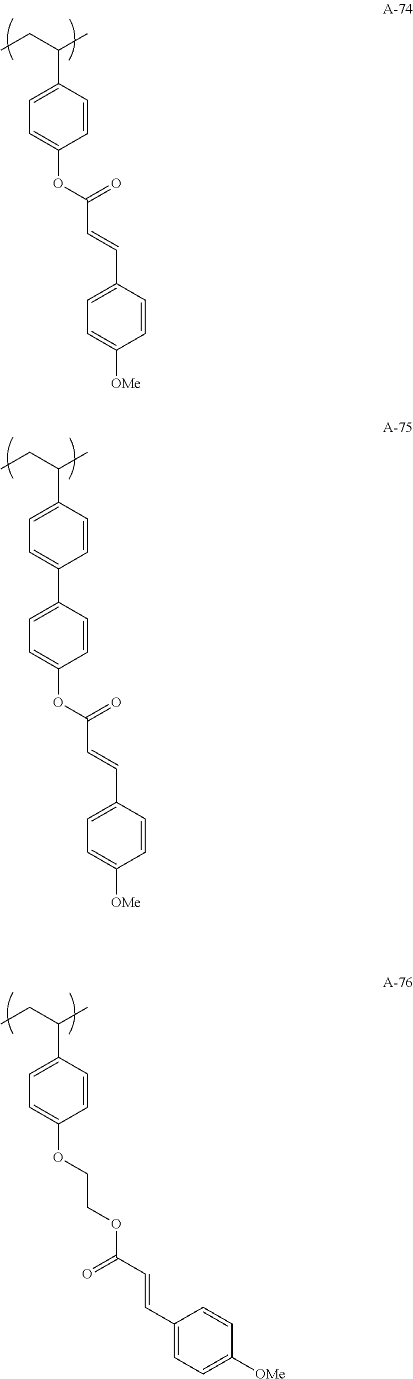

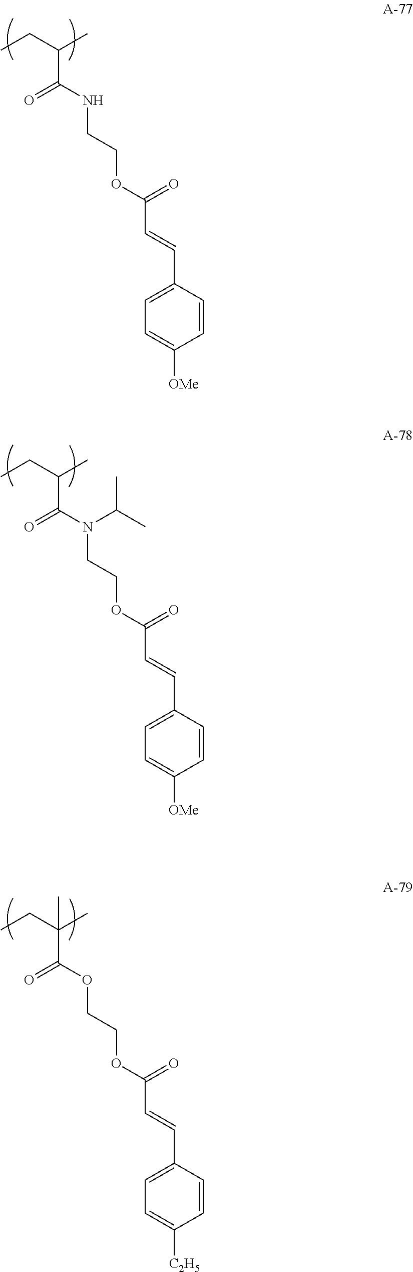

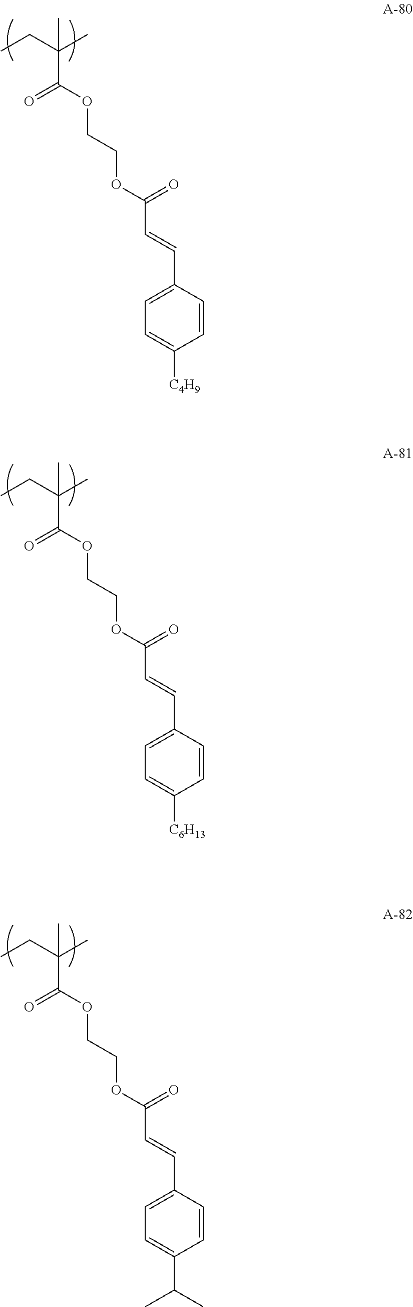

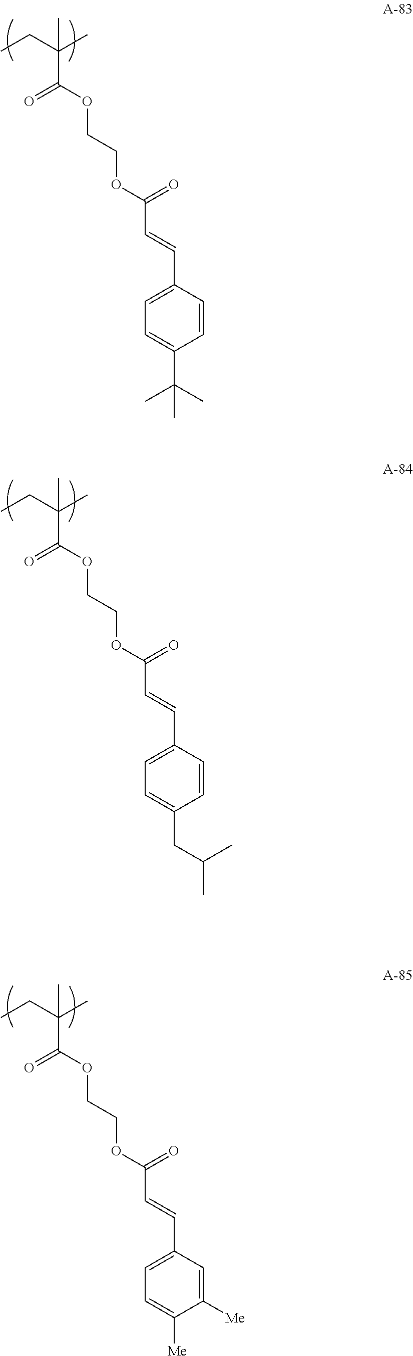

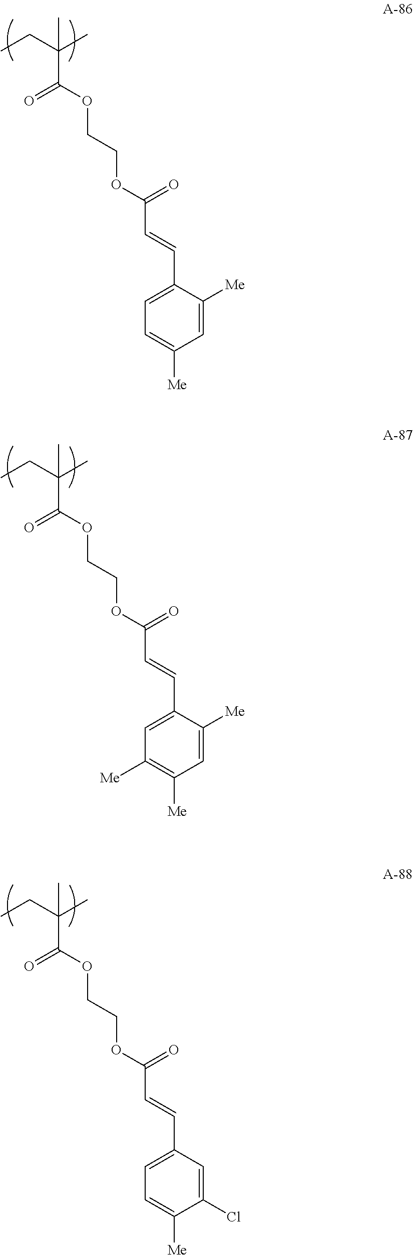

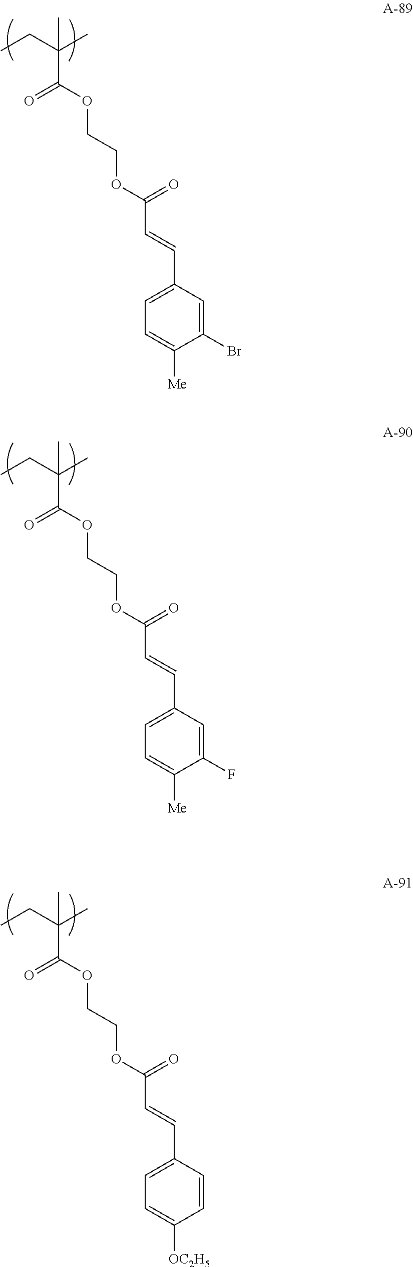

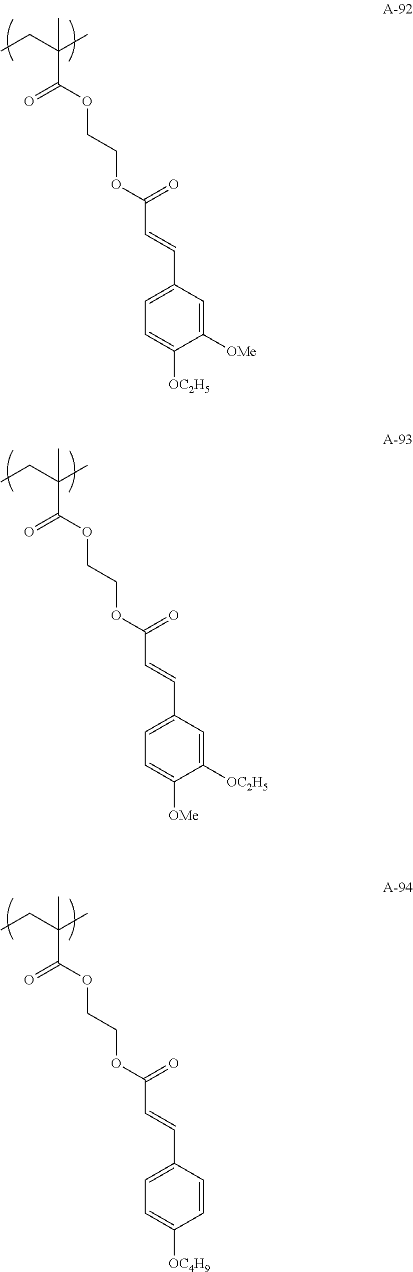

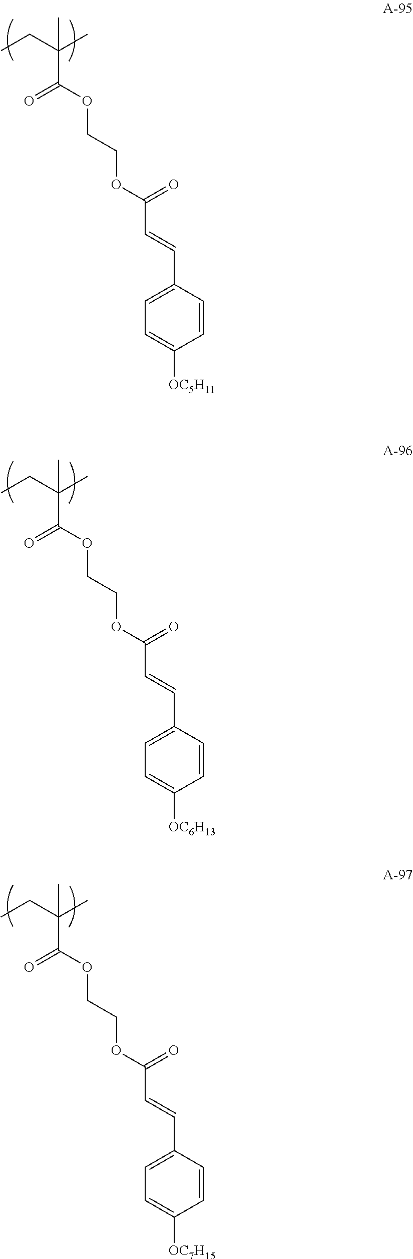

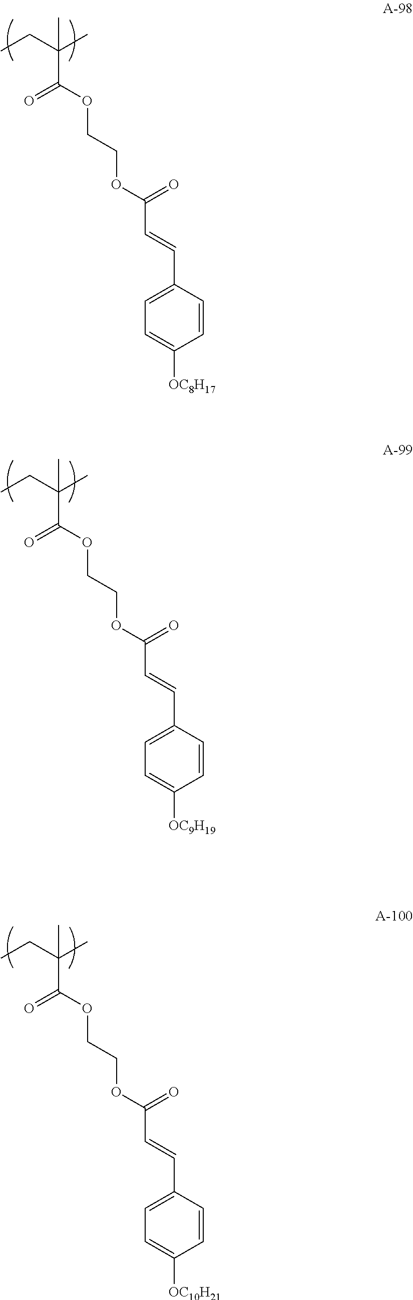

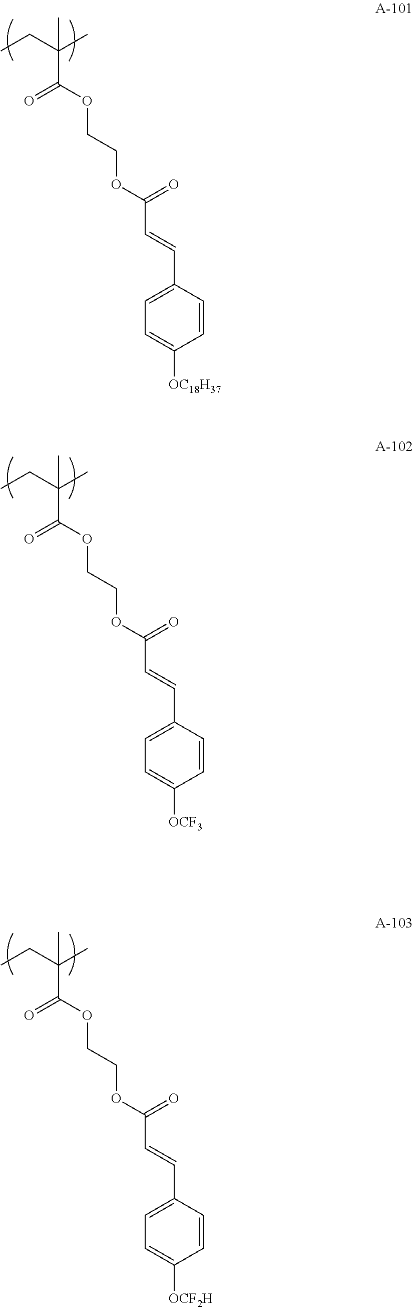

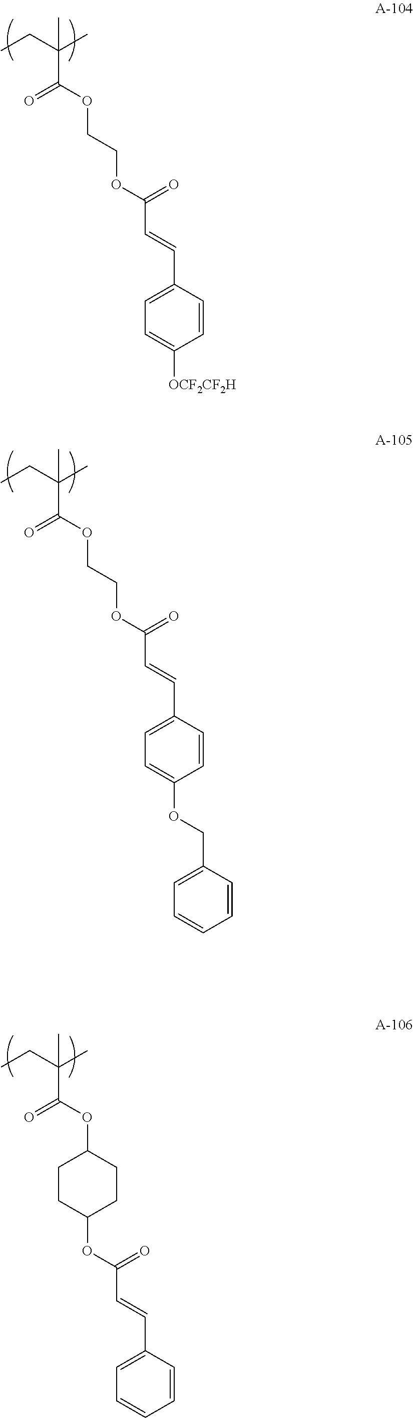

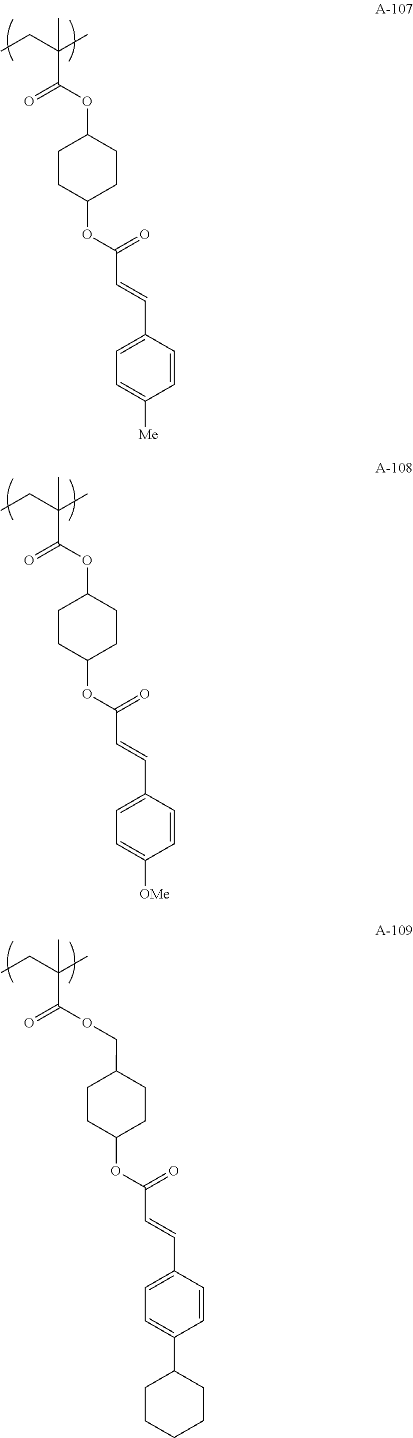

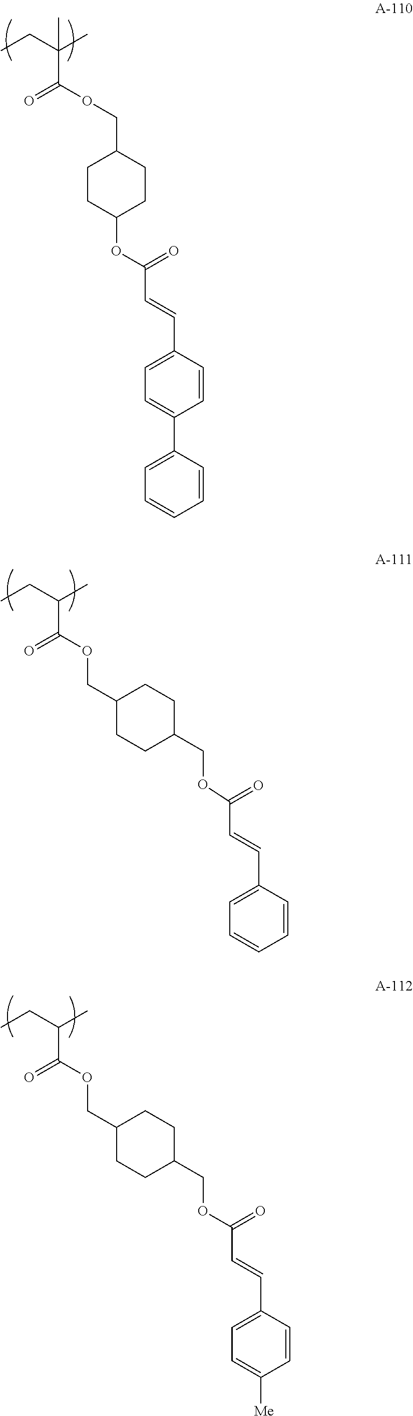

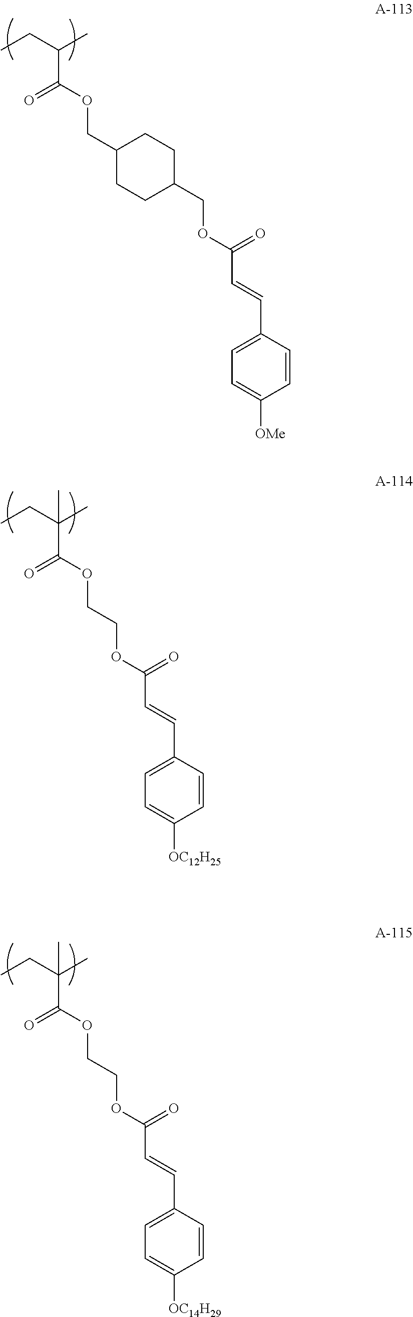

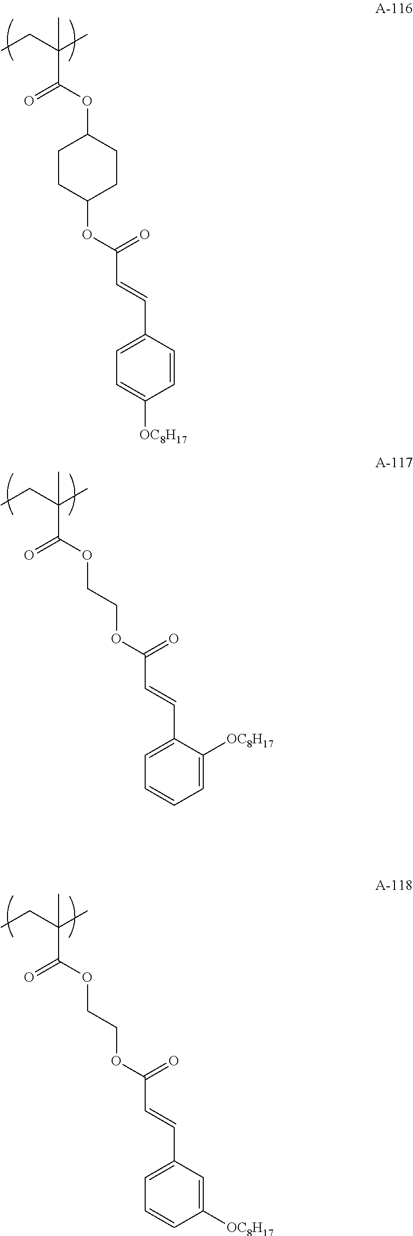

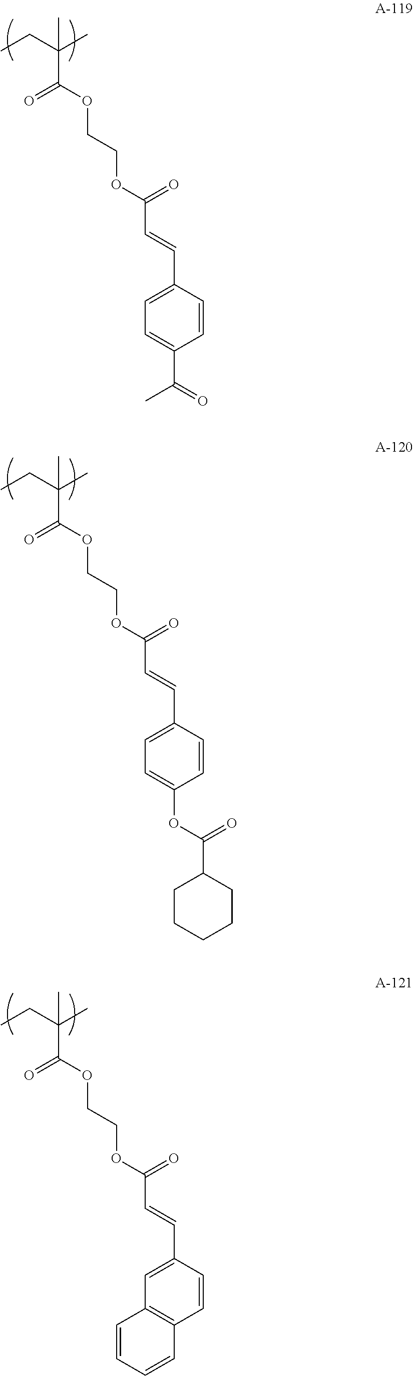

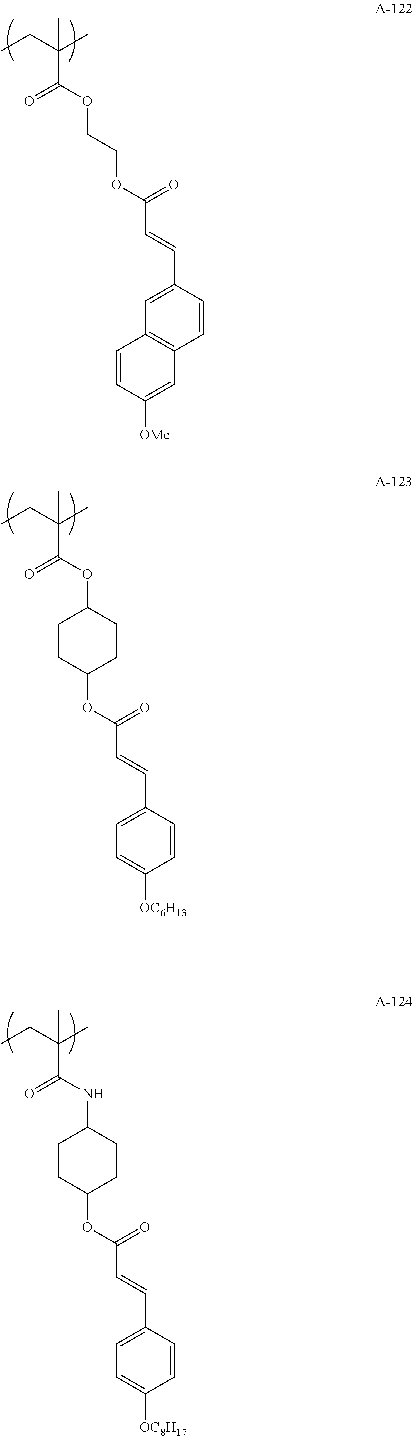

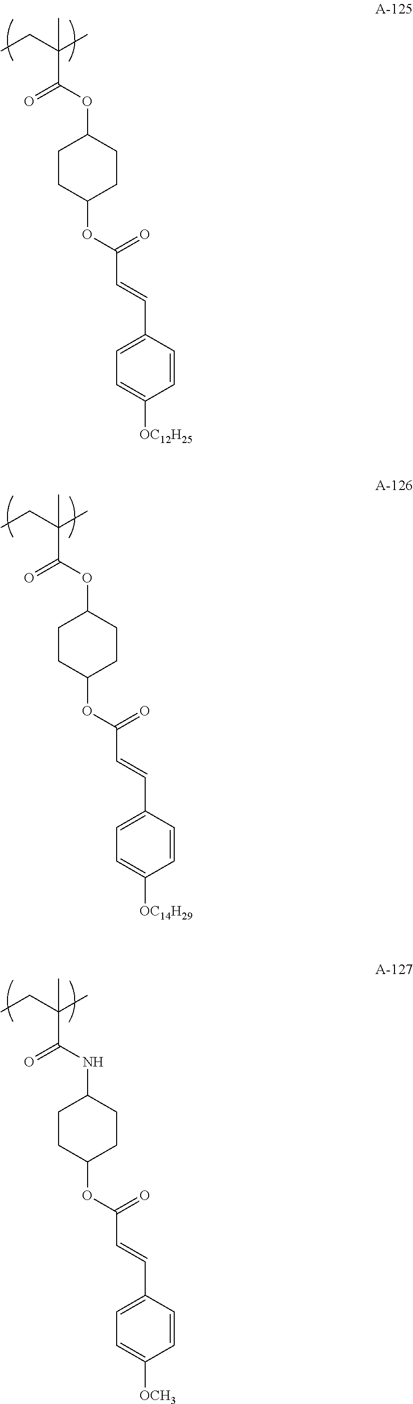

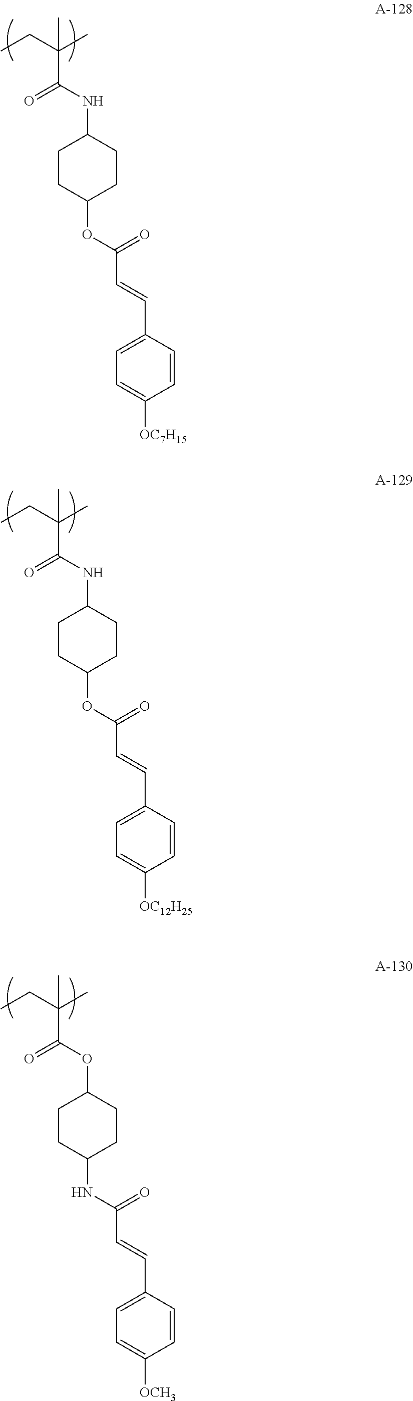

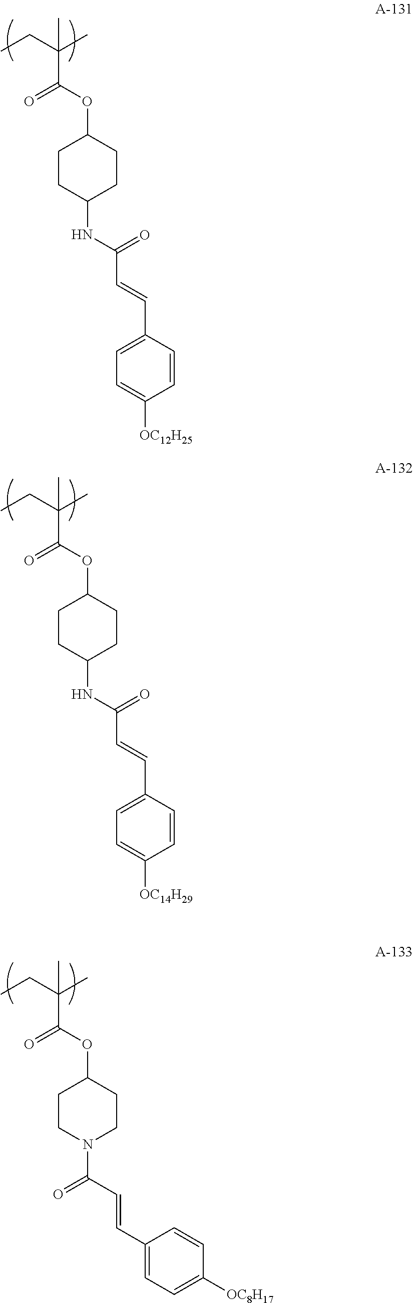

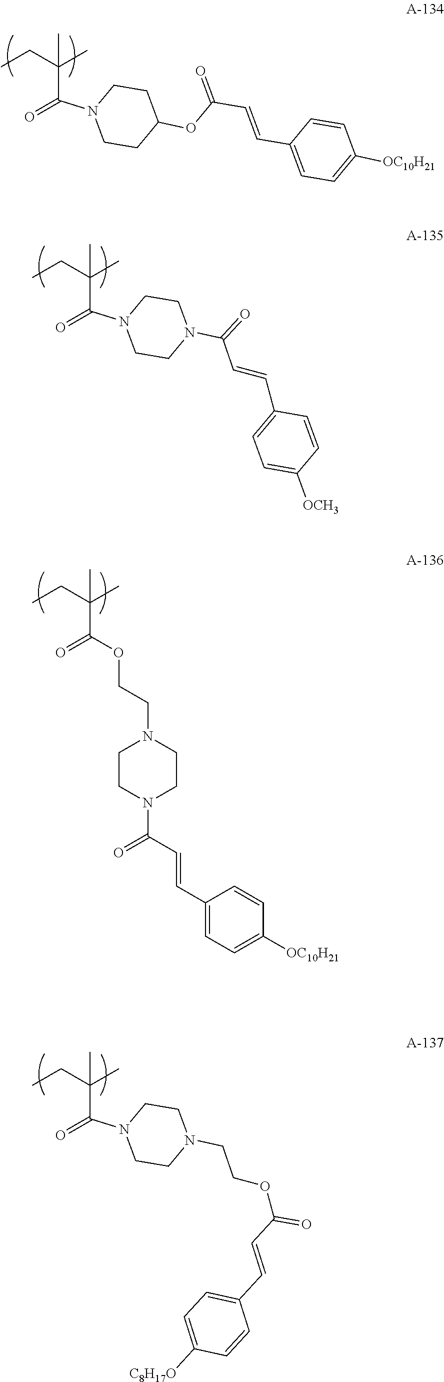

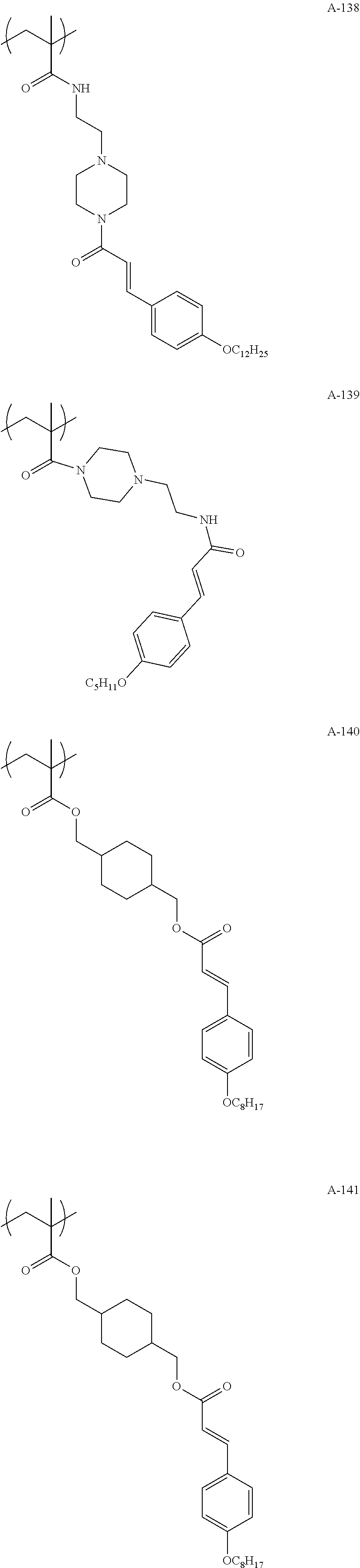

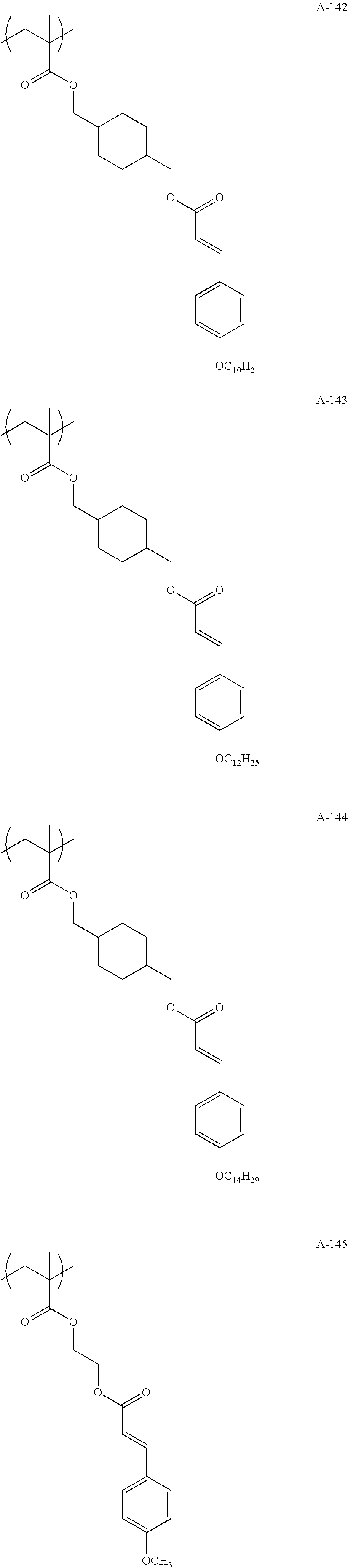

The content of the repeating unit having a photo-alignment group in the photo-alignment polymer is not particularly limited, and is preferably 5 to 60 mass %, more preferably 10 to 50 mass %, and even more preferably 15 to 40 mass % with respect to all the repeating units of the photo-alignment polymer from the viewpoint of more excellent effects of the present invention.

The photo-alignment polymer may have a repeating unit other than the above-described repeating unit.

(Repeating Unit Having Crosslinkable Group)

The photo-alignment polymer may further have a repeating unit having a crosslinkable group.

The type of the crosslinkable group is not particularly limited, and known crosslinkable groups are considered. Among these, a cationically polymerizable group or a radically polymerizable group is preferable from the viewpoint of excellent adhesiveness to an upper layer disposed on a binder layer.

Examples of the cationically polymerizable group include an epoxy group, an epoxycyclohexyl group, and an oxetanyl group, and a group represented by any one of Formula (C1), . . . , or Formula (C3) is preferable.

* in Formulae (C1) to (C3) represents a bonding position.

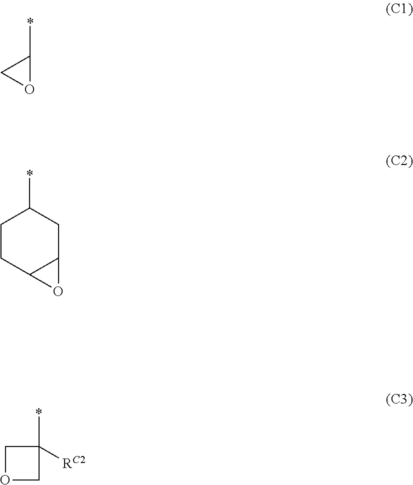

In Formula (C3), R^{C2} represents a hydrogen atom, a methyl group, or an ethyl group.

Examples of the radically polymerizable group include an acryloyl group, a methacryloyl group, a vinyl group, a styryl group, and an allyl group, and a group represented Formula (C4) is preferable.

* in Formula (C4) represents a bonding position.

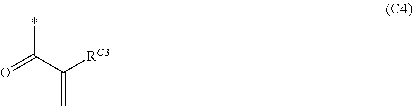

In Formula (C4), R^{C3} represents a hydrogen atom or a methyl group.

The structure of a main chain of the repeating unit having a crosslinkable group is not particularly limited, and known structures are considered. For example, a skeleton selected from the group consisting of a (meth)acrylic skeleton, a styrene-based skeleton, a siloxane-based skeleton, a cycloolefin-based skeleton, a methylpentene-based skeleton, an amide-based skeleton, and an aromatic ester-based skeleton is preferable.

Among these, a skeleton selected from the group consisting of a (meth)acrylic skeleton, a siloxane-based skeleton, and a cycloolefin-based skeleton is more preferable, and a (meth)acrylic skeleton is even more preferable.

The repeating unit having a crosslinkable group is preferably a repeating unit represented by Formula (C) from the viewpoint of more excellent effects of the present invention.

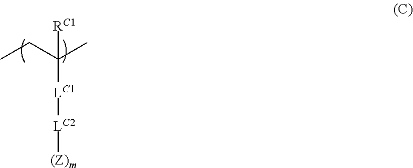

In Formula (C), R^{C1} represents a hydrogen atom or a substituent.

The type of the substituent represented by R^{C1} is not particularly limited, and known substituents are considered. Examples thereof include the examples of the substituent represented by R^{B2}.

The substituent represented by R^{C1} is preferably an alkyl group.

L^{C1} represents a single bond or a divalent linking group.

A definition of the divalent linking group represented by L^{C1} is the same as that of the divalent linking group represented by L^{B3} described above. Among these, from the viewpoint of more excellent effects of the present invention, a divalent linking group formed by combining at least two selected from the group consisting of a linear, branched, or cyclic alkylene group which may have a substituent and has 1 to 10 carbon atoms, an arylene group which may have a substituent and has 6 to 12 carbon atoms, —O—, —CO—, and —N(Q)- is preferable as the divalent linking group represented by L. Q represents a hydrogen atom or a substituent.

Definitions of the groups are the same as those of the groups described for the divalent linking group represented by L^{A1} described above.

L^{C2} represents an m+1-valent linking group.

From the viewpoint of more excellent effects of the present invention, the m+1-valent linking group is an m+1-valent hydrocarbon group which may have a substituent and has 1 to 24 carbon atoms, and is preferably a hydrocarbon group in which a part of carbon atoms constituting the hydrocarbon group may be substituted with a hetero atom, and more preferably an aliphatic hydrocarbon group which may contain an oxygen atom or a nitrogen atom and has 1 to 10 carbon atoms.

The number of carbon atoms contained in the m+1-valent linking group is not particularly limited, and is preferably 1 to 24, and more preferably 1 to 10 from the viewpoint of more excellent effects of the present invention.

The m+1-valent linking group is preferably a divalent linking group. A definition of the divalent linking group is the same as that of the divalent linking group represented by L^{B3} described above.

In a case where the m+1-valent linking group is a divalent linking group, examples of the divalent linking group include —CO—O— (a linear alkylene group which may have a substituent and has 1 to 10 (preferably 1 to 5) carbon atoms)-, —CO—O— (a linear alkylene group which may have a substituent and has 1 to 10 (preferably 1 to 5) carbon atoms) —O— (a linear alkylene group which may have a substituent and has 1 to 5 carbon atoms)-, and —CO—O— (a linear alkylene group which may have a substituent and has 1 to 5 carbon atoms) —O—CO—NH— (a linear alkylene group which may have a substituent and has 1 to 5 carbon atoms).

Z represents a crosslinkable group. A definition of the crosslinkable group is as described above.

m represents an integer of 1 or more. In the above range, the integer is preferably 1 to 5, more preferably 1 to 3, and even more preferably 1 from the viewpoint of more excellent effects of the present invention.

Specific examples of the repeating unit having a crosslinkable group are as follows.

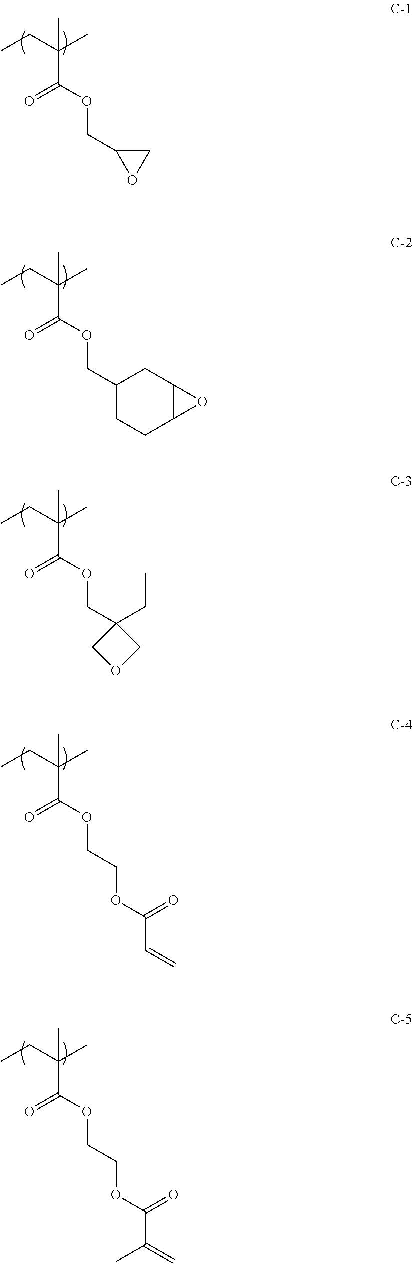

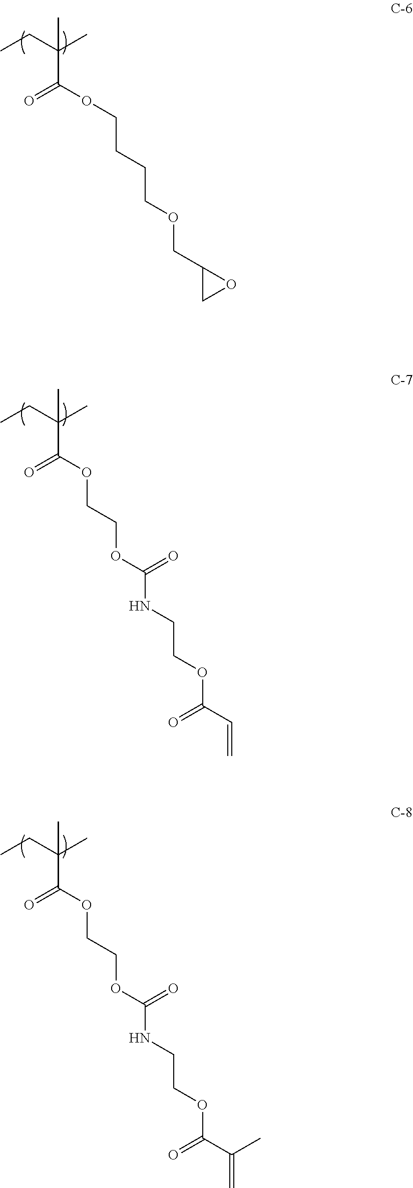

The content of the repeating unit having a crosslinkable group in the photo-alignment polymer is not particularly limited, and is preferably 10 to 60 mass %, and more preferably 20 to 50 mass % with respect to all the repeating units of the photo-alignment polymer from the viewpoint of more excellent effects of the present invention.

A content a of the above-described repeating unit having a group represented by Formula (1), a content b of the above-described repeating unit having a photo-alignment group, and a content c of the above-described repeating unit having a crosslinkable group preferably satisfy Expression (D1) in terms of mass ratio from the viewpoint of more excellent effects of the present invention.

0.03≤a/(a+b+c)≤0.5 (D1)

Examples of the monomer (radically polymerizable monomer) forming a repeating unit other than the above repeating units include an acrylic acid ester compound, a methacrylic acid ester compound, a maleimide compound, an acrylamide compound, acrylonitrile, maleic anhydride, a styrene compound, and a vinyl compound.

The method of synthesizing the photo-alignment polymer is not particularly limited. For example, the photo-alignment polymer can be synthesized by mixing a monomer forming the above-described repeating unit having a group represented by Formula (1), a monomer forming the above-described repeating unit having a photo-alignment group, and a monomer forming an optional repeating unit other than the above repeating units, and polymerizing the monomers using a radical polymerization initiator in an organic solvent.

The weight-average molecular weight (Mw) of the photo-alignment polymer according to the present invention is not particularly limited, and is preferably 10,000 to 500,000, more preferably 10,000 to 300,000, and even more preferably 30,000 to 150,000 from the viewpoint of more excellent effects of the present invention.

Here, in the present invention, the weight-average molecular weight and the number-average molecular weight are values measured by gel permeation chromatography (GPC) under the following conditions.
Solvent (eluent): Tetrahydrofuran (THF)
Device Name: TOSOH HLC-8320GPC
Column: Three items of TOSOH TSKgel Super HZM-H (4.6 mm×15 cm) are connected and used.
Column Temperature: 40° C.
Sample Concentration: 0.1 mass %
Flow Rate: 1.0 ml/min
Calibration Curve: A calibration curve made by 7 samples of TSK standard polystyrene manufactured by TOSOH Corporation, Mw of which is 2,800,000 to 1,050 (Mw/Mn=1.03 to 1.06), is used.

<Binder Composition>

A binder composition according to the embodiment of the present invention is a composition containing the photo-alignment polymer according to the embodiment of the present invention, a binder, and a photo-acid generator.

Here, the content of the photo-alignment polymer contained in the binder composition according to the embodiment of the present invention is preferably 0.1 to 10 parts by mass, and more preferably 0.5 to 5 parts by mass with respect to 100 parts by mass of the binder to be described later.

Here, the content of the photo-acid generator contained in the binder composition according to the embodiment of the present invention is preferably 0.5 to 50 parts by mass, and more preferably 2.5 to 25 parts by mass with respect to 100 parts by mass of the binder to be described later.

(Binder)

The type of the binder contained in the binder composition according to the embodiment of the present invention is not particularly limited. The binder itself may be a resin (hereinafter, also referred to as “resin binder”) which is formed only of a resin having no polymerization reactivity and simply dried and solidified, or a polymerizable compound.

[Resin Binder]

Examples of the resin binder include an epoxy resin, a diallyl phthalate resin, a silicone resin, a phenol resin, an unsaturated polyester resin, a polyimide resin, a polyurethane resin, a melamine resin, an urea resin, an ionomer resin, an ethylene ethyl acrylate resin, an acrylonitrile acrylate styrene copolymer resin, an acrylonitrile styrene resin, an acrylonitrile chloride polyethylene styrene copolymer resin, an ethylene-vinyl acetate resin, an ethylene vinyl alcohol copolymer resin, an acrylonitrile butadiene styrene copolymer resin, a vinyl chloride resin, a chlorinated polyethylene resin, a polyvinylidene chloride resin, a cellulose acetate resin, a fluorine resin, a polyoxymethylene resin, a polyamide resin, a polyarylate resin, a thermoplastic polyurethane elastomer, a polyether ether ketone resin, a polyether sulfone resin, polyethylene, polypropylene, a polycarbonate resin, polystyrene, a polystyrene maleic acid copolymer resin, a polystyrene acrylic acid copolymer resin, a polyphenylene ether resin, a polyphenylene sulfide resin, a polybutadiene resin, a polybutylene terephthalate resin, an acrylic resin, a methacrylic resin, a methylpentene resin, a polylactic acid, a polybutylene succinate resin, a butyral resin, a formal resin, polyvinyl alcohol, polyvinyl pyrrolidone, ethyl cellulose, carboxymethyl cellulose, gelatin, and copolymer resins thereof.

[Polymerizable Compound]

Examples of the polymerizable compound include an epoxy-based monomer, a (meth)acrylic monomer, and an oxetanyl-based monomer, and an epoxy-based monomer or a (meth)acrylic monomer is preferable.

In addition, a polymerizable liquid crystal compound may be used as the polymerizable compound.

Examples of the epoxy group-containing monomer which is an epoxy-based monomer include a bisphenol A epoxy resin, a bisphenol F epoxy resin, a brominated bisphenol A epoxy resin, a bisphenol S epoxy resin, a diphenyl ether epoxy resin, a hydroquinone epoxy resin, a naphthalene epoxy resin, a biphenyl epoxy resin, a fluorene epoxy resin, a phenol novolac epoxy resin, an orthocresol novolac epoxy resin, a trishydroxyphenylmethane epoxy resin, a trifunctional epoxy resin, a tetraphenylolethane epoxy resin, a dicyclopentadiene phenol epoxy resin, a hydrogenated bisphenol A epoxy resin, a bisphenol A nucleus-containing polyol epoxy resin, a polypropylene glycol epoxy resin, a glycidyl ester epoxy resin, a glycidylamine epoxy resin, a glyoxal epoxy resin, an alicyclic epoxy resin, and a heterocyclic epoxy resin.

Examples of the acrylic monomer and the methacrylic monomer, which are (meth)acrylic monomers, include trifunctional monomers such as trimethylolpropane triacrylate, trimethylolpropane propylene oxide (PO)-modified triacrylate, trimethylolpropane ethylene oxide (EO)-modified triacrylate, trimethylolpropane trimethacrylate, and pentaerythritol triacrylate. The examples further include tetrafunctional or higher-functional monomers such as pentaerythritol tetraacrylate, pentaerythritol tetramethacrylate, dipentaerythritol pentaacrylate, dipentaerythritol pentamethacrylate, dipentaerythritol hexaacrylate, and dipentaerythritol hexamethacrylate.

The polymerizable liquid crystal compound is not particularly limited, and examples thereof include a compound in which any one of homeotropic alignment, homogeneous alignment, hybrid alignment, or cholesteric alignment can be performed.

Here, in general, liquid crystal compounds can be classified into a rod-like type and a disk-like type according to the shape thereof. Furthermore, each type includes a low molecular type and a high molecular type. The term high molecular generally refers to a compound having a degree of polymerization of 100 or more (Polymer Physics-Phase Transition Dynamics, written by Masao Doi, p. 2, published by Iwanami Shoten, 1992). In the present invention, any liquid crystal compound can be used, and a rod-like liquid crystal compound or a discotic liquid crystal compound (disk-like liquid crystal compound) is preferable. In addition, a liquid crystal compound which is a monomer or has a relatively low molecular weight with a degree of polymerization of less than 100 is preferable.

In addition, examples of the polymerizable group of the polymerizable liquid crystal compound include an acryloyl group, a methacryloyl group, an epoxy group, and a vinyl group.

By polymerizing such a polymerizable liquid crystal compound, the alignment of the liquid crystal compound can be fixed. After fixing of the liquid crystal compound by polymerization, it is no longer necessary to exhibit liquid crystallinity.

As the rod-like liquid crystal compound, for example, those described in claim 1 of JP1999-513019A (JP-H11-513019A) or paragraphs [0026] to [0098] of JP2005-289980A are preferable, and as the discotic liquid crystal compound, for example, those described in paragraphs [0020] to [0067] of JP2007-108732A or paragraphs [0013] to [0108] of JP2010-244038A are preferable.

A liquid crystal compound having reverse wavelength dispersibility can be used as the polymerizable liquid crystal compound.

Here, in this specification, the liquid crystal compound having “reverse wavelength dispersibility” refers to the fact that in the measurement of an in-plane retardation (Re) value at a specific wavelength (visible light range) of a retardation film produced using the liquid crystal compound, as the measurement wavelength increases, the Re value is the same or increased.

The liquid crystal compound having reverse wavelength dispersibility is not particularly limited as long as a film having reverse wavelength dispersibility can be formed as described above, and for example, compounds represented by Formula (I) described in JP2008-297210A (particularly, compounds described in paragraphs [0034] to [0039]), compounds represented by Formula (1) described in JP2010-084032A (particularly, compounds described in paragraphs [0067] to [0073]), and compounds represented by Formula (1) described in JP2016-081035A (particularly, compounds described in paragraphs [0043] to [0055]) are considered.

Compounds described in paragraphs [0027] to [0100] of JP2011-006360A, paragraphs [0028] to [0125] of JP2011-006361A, paragraphs [0034] to [0298] of JP2012-207765A, paragraphs [0016] to [0345] of JP2012-077055A, paragraphs [0017] to [0072] of WO12/141245A, paragraphs [0021] to [0088] of WO12/147904A, and paragraphs [0028] to [0115] of WO14/147904A are also considered.

(Photo-Acid Generator)

The binder composition according to the embodiment of the present invention contains a photo-acid generator.

The photo-acid generator is not particularly limited, and is preferably a compound which is sensitive to actinic rays having a wavelength of 300 nm or more, preferably 300 to 450 nm, and generates an acid. A photo-acid generator which is not directly sensitive to actinic rays having a wavelength of 300 nm or more can also be preferably used in combination with a sensitizer as long as it is a compound which is sensitive to actinic rays having a wavelength of 300 nm or more and generates an acid by being used in combination with the sensitizer.

The photo-acid generator is preferably a photo-acid generator which generates an acid with a pKa of 4 or less, more preferably a photo-acid generator which generates an acid with a pKa of 3 or less, and even more preferably a photo-acid generator which generates an acid with a pKa of 2 or less. In the present invention, the pKa basically refers to a pKa in water at 25° C. Those which cannot be measured in water refer to those measured after changing to a solvent suitable for the measurement. Specifically, the pKa described in a chemical handbook or the like can be referred to. The acid with a pKa of 3 or less is preferably a sulfonic acid or a phosphonic acid, and more preferably a sulfonic acid.

Examples of the photo-acid generator include an onium salt compound, trichloromethyl-s-triazines, a sulfonium salt, an iodonium salt, quaternary ammonium salts, a diazomethane compound, an imidosulfonate compound, and an oxime sulfonate compound. Among these, an onium salt compound, an imidosulfonate compound, or an oxime sulfonate compound is preferable, and an onium salt compound or an oxime sulfonate compound is particularly preferable. The photo-acid generators can be used alone or in combination of two or more types thereof.

The binder composition according to the embodiment of the present invention may contain a component other than the photo-alignment polymer, the binder, and the photo-acid generator described above.

(Polymerization Initiator)

In a case where a polymerizable compound is used as the binder, the binder composition according to the embodiment of the present invention preferably contains a polymerization initiator.

The polymerization initiator is not particularly limited, and examples thereof include a thermal polymerization initiator and a photopolymerization initiator depending on the method of a polymerization reaction.

The polymerization initiator is preferably a photopolymerization initiator capable of initiating a polymerization reaction by ultraviolet irradiation.

Examples of the photopolymerization initiator include a-carbonyl compounds (described in U.S. Pat. Nos. 2,367,661A and 2,367,670A), acyloin ethers (described in U.S. Pat. No. 2,448,828A), a-hydrocarbon-substituted aromatic acyloin compounds (described in U.S. Pat. No. 2,722,512A), polynuclear quinone compounds (described in U.S. Pat. Nos. 3,046,127A and 2,951,758A), combinations of triarylimidazole dimer and p-aminophenyl ketone (described in U.S. Pat. No. 3,549,367A), acridine and phenazine compounds (described in JP1985-105667A (JP-S60-105667A) and US4239850A), oxadiazole compounds (described in U.S. Pat. No. 4,212,970A), and acylphosphine oxide compounds (described in JP1988-040799B (JP-S63-040799B), JP1993-029234B (JP-H05-029234B), JP1998-095788A (JP-H10-095788A), and JP1998-029997A (JP-H10-029997A)).

(Solvent)

The binder composition according to the embodiment of the present invention preferably contains a solvent from the viewpoint of workability for forming a binder layer.

Examples of the solvent include ketones (for example, acetone, 2-butanone, methyl isobutyl ketone, and cyclohexanone), ethers (for example, dioxane and tetrahydrofuran), aliphatic hydrocarbons (for example, hexane), alicyclic hydrocarbons (for example, cyclohexane), aromatic hydrocarbons (for example, toluene, xylene, and trimethylbenzene), halogenated carbons (for example, dichloromethane, dichloroethane, dichlorobenzene, and chlorotoluene), esters (for example, methyl acetate, ethyl acetate, and butyl acetate), water, alcohols (for example, ethanol, isopropanol, butanol, and cyclohexanol), cellosolves (for example, methyl cellosolve and ethyl cellosolve), cellosolve acetates, sulfoxides (for example, dimethyl sulfoxide), and amides (for example, dimethylformamide and dimethylacetamide).

The solvents may be used alone or in combination of two or more kinds thereof.

<Binder Layer>

A binder layer according to the embodiment of the present invention is formed of the above-described binder composition according to the embodiment of the present invention, and its surface has alignment controllability. More specifically, the binder layer is a layer formed by generating an acid from the photo-acid generator in a coating film of the binder composition and then performing a photo-alignment treatment.

That is, the method of forming a binder layer preferably has a step of generating an acid from the photo-acid generator in a coating film formed of the binder composition, and then performing a photo-alignment treatment on the coating film to form a binder layer (Step 1).

The expression “has alignment controllability” means having a function of aligning the liquid crystal compound disposed on the binder layer in a predetermined direction.

In a case where the binder composition contains a polymerizable compound, it is preferable that in Step 1, a curing treatment is performed on a coating film formed of the binder composition, a treatment for generating an acid from the photo-acid generator in the coating film (hereinafter, also simply referred to as “acid generation treatment”) is performed, and then a photo-alignment treatment is performed to form a binder layer.

As will be described later, the curing treatment and the acid generation treatment may be performed at the same time.

Hereinafter, the method of performing the curing treatment will be described in detail.

The method of forming a coating film of the binder composition is not particularly limited, and examples thereof include a method including performing coating with the binder composition on a support and optionally performing a drying treatment.

The support will be described in detail later.

In addition, an alignment layer may be disposed on the support.

The method of performing coating with the binder composition is not particularly limited, and examples of the coating method include a spin coating method, an air knife coating method, a curtain coating method, a roller coating method, a wire bar coating method, a gravure coating method, and a die coating method.

Next, a curing treatment and a treatment for generating an acid from the photo-acid generator in the coating film (hereinafter, also referred to as “acid generation treatment”) are performed on the coating film of the binder composition.

Examples of the curing treatment include a light irradiation treatment and a heating treatment.

The conditions of the curing treatment are not particularly limited, and ultraviolet rays are preferably used in polymerization by light irradiation. The irradiation dose is preferably 10 mJ/cm² to 50 J/cm², more preferably 20 mJ/cm² to 5 J/cm², even more preferably 30 mJ/cm² to 3 J/cm², and particularly preferably 50 to 1,000 mJ/cm². In order to promote the polymerization reaction, the treatment may be performed under heating conditions.

The treatment for generating an acid from the photo-acid generator in the coating film is a treatment for generating an acid by irradiation with light to which the photo-acid generator contained in the binder composition is exposed. By performing the treatment, cleavage at the cleavage group proceeds, and the group containing a fluorine atom or a silicon atom is eliminated.

The light irradiation treatment performed in the above treatment may be a treatment in which the photo-acid generator is exposed to light, and examples thereof include an ultraviolet irradiation method. As a light source, a lamp emitting ultraviolet rays, such as a high-pressure mercury lamp and a metal halide lamp, can be used. In addition, the irradiation dose is preferably 10 mJ/cm² to 50 J/cm², more preferably 20 mJ/cm² to 5 J/cm², even more preferably 30 mJ/cm² to 3 J/cm², and particularly preferably 50 to 1,000 mJ/cm².

Regarding the curing treatment and the acid generation treatment, the acid generation treatment may be performed after the curing treatment, or the curing treatment and the acid generation treatment may be performed at the same time. In particular, in a case where the photo-acid generator and the polymerization initiator in the binder composition are exposed to light of the same wavelength, it is preferable that the curing treatment and the acid generation treatment are performed at the same time from the viewpoint of productivity.

The method for the photo-alignment treatment to be performed on the coating film of the binder composition formed as described above (including the cured film of the binder composition subjected to the curing treatment) is not particularly limited, and known methods are considered.

Examples of the photo-alignment treatment include a method of irradiating the coating film of the binder composition (including the cured film of the binder composition subjected to the curing treatment) with polarized light or irradiating the surface of the coating film with unpolarized light from an oblique direction.

In the photo-alignment treatment, the polarized light to be applied is not particularly limited. Examples thereof include linearly polarized light, circularly polarized light, and elliptically polarized light, and linearly polarized light is preferable.

In addition, the “oblique direction” in which irradiation with unpolarized light is performed is not particularly limited as long as it is a direction inclined at a polar angle θ) (0°<θ<90° with respect to a normal direction of the surface of the coating film. θ can be appropriately selected according to the purpose, and is preferably 20° to 80°.

The wavelength of the polarized light or the unpolarized light is not particularly limited as long as the light is light to which the photo-alignment group is exposed. Examples thereof include ultraviolet rays, near-ultraviolet rays, and visible rays, and near-ultraviolet rays of 250 to 450 nm are preferable.

In addition, examples of the light source for the irradiation with polarized light or unpolarized light include a xenon lamp, a high-pressure mercury lamp, an extra-high-pressure mercury lamp, and a metal halide lamp. By using an interference filter, a color filter, or the like with respect to ultraviolet rays or visible rays obtained from the light source, the wavelength range of the irradiation can be restricted. In addition, linearly polarized light can be obtained by using a polarization filter or a polarization prism with respect to the light from the light source.

The integrated quantity of the polarized light or the unpolarized light is not particularly limited, and is preferably 1 to 300 mJ/cm², and more preferably 5 to 100 mJ/cm².

The illuminance of the polarized light or the unpolarized light is not particularly limited, and is preferably 0.1 to 300 mW/cm², and more preferably 1 to 100 mW/cm².

An aspect has been described in which the curing treatment and the acid generation treatment are performed before the photo-alignment treatment, but the present invention is not limited to this aspect. The curing treatment and the acid generation treatment may be performed at the same time in the photo-alignment treatment.

The thickness of the binder layer is not particularly limited, and is preferably 0.1 to 10 μm, and more preferably 0.5 to 5 μm from the viewpoint of more excellent effects of the present invention.

<Optical Laminate>

An optical laminate according to the embodiment of the present invention has the binder layer according to the embodiment of the present invention and an optically anisotropic layer provided on the binder layer.

A suitable aspect of the optical laminate according to the embodiment of the present invention is that the optically anisotropic layer provided on the binder layer is formed of a polymerizable liquid crystal composition containing a polymerizable liquid crystal compound, and the binder layer and the optically anisotropic layer are laminated adjacent to each other.

The optical laminate according to the embodiment of the present invention preferably has a support which supports the binder layer.

Hereinafter, preferable aspects of the optical laminate according to the embodiment of the present invention will be described in detail.

(Support)

Examples of the support include a glass substrate and a polymer film.

Examples of the material of the polymer film include cellulose-based polymers; acrylic polymers having an acrylic acid ester polymer such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer (AS resin); polyolefin-based polymers such as polyethylene, polypropylene, and an ethylene-propylene copolymer; vinyl chloride-based polymers; amide-based polymers such as nylon and aromatic polyimide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers obtained by mixing these polymers.

The thickness of the support is not particularly limited, and is preferably 5 to 200 μm, more preferably 10 to 100 μm, and even more preferably 20 to 90 μm.

(Binder Layer)

The binder layer is the above-described binder layer according to the embodiment of the present invention.

(Optically Anisotropic Layer)

The optically anisotropic layer is preferably formed of a polymerizable liquid crystal composition containing a polymerizable liquid crystal compound.

Here, examples of the polymerizable liquid crystal composition for forming the optically anisotropic layer include a composition obtained by blending the polymerizable liquid crystal compound, the polymerization initiator, the solvent, and the like described as optional components in the binder composition according to the embodiment of the present invention.

The thickness of the optically anisotropic layer is not particularly limited, and is preferably 0.1 to 10 μm, and more preferably 0.5 to 5 μm.

<Optical Laminate Manufacturing Method>

An optical laminate manufacturing method according to the embodiment of the present invention is a method of producing a suitable aspect of the above-described optical laminate according to the embodiment of the present invention, and has a step of generating an acid from the photo-acid generator in a coating film formed of the binder composition, and then performing a photo-alignment treatment on the coating film to form a binder layer (Step 1), and a step of performing coating on the binder layer with a polymerizable liquid crystal composition containing a polymerizable liquid crystal compound to form an optically anisotropic layer (Step 2).

(Step 1)

Step 1 is a step of generating an acid from the photo-acid generator in a coating film formed of the binder composition, and then performing a photo-alignment treatment on the coating film to form a binder layer.

The procedure of Step 1 is as described above.

(Step 2)

Step 2 is a step of performing coating on the binder layer with a polymerizable liquid crystal composition containing a polymerizable liquid crystal compound to form an optically anisotropic layer.

The method of performing coating with the polymerizable liquid crystal composition is not particularly limited, and examples thereof include the examples of the coating method in Step 1.

Examples of the method of forming the optically anisotropic layer include a method in which a coating film of the polymerizable liquid crystal composition is subjected to a heating treatment and then subjected to a curing treatment. The polymerizable liquid crystal compound can be aligned by the above heating treatment.

In the above description, the heating treatment and the curing treatment are separately performed. However, a method in which the curing treatment is performed under heating conditions may also be carried out.

In a case where the polymerizable liquid crystal compound is aligned without the heating treatment depending on the type thereof, the heating treatment may not be performed.

After being heated, the coating film may be optionally cooled before the curing treatment to be described later.

The conditions of the heating treatment are not particularly limited, and the temperature may be adjusted so that the polymerizable liquid crystal compound is aligned. Usually, the heating temperature is preferably 30° C. to 100° C., and more preferably 50° C. to 80° C. The heating time is preferably 0.5 to 20 minutes, and more preferably 1 to 5 minutes.

The method for the curing treatment is not particularly limited. Examples thereof include a light irradiation treatment and a heating treatment, and a light irradiation treatment is preferable. Ultraviolet rays are preferable as light in the light irradiation treatment.

The conditions for a case where the light irradiation is performed are not particularly limited, and the irradiation dose is preferably 10 mJ/cm² to 50 J/cm², more preferably 20 mJ/cm² to 5 J/cm², and even more preferably 30 mJ/cm² to 3 J/cm².

In order to promote the polymerization reaction, the treatment may be performed under heating conditions.

<Image Display Device>

An image display device according to the embodiment of the present invention is an image display device having the optically anisotropic layer according to the present invention or the optical laminate according to the embodiment of the present invention.

The display element which is used in the image display device according to the embodiment of the present invention is not particularly limited, and examples thereof include a liquid crystal cell, an organic electroluminescence (hereinafter, abbreviated as “EL”) display panel, and a plasma display panel.

Among these, a liquid crystal cell or an organic EL display panel is preferable, and a liquid crystal cell is more preferable. That is, the image display device according to the embodiment of the present invention is preferably a liquid crystal display device using a liquid crystal cell as a display element or an organic EL display device using an organic EL display panel as a display element.

(Liquid Crystal Display Device)

A liquid crystal display device as an example of the image display device according to the embodiment of the present invention has the optically anisotropic layer according to the present invention or the optical laminate according to the embodiment of the present invention described above, and a liquid crystal cell.

Hereinafter, the liquid crystal cell constituting the liquid crystal display device will be described in detail.

The liquid crystal cell which is used in the liquid crystal display device is preferably a vertical alignment (VA) mode, an optically compensated bend (OCB) mode, an in-plane-switching (IPS) mode, or a twisted nematic (TN) mode, but is not limited thereto.

In a TN mode liquid crystal cell, rod-like liquid crystalline molecules (rod-like liquid crystal compound) are substantially horizontally aligned with no voltage application thereto, and subjected to twist alignment of 60° to 120°. The TN mode liquid crystal cell is the most frequently used as a color TFT liquid crystal display device, and there are descriptions in many literatures.

In a VA mode liquid crystal cell, rod-like liquid crystalline molecules are substantially vertically aligned with no voltage application thereto. The VA mode liquid crystal cell includes (1) a VA mode liquid crystal cell in the narrow sense in which rod-like liquid crystalline molecules are substantially vertically aligned with no voltage application thereto, but are substantially horizontally aligned in the presence of voltage application thereto (described in JP1990-176625A (JP-H2-176625A)); (2) a (multi-domain vertical alignment (MVA) mode) liquid crystal cell attaining multi-domain of the VA mode for view angle enlargement (described in SID97, Digest of tech. Papers (proceedings) 28 (1997), 845), (3) an (n-axially symmetric aligned microcell (ASM) mode) liquid crystal cell in which rod-like liquid crystalline molecules are substantially vertically aligned with no voltage application thereto, but are subjected to twist multi-domain alignment in the presence of voltage application thereto (described in proceedings of Japan Liquid Crystal Debating Society, 58 to 59 (1998)), and (4) a super ranged viewing by vertical alignment (SURVIVAL) mode liquid crystal cell (published in liquid crystal display (LCD) International 98). In addition, the VA mode liquid crystal cell may be any one of a patterned vertical alignment (PVA) type, an optical alignment type, or a polymer-sustained alignment (PSA) type. Details of the modes are described in JP2006-215326A and JP2008-538819A.

In an IPS mode liquid crystal cell, rod-like liquid crystalline molecules are aligned to be substantially parallel to the substrate. The liquid crystalline molecules planarly respond by the application of an electric field parallel to a substrate surface. In the IPS mode, black display is performed during application of no electric field, and the absorption axes of a pair of upper and lower polarizing plates are perpendicular to each other. A method of improving a view angle by reducing light leakage at the time of black display in an oblique direction by using an optical compensation sheet is disclosed in JP1998-054982A (JP-H10-054982A), JP1999-202323A (JP-H11-202323A), JP1997-292522A (JP-H09-292522A), JP1999-133408A (JP-H11-133408A), JP1999-305217A (JP-H11-305217A), JP1998-307291A (JP-H10-307291A), and the like.

(Organic EL Display Device)

Suitable examples of the organic EL display device as an example of the image display device according to the embodiment of the present invention include a device having an aspect in which it has a polarizer, the optically anisotropic layer according to the present invention or the optical laminate according to the embodiment of the present invention, and an organic EL display panel in this order from the viewing side.

(Polarizer)

The polarizer is not particularly limited as long as it is a member having a function of converting light into specific linearly polarized light. An absorption-type polarizer or a reflective-type polarizer which has been known can be used.

Examples of the absorption-type polarizer include an iodine-based polarizer, a dye-based polarizer using a dichroic dye, and a polyene-based polarizer. The iodine-based polarizer and the dye-based polarizer include a coating-type polarizer and a stretching-type polarizer, and any of these is applicable.

Examples of the method of obtaining a polarizer by performing stretching and dyeing in a state in which a laminate film is obtained by forming a polyvinyl alcohol layer on a base include JP5048120B, JP5143918B, JP4691205B, JP4751481B, and JP4751486B.

Examples of the reflective-type polarizer include a polarizer obtained by laminating thin films having different birefringences, a wire grid-type polarizer, and a polarizer obtained by combining a cholesteric liquid crystal having a selective reflection area and a ¼ wavelength plate.

Among these, from the viewpoint of more excellent adhesiveness, a polarizer including a polyvinyl alcohol-based resin (a polymer containing —CH₂—CHOH— as a repeating unit, particularly, at least one selected from the group consisting of a polyvinyl alcohol and an ethylene-vinyl alcohol copolymer) is preferable.

The thickness of the polarizer is not particularly limited, and is preferably 3 to 60 μm, more preferably 5 to 30 μm, and even more preferably 5 to 15 μm.

(Organic EL Display Panel)

The organic EL display panel is a member in which a light emitting layer or a plurality of organic compound thin films including a light emitting layer is formed between a pair of electrodes of an anode and a cathode. In addition to the light emitting layer, a hole injection layer, a hole transport layer, an electron injection layer, an electron transport layer, a protective layer, and the like may be provided, and each of these layers may have a different function. Various materials can be used to form the respective layers.

### EXAMPLES

Hereinafter, the present invention will be more specifically described with examples. Materials, used amounts, ratios, treatment contents, and treatment procedures shown in the following examples are able to be suitably changed unless the changes cause deviance from the gist of the invention. Therefore, the range of the present invention will not be restrictively interpreted by the following examples.

### Synthesis Example

As shown in the following scheme, 2-hydroxyethyl methacrylate (13.014 g, 100 mmol), toluene (100 g), and dibutylhydroxytoluene (BHT) (10.0 mg) were put into a 200 ml three-neck flask comprising a stirrer, a thermometer, and a reflux condenser, and stirred at room temperature (23° C.). Next, to the obtained solution, 10-camphorsulfonic acid (230.3 mg, 0.1 mmol) was added, and the mixture was stirred at room temperature. Next, to the obtained solution, 2-(perfluorohexyl)ethyl vinyl ether (39.014 g, 100 mmol) was added dropwise for 1.5 hours, and the mixture was further stirred at room temperature for 3 hours. To the obtained solution, ethyl acetate (200 mL) and sodium bicarbonate water (200 mL) were added to perform separation and purification, and an organic phase was extracted. Magnesium sulfate was added to the obtained organic phase. The resulting organic phase was dried and filtered, and then from the obtained filtrate, the solvent was distilled off to obtain 46.8 g of a monomer mB-1.

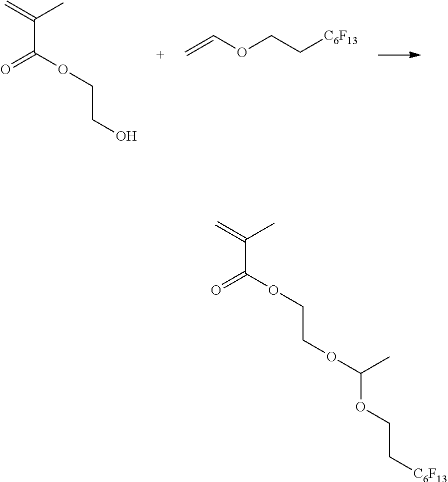

Monomers other than the above monomer were synthesized with reference to the above-described synthesis method and known methods (for example, the method described in WO2018/216812A).

### Example 1

5.5 parts by mass of a monomer mA-2 forming a repeating unit represented by Formula (A-2) to be described later and 10 parts by mass of 2-butanone as a solvent were put into a flask comprising a cooling pipe, a thermometer, and a stirrer, and refluxing was performed by heating in a water bath with nitrogen flowing into the flask at 5 mL/min. To the resulting material, a solution obtained by mixing 3.0 parts by mass of the monomer mB-1, 1.5 parts by mass of a monomer mC-1 forming a repeating unit represented by Formula (C-1) to be described later, 0.062 parts by mass of 2,2′-azobis(isobutyronitrile) as a polymerization initiator, and 13 parts by mass of 2-butanone as a solvent was added dropwise for 3 hours, and stirred while maintaining the refluxing state for 3 hours. After completion of the reaction, the reaction mixture was allowed to cool to room temperature, and 10 parts by mass of 2-butanone was added and diluted to obtain about 20 mass % of a polymer solution. The obtained polymer solution was poured into a large excess of methanol to precipitate the polymer, and the collected precipitate was separated by filtering and washed with a large amount of methanol. Then, the resulting material was subjected to blast drying at 50° C. for 12 hours, and thus a photo-alignment polymer P-1 was obtained.

### Examples 2 to 48 and Comparative Examples 1 and 2

Photo-alignment polymers P-2 to P-46, H-1, and H-2 were synthesized in the same manner as in the case of the photo-alignment polymer P-1 synthesized in Example 1, except that monomers capable of forming the following repeating units, respectively, were used as monomers forming the repeating units shown in the following Tables 1 and 2.

The symbols in Tables 1 and 2 have the following meanings, respectively.

In addition, n in B-14 represents 2.

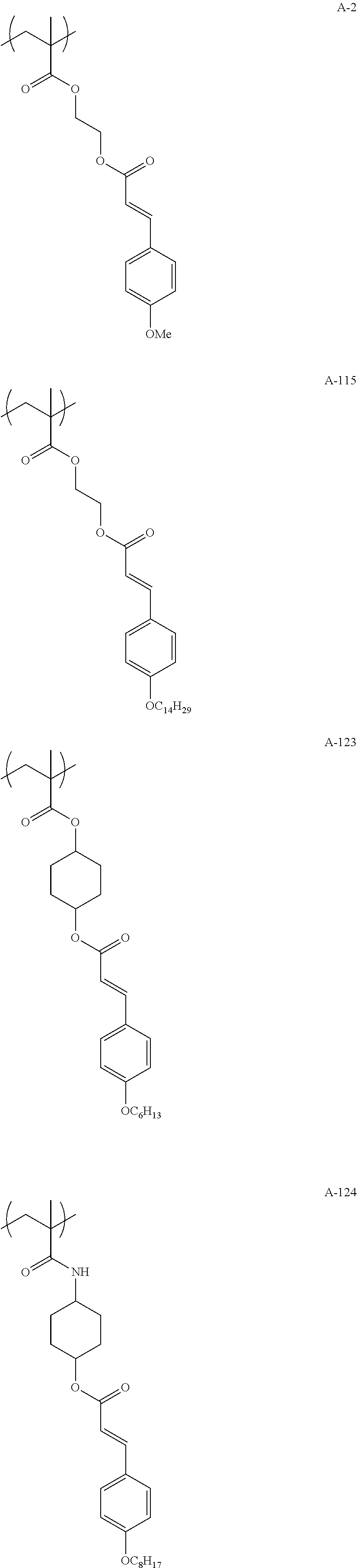

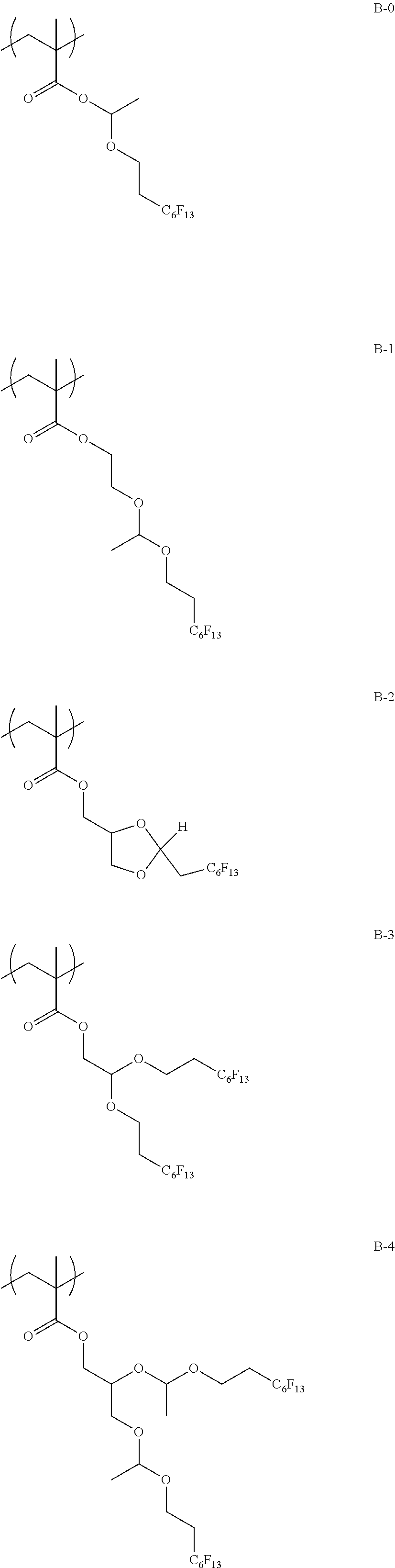

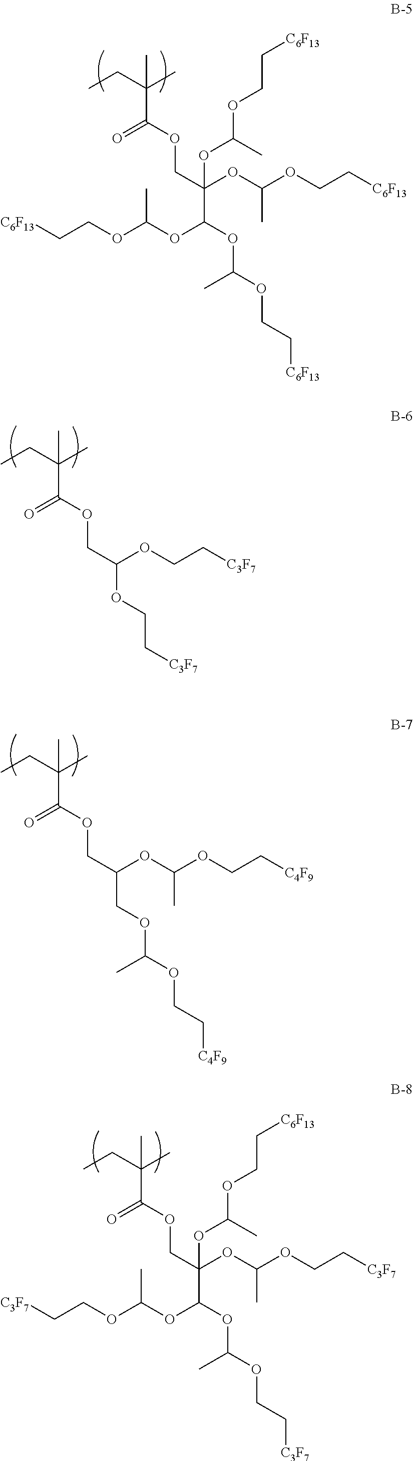

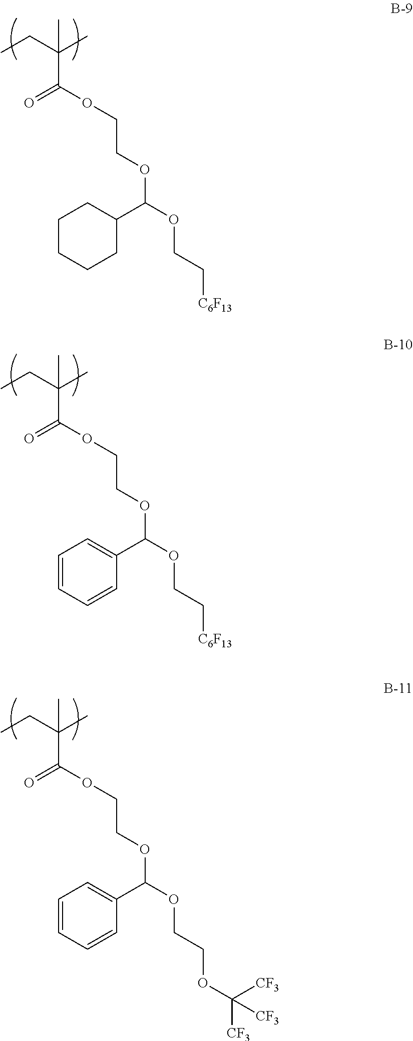

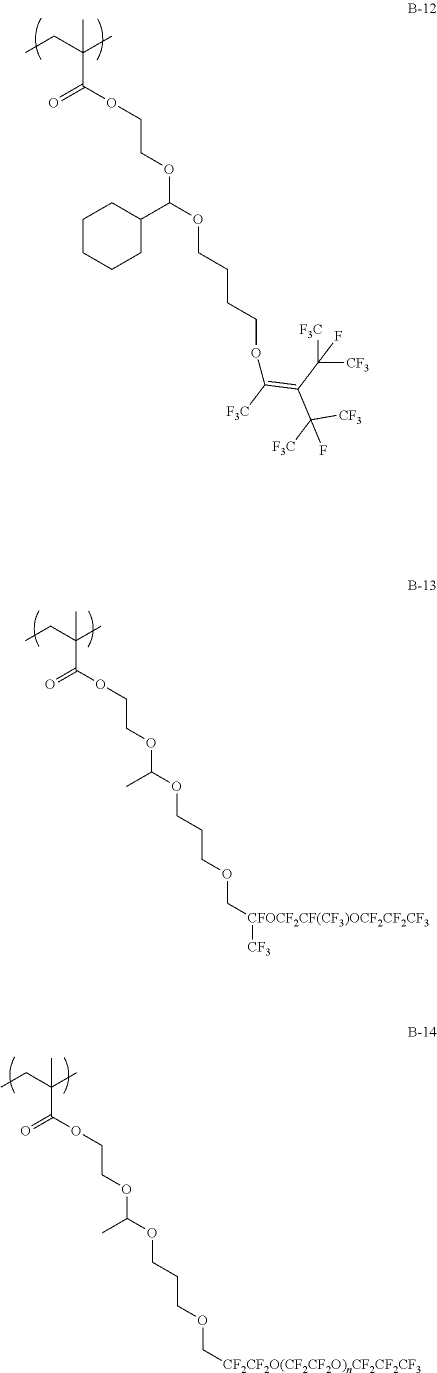

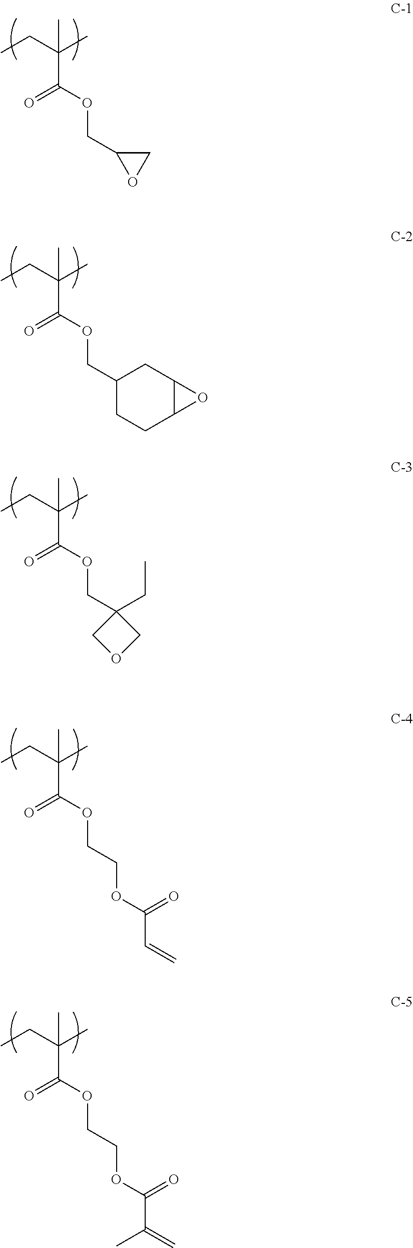

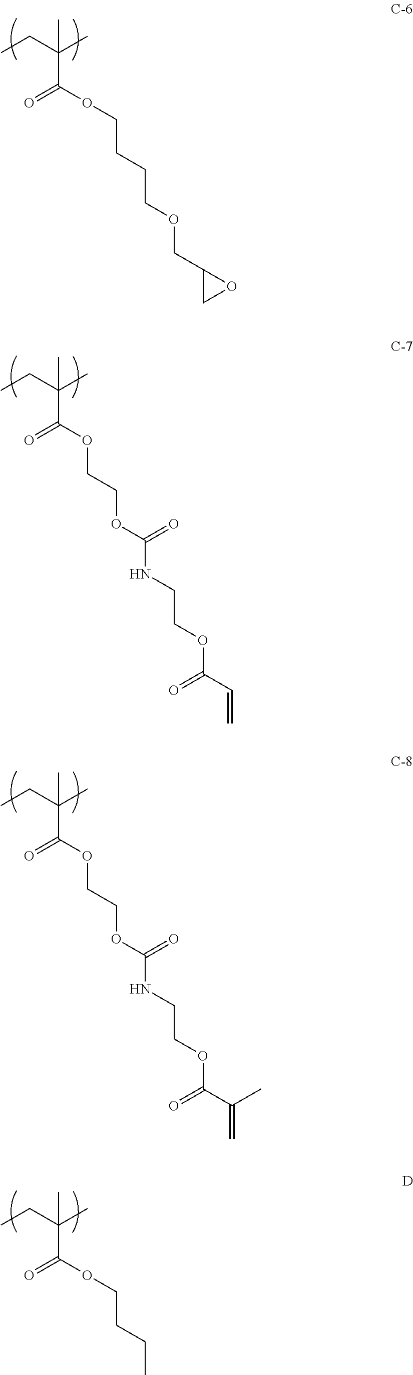

PETA: acrylic monomer (manufactured by Osaka Organic Chemical Industry Ltd.)

CEL2021P: epoxy monomer (manufactured by Daicel Corporation)

EPOLEAD GT401 (manufactured by Daicel Corporation)

A-DPH: acrylic monomer (manufactured by Shin-Nakamura Chemical Co., Ltd.)

The weight-average molecular weight of each of the synthesized polymers was measured by the above-described method. The results are shown in the following Tables 1 and 2.

<Manufacturing of Optical Laminate>

(Production of Support)

A cellulose acylate film (TD40UL, manufactured by FUJIFILM Corporation) passed through dielectric heating rolls at a temperature of 60° C., and after the film surface temperature was raised to 40° C., an alkali solution having the following composition was applied to one surface of the film using a bar coater at a coating rate of 14 ml/m², and heated to 110° C.

Next, the obtained film was transported for 10 seconds under a steam-type far-infrared heater manufactured by NORITAKE CO., LIMITED.

Next, using a bar coater, pure water was applied in the same manner to the obtained film at 3 ml/m².

Next, water washing by a fountain coater and dewatering by an air knife were repeatedly performed on the obtained film three times. Then, the film was transported and dried for 10 seconds in a drying zone at 70° C. to produce an alkali saponified cellulose acylate film, and the film was used as a support.

Composition of Alkali Solution

| | |
|---|---|
| Potassium Hydroxide | 4.7 parts by |
| | mass |
| Water | 15.8 parts by |
| | mass |
| Isopropanol | 63.7 parts by |
| | mass |
| Surfactant | 1.0 part by |
| (C₁₄H₂₉O(CH₂CH₂O)₂₀H) | mass |
| Propylene Glycol | 14.8 parts by |
| | mass |

(Formation of Alignment Layer)

An alignment layer coating liquid having the following composition was continuously applied to a long cellulose acetate film saponified as described above by a #14 wire bar. After application, the obtained film was dried by hot air at 60° C. for 60 seconds, and further dried by hot air at 100° C. for 120 seconds. In the following composition, “Polymerization Initiator (IN1)” represents a photopolymerization initiator (IRGACURE 2959, manufactured by BASF SE).

Next, a rubbing treatment was continuously performed on the dried coating film to form an alignment layer. In this case, the longitudinal direction of the long film was parallel to the transport direction, and the rotation axis of a rubbing roller was in a clockwise direction of 45° with respect to the longitudinal direction of the film.

Composition of Alignment Layer Coating Liquid

| | |
|---|---|
| Following Modified Polyvinyl | 10.0 parts by mass |
| Alcohol | |
| Water | 371.0 parts by mass |
| Methanol | 119.0 parts by mass |
| Glutaric Aldehyde | 0.5 parts by mass |
| Polymerization Initiator (IN1) | 0.3 parts by mass |

(In the following structural formulae, the ratio indicates a molar ratio)

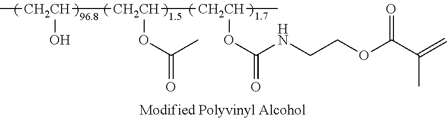

(Production of Binder Layer (Liquid Crystal Layer))

The following liquid crystal compound L-1 (39 parts by mass), the following liquid crystal compound L-2 (39 parts by mass), the following liquid crystal compound L-3 (17 parts by mass), the following liquid crystal compound L-4 (5 parts by mass), a photopolymerization initiator (IRGACURE 819, manufactured by BASF SE) (3 parts by mass), the following photo-acid generator (B-1-1) (5.0 parts by mass), the following vertical alignment agent A (1 part by mass), the following vertical alignment agent B (0.5 parts by mass), and a photo-alignment polymer P-1 (3.0 parts by mass) were dissolved in 215 parts by mass of methyl ethyl ketone to prepare a binder composition. The prepared binder composition was applied to the alignment layer by a #3.0 wire bar. The obtained coating film was heated for 2 minutes at 70° C., and cooled to 40° C. Then, the coating film was irradiated with 500 mJ/cm² of ultraviolet rays using a 365 nm UV-LED while nitrogen purge was conducted to make an atmosphere with an oxygen concentration of 1.0 vol % or less. Then, the obtained film was annealed for 1 minute at 120° C. to produce a cured film.

The film thickness was about 1 μm. The surface energy of the cured layer was 50 mN/m.

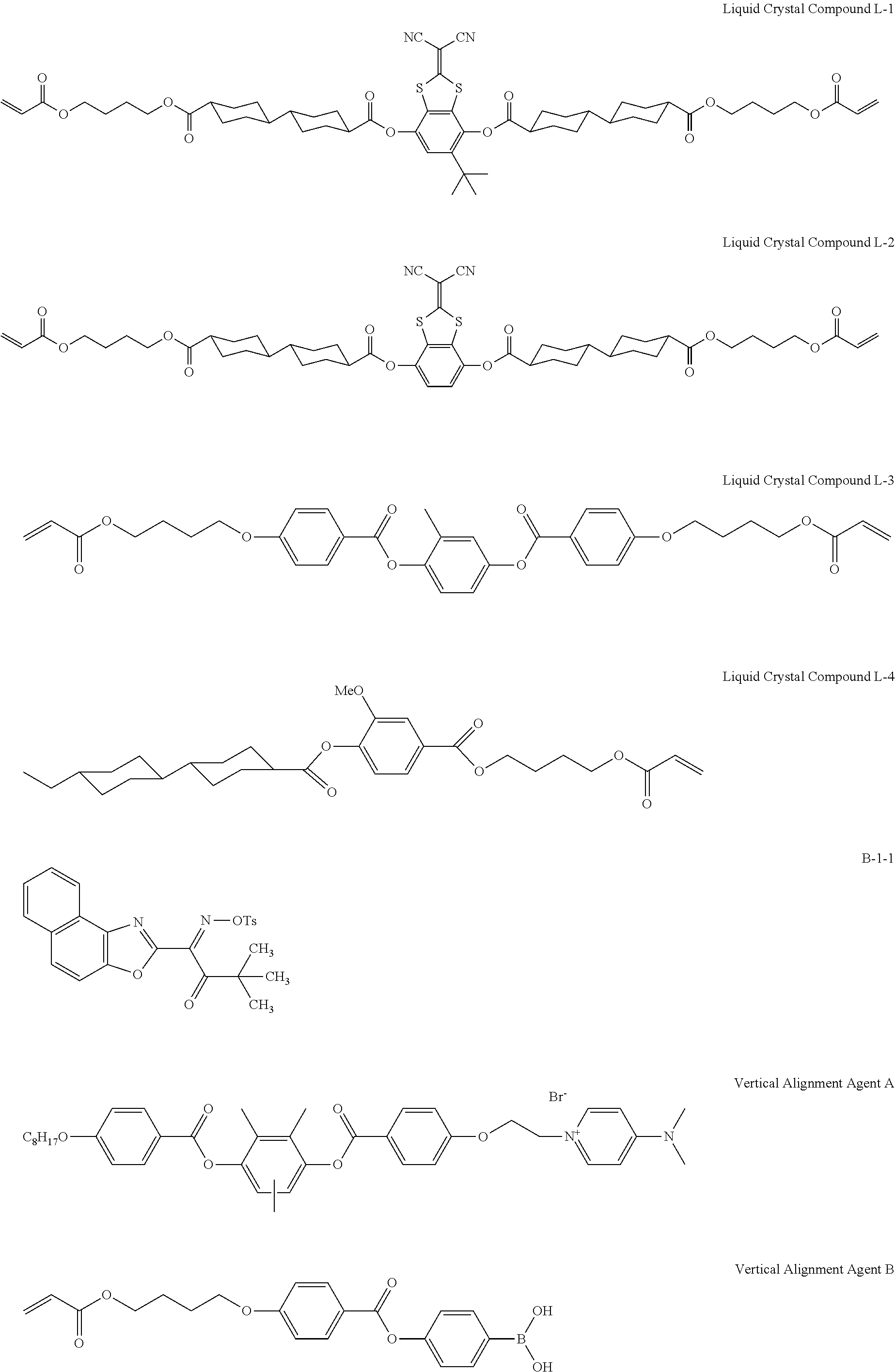

(Irradiation Step (Impartation of Alignment Function))

The obtained cured layer was irradiated with 25 mJ/cm² of UV light (ultra-high pressure mercury lamp; UL750; manufactured by HOYA CANDEO OPTRONICS CORPORATION) (wavelength: 313 nm) passing through a wire grid polarizer at room temperature to impart an alignment function to the cured layer, and thus a binder layer was formed.

(Production of Optically Anisotropic Layer (Upper Layer))

The following liquid crystal compound A (80 parts by mass), the following liquid crystal compound B (20 parts by mass), a photopolymerization initiator (IRGACURE 907, manufactured by BASF SE) (3 parts by mass), a sensitizer (KAYACURE DETX, manufactured by Nippon Kayaku Co., Ltd.) (1 part by mass), and the following horizontal alignment agent (0.3 parts by mass) were dissolved in methyl ethyl ketone (193 parts by mass) to prepare an optically anisotropic layer forming solution. The optically anisotropic layer forming solution was applied to the binder layer with the alignment function imparted thereto by a wire bar coater #2.2. The obtained coating film was heated for 2 minutes at 60° C., and irradiated with 300 mJ/cm² of ultraviolet rays using an air-cooling metal halide lamp (manufactured by Eye Graphics Co., Ltd.) of 160 W/cm while the temperature was maintained at 60° C. and nitrogen purge was conducted to make an atmosphere with an oxygen concentration of 1.0 vol % or less, and thus an optically anisotropic layer was produced.

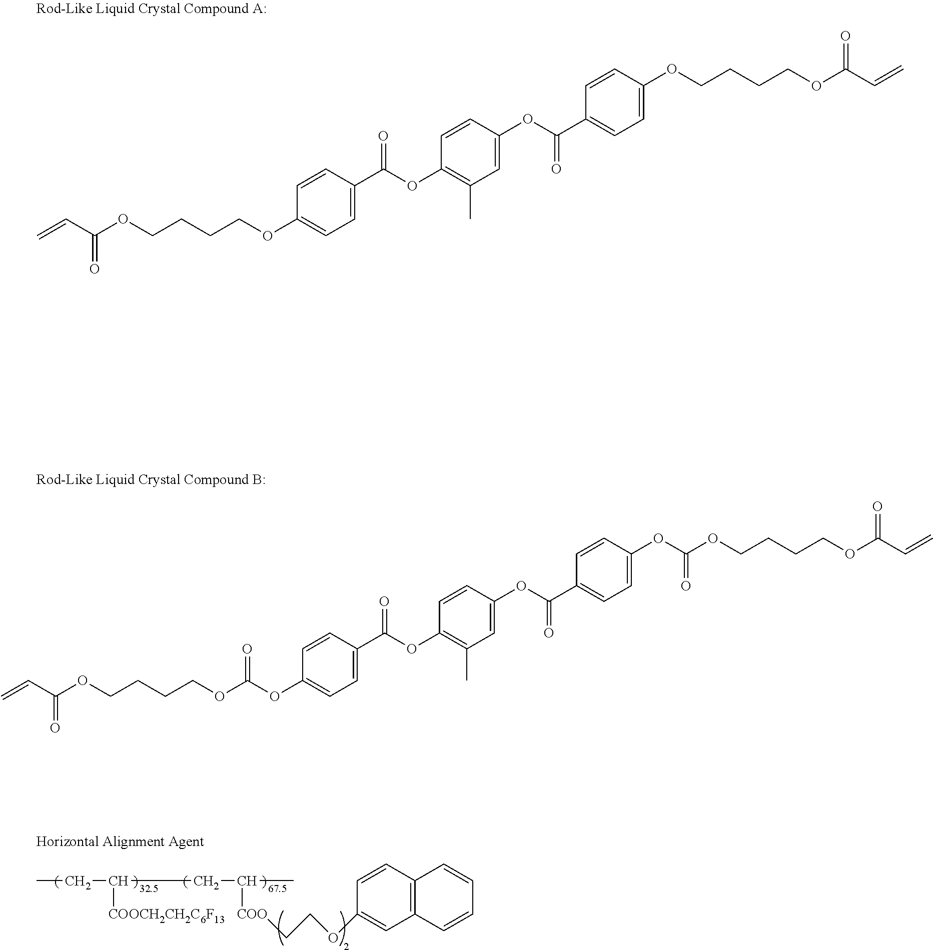

Optical laminates were produced by the same procedure as in the above description, except that instead of the photo-alignment polymer P-1, photo-alignment polymers P-2 to P-46, H-1, and H-2 were used as shown in Tables 1 and 2, instead of the liquid crystal compounds L1 to L4, the type of the liquid crystal compound in the binder layer forming composition was changed as shown in Tables 1 and 2, and a crosslinking agent (polymerizable compound) was optionally further added to the binder composition as shown in Tables 1 and 2.

In a case where the liquid crystal compound A and the liquid crystal compound B were used as the liquid crystal compound contained in the binder layer forming composition, the amount of the liquid crystal compound A used was 80 parts by mass, and the amount of the liquid crystal compound B used was 20 parts by mass.

In addition, in a case where CEL2021P was used instead of the liquid crystal compounds L1 to L4 in the binder layer forming composition in Comparative Example 1, the amount of CEL2021P used was 100 parts by mass.

The amount of the crosslinking agent (polymerizable compound) used in each example was 100 parts by mass.

<Liquid Crystal Aligning Properties>

Two polarizing plates were disposed in crossed nicols, and the obtained optical laminate was disposed therebetween to observe the degree of light leakage and to observe the surface state with a polarization microscope. The results are shown in the following Tables 1 and 2.

AA: There is no light leakage, liquid crystal directors are uniformly aligned, and the plane state is very stable.

A: There is no light leakage, liquid crystal directors are not misaligned, and the plane state is stable.

B: There is no light leakage, liquid crystal directors are slightly misaligned, and the plane state is stable.

C: There is no light leakage, but liquid crystal directors are misaligned and the plane state is not stable.

D: Light leakage is observed, liquid crystal directors are misaligned, and the plane state is not stable.

“Content a” in Tables 1 and 2 represents the content (mass %) of a repeating unit A with respect to all the repeating units of the photo-alignment polymer.

“Content b” in Tables 1 and 2 represents the content (mass %) of a repeating unit B with respect to all the repeating units of the photo-alignment polymer.

“Content c” in Tables 1 and 2 represents the content (mass %) of a repeating unit C with respect to all the repeating units of the photo-alignment polymer.

The column “binder” in Tables 1 and 2 represents the type of the binder contained in the binder layer forming composition.

TABLE 1

| | Photo-Alignment Polymer | | | | | | | | | | Liquid |
|---|---|---|---|---|---|---|---|---|---|---|---|
| | | | | | | | | Weight- | | | Crystal |
| | | | | | | | | Average | Binder | | |
| | | Repeating Unit | | | Content | | | Molecular | | Polymerizable | Aligning |
| | Type | A | B | C | a | b | c | Weight | Liquid Crystal Compound | Compound | Properties |
| Example 1 | P-1 | A-2 | B-1 | C-1 | 50 | 30 | 20 | 40,000 | Liquid Crystal Compounds L-1, L-2, L-3, L4 | | B |
| Example 2 | P-2 | A-115 | B-1 | | 40 | 60 | | 50,000 | Liquid Crystal Compounds L-1, L-2, L-3, L4 | PETA | A |
| Example 3 | P-3 | A-123 | B-1 | | 30 | 70 | | 45,000 | Liquid Crystal Compounds A, B | PETA | AA |
| Example 4 | P-3 | A-123 | B-1 | | 30 | 70 | | 45,000 | Liquid Crystal Compounds L-1, L-2, L-3, L4 | PETA | AA |
| Example 5 | P-4 | A-124 | B-1 | | 20 | 80 | | 40,000 | Liquid Crystal Compounds L-1, L-2, L-3, L4 | CEL2021P | AA |
| Example 6 | p-5 | A-124 | B-2 | | 20 | 80 | | 45,000 | Liquid Crystal Compounds L-1, L-2, L-3, L4 | EPOLEAD | AA |
| | | | | | | | | | | GT401 | |
| Example 7 | P-6 | A-124 | B-3 | | 20 | 80 | | 50,000 | Liquid Crystal Compounds L-1, L-2, L-3, L4 | PETA | AA |
| Example 8 | P-7 | A-124 | B-4 | | 20 | 80 | | 80,000 | Liquid Crystal Compounds L-1, L-2, L-3, L4 | A-DPH | AA |
| Example 9 | P-8 | A-124 | B-5 | | 2O | 80 | | 100,000 | Liquid Crystal Compounds L-1, L-2, L-3, L4 | PETA | AA |
| Example 10 | P-9 | A-124 | B-1 | C-2 | 15 | 40 | 45 | 45,000 | Liquid Crystal Compounds A, B | | AA |
| Example 11 | P-9 | A-124 | B-1 | C-2 | 15 | 40 | 45 | 45,000 | Liquid Crystal Compounds L-1, L-2, L-3, L4 | | AA |
| Example 12 | P-10 | A-124 | B-1 | C-4 | 15 | 40 | 45 | 45,000 | Liquid Crystal Compounds L-1, L-2, L-3, L4 | | AA |
| Example 13 | p-11 | A-124 | B-1 | C-4 | 20 | 40 | 40 | 45,000 | Liquid Crystal Compounds L-1, L-2, L-3, L4 | | AA |
| Example 14 | P-12 | A-124 | B-1 | C-4 | 25 | 40 | 35 | 45,000 | Liquid Crystal Compounds L-1, L-2, L-3, L4 | | AA |
| Example 15 | P-13 | A-124 | B-1 | C-4 | 25 | 45 | 30 | 45,000 | Liquid Crystal Compounds L-1, L-2, L-3, L4 | | AA |
| Example 16 | P-14 | A-124 | B-2 | C-4 | 20 | 40 | 40 | 45,000 | Liquid Crystal Compounds L-1, L-2, L-3, L4 | | AA |
| Example 17 | P-15 | A-124 | B-3 | C-4 | 20 | 30 | 50 | 45,000 | Liquid Crystal Compounds L-1, L-2, L-3, L4 | | AA |
| Example 18 | P-16 | A-124 | B-4 | C-4 | 20 | 30 | 50 | 45,000 | Liquid Crystal Compounds L-1, L-2, L-3, L4 | | AA |
| Example 19 | P-17 | A-124 | B-5 | C-4 | 20 | 20 | 60 | 45,000 | Liquid Crystal Compounds L-1, L-2, L-3, L4 | | AA |
| Example 20 | P-18 | A-124 | B-1 | C-3 | 20 | 40 | 40 | 50,000 | Liquid Crystal Compounds L-1, L-2, L-3, L4 | | AA |
| Example 21 | P-19 | A-124 | B-1 | C-5 | 20 | 40 | 40 | 50,000 | Liquid Crystal Compounds L-1, L-2, L-3, L4 | | AA |
| Example 22 | P-20 | A-124 | B-1 | C-6 | 20 | 40 | 40 | 50,000 | Liquid Crystal Compounds L-1, L-2, L-3, L4 | | AA |
| Example 23 | P-21 | A-124 | B-1 | C-7 | 20 | 40 | 40 | 50,000 | Liquid Crystal Compounds L-1, L-2, L-3, L4 | | AA |
| Example 24 | P-22 | A-124 | B-1 | C-8 | 20 | 40 | 40 | 50,000 | Liquid Crystal Compounds L-1, L-2, L-3, L4 | | AA |
| Example 25 | P-23 | A-124 | B-1 | | 5 | 95 | | 50,000 | Liquid Crystal Compounds L-1, L-2, L-3, L4 | PETA | AA |
| Example 26 | P-24 | A-124 | B-1 | | 10 | 90 | | 50,000 | Liquid Crystal Compounds L-1, L-2, L-3, L4 | PETA | AA |
| Example 27 | P-25 | A-124 | B-1 | | 15 | 85 | | 50,000 | Liquid Crystal Compounds L-1, L-2, L-3, L4 | PETA | AA |
| Example 28 | P-26 | A-124 | B-2 | | 15 | 85 | | 50,000 | Liquid Crystal Compounds L-1, L-2, L-3, L4 | PETA | AA |
| Example 29 | P-27 | A-124 | B-3 | | 15 | 85 | | 50,000 | Liquid Crystal Compounds L-1, L-2, L-3, L4 | A-DPH | AA |
| Example 30 | P-28 | A-124 | B-4 | | 15 | 85 | | 50,000 | Liquid Crystal Compounds L-1, L-2, L-3, L4 | PETA | AA |
| Example 31 | P-29 | A-124 | B-5 | | 15 | 85 | | 50,000 | Liquid Crystal Compounds L-1, L-2, L-3, L4 | A-DPH | AA |
| Example 32 | P-30 | A-124 | B-1 | C-4 | 5 | 40 | 55 | 50,000 | Liquid Crystal Compounds L-1, L-2, L-3, L4 | | AA |
| Example 33 | p-31 | A-124 | B-1 | C-4 | 10 | 40 | 50 | 50,000 | Liquid Crystal Compounds L-1, L-2, L-3, L4 | | AA |
| Example 34 | P-32 | A-124 | B-1 | C-4 | 15 | 40 | 45 | 50,000 | Liquid Crystal Compounds L-1, L-2, L-3, L4 | | AA |
| Example 35 | P-33 | A-124 | B-1 | C-4 | 20 | 40 | 40 | 50,000 | Liquid Crystal Compounds L-1, L-2, L-3, L4 | | AA |
| Example 36 | P-34 | A-124 | B-1 | C-4 | 25 | 40 | 35 | 50,000 | Liquid Crystal Compounds L-1, L-2, L-3, L4 | | AA |
| Example 37 | P-35 | A-124 | B-2 | C-4 | 20 | 40 | 40 | 50,000 | Liquid Crystal Compounds L-1, L-2, L-3, L4 | | AA |
| Example 38 | P-36 | A-124 | B-2 | C-4 | 25 | 40 | 35 | 50,000 | Liquid Crystal Compounds L-1, L-2, L-3, L4 | | AA |
| Example 39 | P-37 | A-124 | B-3 | C-4 | 20 | 40 | 40 | 50,000 | Liquid Crystal Compounds L-1, L-2, L-3, L4 | | AA |
| Comparative | H-1 | A-2 | D | | 60 | 40 | | 39,600 | | CEL2021P | D |
| Example 1 | | | | | | | | | | | |
| Comparative | H-2 | A-2 | B-0 | C-1 | 50 | 30 | 20 | 39,600 | Liquid Crystal Compounds A, B | | C |
| Example 2 | | | | | | | | | | | |

TABLE 2

| | | | | | | | | Weight- | | | Liquid |
|---|---|---|---|---|---|---|---|---|---|---|---|
| | Photo-Alignment Polymer | | | | | | | Average | Binder | | Crystal |
| | | Repeating Unit | | | Content | | | Molecular | | Polymerizable | Aligning |
| | Type | A | B | C | a | b | c | Weight | Liquid Crystal Compound | Compound | Properties |
| Example 40 | P-38 | A-124 | B-6 | C-4 | 20 | 45 | 35 | 50,000 | Liquid Crystal Compounds L-1, L-2, L-3, L4 | | AA |
| Example 41 | P-39 | A-124 | B-7 | C-4 | 20 | 45 | 35 | 50,000 | Liquid Crystal Compounds L-1, L-2, L-3, L4 | | AA |
| Example 42 | P-40 | A-124 | B-8 | C-4 | 20 | 45 | 35 | 50,000 | Liquid Crystal Compounds L-1, L-2, L-3, L4 | | AA |
| Example 43 | P-41 | A-124 | B-9 | C-4 | 20 | 40 | 40 | 50,000 | Liquid Crystal Compounds L-1, L-2, L-3, L4 | | AA |
| Example 44 | P-42 | A-124 | B-10 | C-4 | 20 | 40 | 40 | 50,000 | Liquid Crystal Compounds L-1, L-2, L-3, L4 | | AA |
| Example 45 | P-43 | A-124 | B-11 | C-4 | 20 | 40 | 40 | 50,000 | Liquid Crystal Compounds L-1, L-2, L-3, L4 | | AA |
| Example 46 | P-44 | A-124 | B-12 | C-4 | 20 | 40 | 40 | 50,000 | Liquid Crystal Compounds L-1, L-2, L-3, L4 | | AA |
| Example 47 | p-45 | A-124 | B-13 | C-4 | 20 | 40 | 40 | 50,000 | Liquid Crystal Compounds L-1, L-2, L-3, L4 | | AA |
| Example 48 | P-46 | A-124 | B-14 | C-4 | 20 | 40 | 40 | 50,000 | Liquid Crystal Compounds L-1, L-2, L-3, L4 | | AA |

As shown in the tables, it has been confirmed that desired effects can be obtained in a case where the photo-alignment polymer according to the embodiment of the present invention is used.

In addition, from the comparison between Examples 1 and 2, it has been confirmed that better effects can be obtained in a case where the number of carbon atoms of the alkoxy group represented by R^{A4} in the repeating unit represented by Formula (A) is 3 or more.

In addition, from the comparison between Examples 2 and 3, it has been confirmed that better effects can be obtained in a case where L^{A1} in the repeating unit represented by Formula (A) is a divalent linking group containing at least a cyclic alkylene group having 3 to 10 carbon atoms.

### Example 49

An optical laminate was produced by the same procedure as in each example, except that in Example 1, the liquid crystal compound A (80 parts by mass) and the liquid crystal compound B (20 parts by mass) were used instead of the liquid crystal compounds L1 to L4 in the binder layer forming composition, and the liquid crystal compound L-1 (39 parts by mass), the liquid crystal compound L-2 (39 parts by mass), the liquid crystal compound L-3 (17 parts by mass), and the liquid crystal compound L-4 (5 parts by mass) were used instead of the liquid crystal compound A and the liquid crystal compound B in the optically anisotropic layer forming solution.

The above <liquid crystal aligning properties> were evaluated using the obtained optical laminate, and evaluated to be “B” as in Example 1.

### Example 50

An optical laminate was produced by the same procedure as in each example, except that in Example 2, the liquid crystal compound A (80 parts by mass) and the liquid crystal compound B (20 parts by mass) were used instead of the liquid crystal compounds L1 to L4 in the binder layer forming composition, and the liquid crystal compound L-1 (39 parts by mass), the liquid crystal compound L-2 (39 parts by mass), the liquid crystal compound L-3 (17 parts by mass), and the liquid crystal compound L-4 (5 parts by mass) were used instead of the liquid crystal compound A and the liquid crystal compound B in the optically anisotropic layer forming solution.

The above <liquid crystal aligning properties> were evaluated using the obtained optical laminate, and evaluated to be “A” as in Example 2.

### Examples 50 to 94

An optical laminate was produced by the same procedure as in each example, except that in Examples 4 to 9 and 11 to 48, the liquid crystal compound A (80 parts by mass) and the liquid crystal compound B (20 parts by mass) were used instead of the liquid crystal compounds L1 to L4 in the binder layer forming composition, and the liquid crystal compound L-1 (39 parts by mass), the liquid crystal compound L-2 (39 parts by mass), the liquid crystal compound L-3 (17 parts by mass), and the liquid crystal compound L-4 (5 parts by mass) were used instead of the liquid crystal compound A and the liquid crystal compound B in the optically anisotropic layer forming solution.

The above <liquid crystal aligning properties> were evaluated using the obtained optical laminate, and evaluated to be “AA” in any of the examples.

What is claimed is:

1. A photo-alignment polymer comprising:
a repeating unit having a photo-alignment group; and
a repeating unit having a group represented by Formula (1), 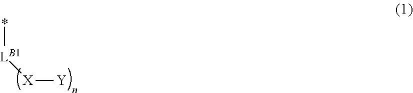
in Formula (1), L^{B1} represents an n+1-valent aliphatic hydrocarbon group having 1 or more carbon atoms,
X represents a cleavage group which is decomposed by the action of an acid to produce a polar group,
Y represents a group containing a fluorine atom or a silicon atom,
n represents an integer of 1 or more, and
* represents a bonding position.

2. The photo-alignment polymer according to claim 1,
wherein the repeating unit having a group represented by Formula (1) is a repeating unit represented by Formula (B), 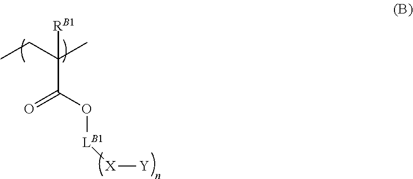
in Formula (B), R^{B1} represents a hydrogen atom or a substituent, and
definitions of L^{B1}, X, Y, and n in Formula (B) are the same as those of L^{B1}, X, Y, and n in Formula (1), respectively.

3. The photo-alignment polymer according to claim 1,
wherein X represents a group represented by any one of Formula (B1), . . . , or Formula (B3), 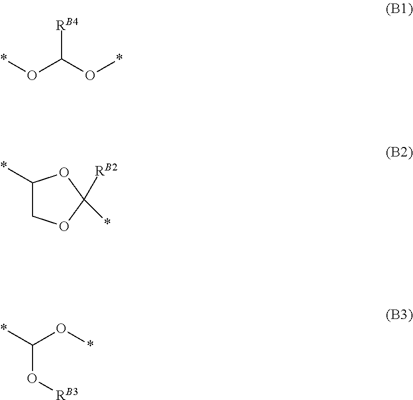
R^{B4} in Formula (B1) represents an alkyl group or an aryl group,
R^{B2} in Formula (B2) represents a hydrogen atom or a substituent,
R^{B3} in Formula (B3) represents a substituent, and
* in Formulae (B1) to (B3) represents a bonding position.

4. The photo-alignment polymer according to claim 1,
wherein the group represented by Formula (1) represents a group represented by any one of Formula (B4), . . . , or Formula (B8), 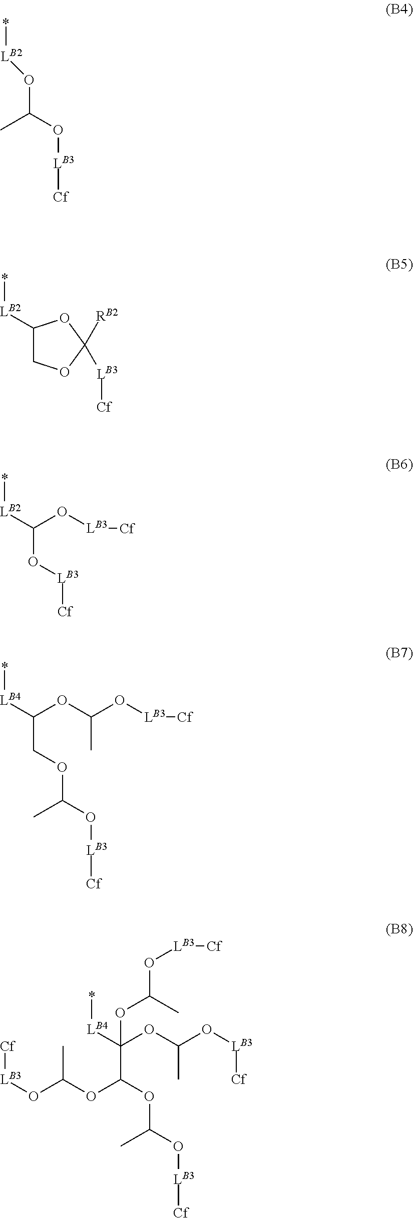
in Formula (B4), L^{B2} represents a divalent aliphatic hydrocarbon group having 1 or more carbon atoms, L^{B3} represents a single bond or a divalent linking group, and Cf represents a fluorine atom-containing alkyl group,
in Formula (B5), L^{B2} represents a divalent aliphatic hydrocarbon group having 1 or more carbon atoms, R^{B2} represents a hydrogen atom or a substituent, L^{B3} represents a single bond or a divalent linking group, and Cf represents a fluorine atom-containing alkyl group,
in Formula (B6), L^{B2} represents a divalent aliphatic hydrocarbon group having 1 or more carbon atoms, L^{B3} each independently represent a single bond or a divalent linking group, and Cf each independently represent a fluorine atom-containing alkyl group,
in Formula (B7), L^{B4} represents a single bond or a divalent aliphatic hydrocarbon group having 1 or more carbon atoms, L^{B3} each independently represent a single bond or a divalent linking group, and Cf each independently represent a fluorine atom-containing alkyl group,
in Formula (B8), L^{B4} represents a single bond or a divalent aliphatic hydrocarbon group having 1 or more carbon atoms, L^{B3} each independently represent a single bond or a divalent linking group, and Cf each independently represent a fluorine atom-containing alkyl group, and
* in Formulae (B4) to (B8) represents a bonding position.

5. The photo-alignment polymer according to claim 1,
wherein the repeating unit having a photo-alignment group is a repeating unit represented by Formula (A), 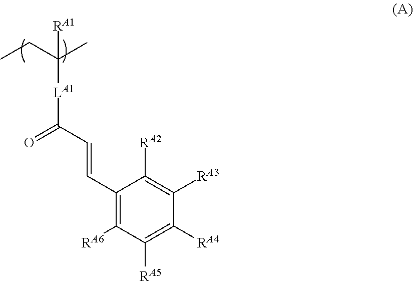
in Formula (A), R^{A1} represents a hydrogen atom or a substituent,
L^{A1} represents a single bond or a divalent linking group,
R^{A2}, R^{A3}, R^{A4}, R^{A5}, and R^{A6} each independently represent a hydrogen atom or a substituent, and two adjacent groups of R^{A2}, R^{A3}, R^{A4}, R^{A5}, and R^{A6} may be bonded to form a ring.

6. The photo-alignment polymer according to claim 1, further comprising a repeating unit having a crosslinkable group.

7. The photo-alignment polymer according to claim 6,
wherein the repeating unit having a crosslinkable group is a repeating unit represented by Formula (C), 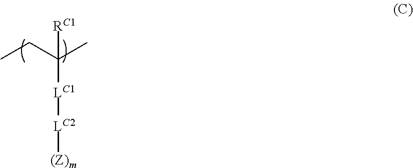
in Formula (C), R^{C1} represents a hydrogen atom or a substituent,
L^{C1} represents a single bond or a divalent linking group,
L^{C2} represents an m+1-valent linking group,
Z represents a crosslinkable group, and
m represents an integer of 1 or more.

8. The photo-alignment polymer according to claim 6,
wherein the crosslinkable group represents a group represented by any one of Formula (C1), . . . , or Formula (C4), 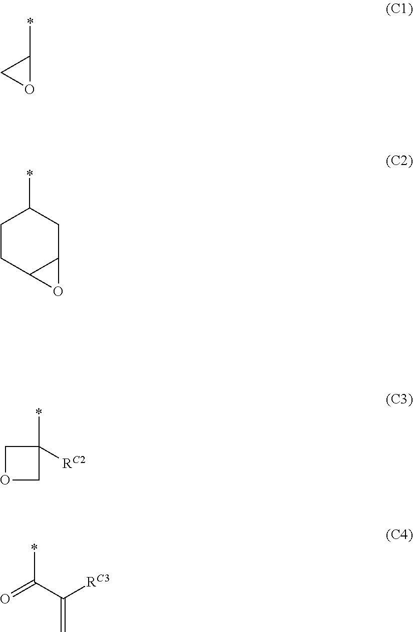
in Formula (C3), R^{C2} represents a hydrogen atom, a methyl group, or an ethyl group,
in Formula (C4), R^{C3} represents a hydrogen atom or a methyl group, and
* in Formulae (C1) to (C4) represents a bonding position.

9. The photo-alignment polymer according to claim 6,
wherein a content a of the repeating unit having a photo-alignment group, a content b of the repeating unit having a group represented by Formula (1), and a content c of the repeating unit having a crosslinkable group satisfy Expression (D1) in terms of mass ratio,
0.03≤a/(a+b+c)≤0.5 (D1).

10. The photo-alignment polymer according to claim 1,
wherein a weight-average molecular weight is 10,000 to 500,000.

11. A binder composition comprising:
the photo-alignment polymer according to claim 1;
a binder; and
a photo-acid generator.

12. A binder layer which is formed of the binder composition according to claim 11, and has a surface having alignment controllability.

13. An optical laminate comprising:
the binder layer according to claim 12; and
an optically anisotropic layer which is disposed on the binder layer.

14. An optical laminate manufacturing method comprising:
a step of generating an acid from the photo-acid generator in a coating film formed of the composition according to claim 11, and then performing a photo-alignment treatment to form a binder layer; and
a step of performing coating on the binder layer with a polymerizable liquid crystal composition containing a polymerizable liquid crystal compound to form an optically anisotropic layer.

15. An image display device comprising:
the binder layer according to claim 12.

16. An image display device comprising:
the optical laminate according to claim 13.
